(19) United States
(12) Patent Application Publication
(10) Pub. No.: US 2003/0211430 A1
(43) Pub. Date: Nov. 13, 2003

(54) Silver halide photosensitive material

(75) Inventors: Akira Ikeda, Minami-Ashigara-shi (JP); Katsuro Nagaoka, Minami-Ashigara-shi (JP); Terukazu Yanagi, Minami-Ashigara-shi (JP); Koichi Yokota, Minami-Ashigara-shi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/261,623

(22) Filed: Oct. 2, 2002

(30) Foreign Application Priority Data
Oct. 4, 2001 (JP) 2001-308855

(51) Int. Cl. G03C 1/005; G03C 1/46; G03C 1/815; G03C 7/32; G03C 1/494

(52) U.S. Cl. 430/523; 430/502; 430/510; 430/546; 430/966; 430/967; 430/567; 430/569

(57) ABSTRACT

A silver halide photosensitive material comprises at least one light-sensitive layer and at least one non-light-sensitive layer on a support. The photosensitive material contains at least one compound represented by general formula (1), and a ratio of fluorescent X-ray intensity of fluorine to fluorescent X-ray intensity of carbon, F/C, in the surface of the photosensitive material is 0.5 or more:

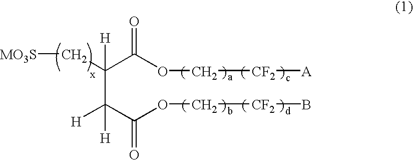

wherein A and B independently represent a fluorine atom or a hydrogen atom, a and b independently represent an integer of 1 to 6, c and d independently represent an integer of 4 to 8, x represents 0 or 1, and M represents a cation.

### CROSS-REFERENCE TO RELATED APPLICATIONS

This application is based upon and claims the benefit of priority from the prior Japanese Patent Applications No. 2001-308855, filed Oct. 4, 2001, the entire contents of which are incorporated herein by reference.

### BACKGROUND OF THE INVENTION

1. Field of the Invention

The present invention relates to a silver halide photosensitive material, and particularly to a photosensitive material which is excellent in antistatic characteristic, has an improved static resistance, and exhibit proper storability before and after exposure.

2. Description of the Related Art

For enhancing user's benefits, silver halide photosensitive materials have been required to have an increased sensitivity, and a remarkable increase in sensitivity has recently been achieved. On the other hand, photosensitive materials come into contact with various substances during their production, exposure and development processing. For example, if a photosensitive material is in a wound-up condition, its surface layer may, in a step of its processing, come into contact with its back layer formed on the back surface of its support. Further, when it is conveyed during the step of processing, it may come into contact with stainless rollers, rubber rollers or the like. If a photosensitive material comes into contact with such materials, the surface (gelatin layer) of the photosensitive material is easily charged positively and, under certain circumstances, may unnecessarily discharge, forming an exposure mark, called a static mark, which is undesirable for photosensitive materials. Compounds containing a fluorine atom are effective in reducing the conductivity of the gelatin and fluorine-containing surfactants are often added. However, the storability before and after exposure is often deteriorated according to combinations of a surfactant added and a silver halide emulsion used.

### BRIEF SUMMARY OF THE INVENTION

An object of the present invention is to provide a photosensitive material which is excellent in antistatic characteristic and has an improved static resistance and a high storability before and after exposure.

The object of the present invention has been achieved by the technique shown below:

(1) A silver halide photosensitive material comprising at least one light-sensitive layer and at least one non-light-sensitive layer on a support, wherein the photosensitive material contains at least one compound represented by general formula (1) and a ratio of fluorescent X-ray intensity of fluorine to fluorescent X-ray intensity of carbon, F/C, in the surface of the photosensitive material is 0.5 or more:

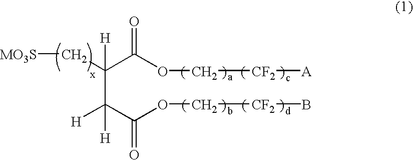

wherein A and B independently represent a fluorine atom or a hydrogen atom; a and b independently represent an integer of 1 to 6; c and d independently represent an integer of 4 to 8; x represents 0 or 1; and M represents a cation.

(2) The silver halide photosensitive material recited in item (1) above, wherein the compound of general formula (1) is represented by general formula (1-a) shown below:

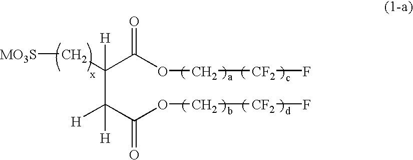

wherein a and b independently represent an integer of 1 to 6; c and d independently represent an integer of 4 to 8; x represents 0 or 1; and M represents a cation.

(3) The silver halide photosensitive material recited in item (1) above, wherein the compound of general formula (1) is represented by general formula (1-b) shown below:

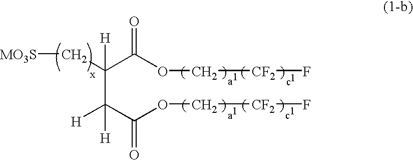

wherein a¹ represents 2 or 3; c¹ represents an integer of 4 to 6; x represents 0 or 1; and M represents a cation.

(4) The silver halide photosensitive material recited in any one of items (1) to (3) above, wherein the at least one light-sensitive emulsion layer contains at least one silver halide emulsion comprising grains having an aspect ratio of at least 8 in an amount of at least 50% of the total projected area of all the grains contained in the silver halide emulsion.

(5) The silver halide photosensitive material recited in any one of items (1) to (4), wherein the photosensitive material is in a rolled form.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DETAILED DESCRIPTION OF THE INVENTION

A photosensitive material of the present invention may be applied to any optional embodiment and can effectively be applied for any photosensitive material regardless of the type thereof, i.e., positive type or negative type. In the present invention, with regard to compounds of general formula (1), one kind of compound may be used or two or more different compounds may be used simultaneously. The amount of the compound(s) used is preferably from 10⁻⁶ to 10⁻¹ mol/m².

In the present invention, the layer in which the compound of general formula (1) is added is preferably an uppermost layer that is located farthest from the support, but it may be added in other layers with spectral sensitivity or in an intermediate layer. That compound may be either in a plurality of layers or in one layer.

The compound of general formula (1) of the present invention must be contained in an outer surface of a photosensitive material in at least a certain predetermined amount and is especially preferably added so as to be richest in the uppermost layer that is located farthest from the support for preventing unfavorable side effects. The amount of the compound present in the surface of the photosensitive material can be determined from the fluorescent X-ray intensity ratio (F/C) of fluorine to carbon in the surface of the photosensitive material. The F/C is preferably 0.5 or more, more preferably 0.8 or more, especially preferably 1.0 or more, and most preferably 1.5 or more. The upper limit of the fluorescent X-ray intensity ratio (F/C) is preferably 10.

The following is a detailed description on the compound of the present invention represented by general formula (1) show below:

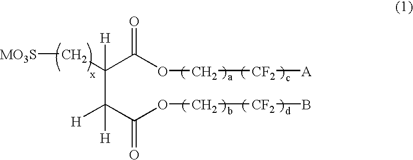

wherein A and B independently represent a fluorine atom or a hydrogen atom, a and b independently represent an integer of 1 to 6, c and d independently represent an integer of 4 to 8, x represents 0 or 1, and M represents a cation.

In general formula (1), A and B independently represent a fluorine atom or a hydrogen atom. A and B may be the same or different. It is preferable that both A and B are a fluorine atom or are a hydrogen atom, and more preferably that both A and B are a fluorine atom.

a and b independently represent an integer of 1 to 6. a and b may be the same or different from each other as long as each of them is an integer of 1 to 6. It is preferable that a and b each are an integer of 1 to 6 and a=b, more preferably that a and b each are an integer of 2 or 3 and a=b, and still more preferably that a=b=2.

c and d independently represent an integer of 4 to 8. c and d may be the same or different from each other as long as each of them is an integer of 4 to 8. It is preferable that c and d each are an integer of 4 to 6 and c=d, more preferably that c and d each are an integer of 4 or 6 and c=d, and still more preferably that c=d=4.

x represents 0 or 1, both of which are equally preferred.

M represents a cation. Preferably employed as the cation represented by M are alkali metal ions (lithium ion, sodium ion, potassium ion, etc.), alkaline earth metal ions (barium ion, calcium ion, etc.), ammonium ion, etc. Particularly preferred among these are lithium ion, sodium ion, potassium ion and ammonium ion.

Preferred as general formula (1) is general formula (1-a) shown below:

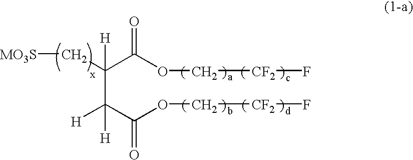

wherein the meanings and the preferable ranges of a, b, c, d, M and x are the same as those of these symbols in general formula (1).

More preferred as general formula (1) is general formula (1-b) shown below:

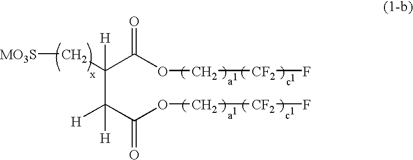

wherein a¹ represents 2 or 3, c¹ represents an integer of 4 to 6, and M represents a cation.

a¹ represents 2 or 3 and is preferably 2.

c¹ represents an integer of 4 to 6 and is preferably 4.

x represents 0 or 1, both of which are equally preferred.

The following are specific examples of surfactants preferably employed for the present invention. However, the present invention is not restricted to these specific examples.

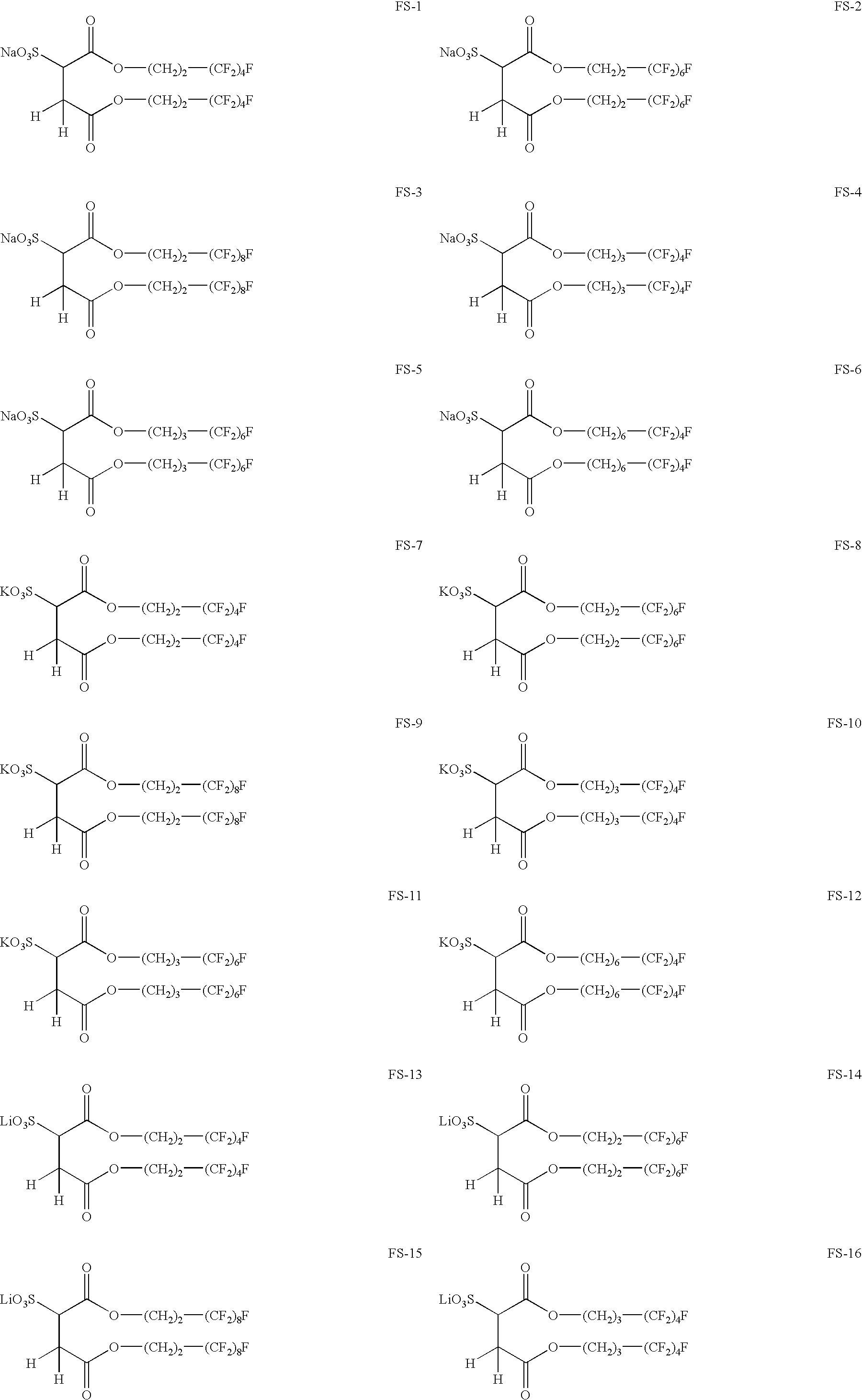

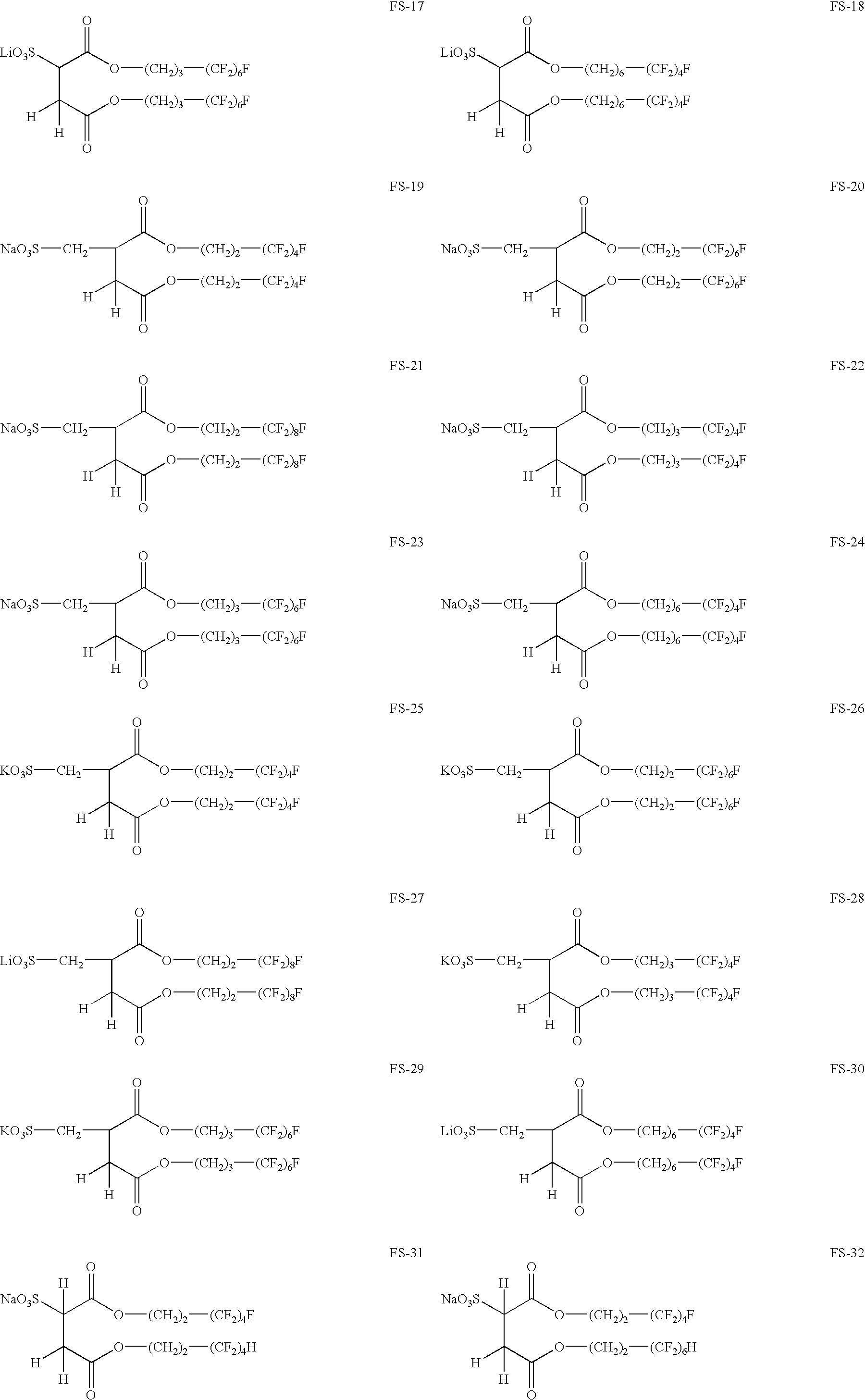

The surfactants of the present invention represented the foregoing general formulas (1), (1-a) and (1-b) can easily be synthesized by use of a combination of an ordinary esterification reaction and a sulfonation reaction. The exchange to a counter cation can easily be achieved by use of an ion exchange resin. The following are examples of representative synthesis methods. However, the present invention is not limited to these specific synthesis examples.

### SYNTHESIS EXAMPLE 1

### Synthesis of Exemplified Compound FS-1

1-1 Synthesis of di(3,3,4,4,5,5,6,6,6-nonafluorohexyl) maleate

In 30 milliliter (hereinafter, milliliter is also referred to as “mL”) of toluene, 9.8 g (0.10 mol) of maleic anhydride, 52.8 g (0.20 mol) of 3,3,4,4,5,5,6,6,6-nonafluorohexanol and 0.5 g of p-toluenesulfonic acid monohydrate were heated to reflux for 24 hours while the water formed was distilled out. Subsequently, the mixture was cooled to room temperature, and then hexane and ethyl acetate were added. The organic phase was washed with an aqueous sodium hydroxide solution with a concentration of 1 mol/liter (hereinafter, liter is also referred to as “L”) and a saturated aqueous sodium chloride solution. After the drying of the organic phase on sodium sulfate, the solvent was distilled out under reduced pressure and then purification was carried out by silica gel chromatography (hexane/ethyl acetate 9/1 to 8/2 v/v) to obtain 53.2 g (yield 88%) of a desired product as a white solid.

1-2 Synthesis of FS-1

To a reactor, 42.8 g (69 mmol) of di(3,3,4,4,5,5,6,6,6-nonafluorohexyl) maleate, 7.9 g (76 mmol) of sodium hydrogen sulfite and 50 mL of water-ethanol (1/1 v/v) were added and then the mixture was heated to reflux for 3 hours. Subsequently, the mixture was cooled to 0° C. and then the solid formed was recovered through filtration. The solid recovered was subjected to recrystallization from acetonitrile and the resulting crystals were dried at 60° C. under reduced pressure to obtain 27.0 g (yield 54%) of a desired product as white crystals.

The ¹H-NMR data of the resulting compound is as follows:

¹H-NMR(DMSO-d₆) 62.49-2.62(m, 4H), 2.85-2.99(m, 2H), 3.68(dd, 1H), 4.23-4.35(m, 4H)

### SYNTHESIS EXAMPLE 2

### Synthesis of Exemplified Compound FS-2

2-1 Synthesis of di(3,3,4,4,5,5,6,6,7,7,8,8,8-tridecafluorooctyl) maleate

In 140 mL of toluene, 4.61 g (47 mmol) of maleic anhydride, 34.1 g (98 mmol) of 3,3,4,4,5,5,6,6,7,7,8,8,8-tridecafluorooctyl alcohol and 0.24 g of p-toluenesulfonic acid monohydrate were heated to reflux for 10 hours while the water formed was distilled out. Subsequently, the mixture was cooled to room temperature and then ethyl acetate was added. The organic phase was washed with a saturated aqueous sodium chloride solution. After the drying of the organic phase on magnesium sulfate, the solvent was distilled out under reduced pressure and then purification was carried out by silica gel chromatography (hexane/ethyl acetate: 8/2 v/v) to obtain 19.7 g (yield 52%) of a desired product as a white solid.

2-2 Synthesis of FS-2

To a reactor, 10.0 g (12.4 mmol) of di(3,3,4,4,5,5,6,6,7,7,8,8,8-tridecafluorooctyl) maleate, 1.55 g (14.9 mmol) of sodium hydrogen sulfite and 15 mL of water-ethanol (1/1 v/v) were added and then the mixture was heated to reflux for 7 hours. Subsequently, the mixture was cooled to room temperature and then a resulting solid was dried at 60° C. under reduced pressure to obtain 9.38 g (yield 81%) of a desired product as white crystals.

The ¹H-NMR data of the resulting compound is as follows:

¹H-NMR(DMSO-d₆) δ 2.48(m, 4H), 2.97(m, 2H), 3.82(m, 1H), 4.18-4.58(m, 4H)

### SYNTHESIS EXAMPLE 3

### Synthesis of Exemplified Compound FS-4

3-1 Synthesis of di(4,4,5,5,6,6,7,7,7-nonafluoroheptyl) maleate

In 250 mL of toluene, 17.6 g (0.18 mol) of maleic anhydride, 100 g (0.36 mol) of 4,4,5,5,6,6,7,7,7-nonafluoroheptanol and 0.5 g of p-toluenesulfonic acid monohydrate were heated to reflux for 12 hours while the water formed was distilled out. Subsequently, the mixture was cooled to room temperature and then chloroform was added. The organic phase was washed with a 1-mol/L aqueous sodium hydroxide solution and a saturated aqueous sodium chloride solution to obtain 114.1 g of a desired product as a white solid quantitatively.

3-2 Synthesis of FS-4

To a reactor, 95.8 g (156 mmol) of di(4,4,5,5,6,6,7,7,7-nonafluoroheptyl) maleate, 7.9 g (172 mmol) of sodium hydrogen sulfite and 100 mL of water-ethanol (1/1 v/v) were added and heated to reflux for 20 hours. Subsequently, ethyl acetate was added and the organic phase was washed with a saturated aqueous sodium chloride solution. After the drying of the organic phase on sodium sulfate, the solvent was concentrated under reduced pressure and then recrystallization was carried out from acetonitrile. The resulting crystals were dried at 60° C. under reduced pressure to obtain 95.8 g (yield 83%) of a desired product as white crystals.

The ¹H-NMR data of the resulting compound is as follows:

¹H-NMR(DMSO-d₆) 61.80(m, 4H), 2.19-2.34(m, 4H), 2.79-2.97(m, 2H), 3.68(dd, 1H), 4.01-4.29(m, 4H)

### SYNTHESIS EXAMPLE 4

### Synthesis of Exemplified Compound FS-19

4-1 Synthesis of di(3,3,4,4,5,5,6,6,6-nonafluorohexyl) itaconate

In 500 mL of toluene, 13.5 g (0.12 mol) of itaconic anhydride, 69.8 g (0.26 mol) of 3,3,4,4,5,5,6,6,6-nonafluorohexanol and 1.14 g (6 mmol) of p-toluenesulfonic acid monohydrate were heated to reflux for 12 hours while the water formed was distilled out. Subsequently, the mixture was cooled to room temperature and then ethyl acetate was added. The organic phase was washed with a 1-mol/L aqueous sodium hydroxide solution and a saturated aqueous sodium chloride solution to obtain 51.3 g (69%) of a desired product as an oily compound.

4-2 Synthesis of FS-19

To a reactor, 20.0 g (32 mmol) of di(3,3,4,4,5,5,6,6,6-nonafluorohexyl) itaconate, 4.0 g (38 mmol) of sodium hydrogen sulfite and 25 mL of water-ethanol (1/1 v/v) were added and heated to reflux for 6 hours. Subsequently, ethyl acetate was added and the organic phase was washed with a saturated aqueous sodium chloride solution. After the drying of the organic phase on sodium sulfate, the solvent was concentrated under reduced pressure and then recrystallization was carried out by use of acetonitrile. The resulting crystals were dried at 80° C. for 2 hours under reduced pressure to obtain 20.6 g (yield 89%) of a desired product as white crystals.

The ¹H-NMR data of the resulting compound is as follows:

¹H-NMR (DMSO-d₆) δ 2.49-2.78 (m, 5H), 3.04-3.13 (m, 2H) 3.47 (br, 2H), 4.23 (t, 4H)

In the present invention, when the above-mentioned surfactant is used in a layer of a photographic light-sensitive material, the aqueous coating composition containing the surfactant may be comprised only of the surfactant of the present invention and water and also may optionally contain other ingredients according to purpose.

In the above-mentioned aqueous coating composition, only one kind of the surfactant of the present invention may be used or, alternatively, two or more kinds of surfactants may be used in combination. Further, a surfactant or surfactants other than the surfactant of the present invention may be used together with the surfactant of the present invention. Surfactants that can be used together with the surfactant of the present invention include surfactants of anionic type, cationic type and nonionic type, high molecular weight surfactants, and also include fluorine-containing surfactants other than the surfactant of the present invention. Examples of the surfactants which can be used together with the surfactant of the present invention include those disclosed in Jpn. Pat. Application KOKAT Publication No. (hereinafter refereed to as JP-A-) 62-215272 (pages 649-706), Research Disclosure (RD) Item 17643, pages 26-27 (December, 1972), ibid., Item 18716, page 650 (November, 1979), and ibid., Item 307105, pages 875-876 (November, 1989), the entire contents of all of which are incorporated herein by reference.

Representative substance that may be contained in the above-mentioned aqueous coating composition is a polymer compound. The polymer compound may be either an aqueous medium-soluble polymer or a water dispersion of a polymer (so-called polymer latex). The soluble polymer has not particular limitations and example thereof include gelatin, polyvinyl alcohol, casein, agar, gum arabic, hydroxyethylcellulose, methylcellulose, carboxymethylcellulose, etc. Examples of polymer latex include homopolymers or copolymers of various vinyl monomers (e.g., acrylate derivatives, methacrylate derivatives, acrylamide derivatives, methacrylamide derivatives, styrene derivatives, conjugated diene derivatives, N-vinyl compounds, O-vinyl compounds, vinylnitrile, and other vinyl compounds (e.g., ethylene and vinylidene chloride)), dispersions of condensation-type polymers (e.g., polyester, polyurethane, polycarbonate and polyamide). Detailed examples of such kinds of polymer compounds include those disclosed in JP-A-62-215272 (pages 707-763), Research Disclosure (RD) Item 17643, page 651 (December, 1978), ibid., Item 18716, page 650 (November, 1979), and ibid., Item 307105, pages 873-874 (November, 1989), the entire contents of all of which are incorporated herein by reference.

The medium in the above-mentioned aqueous coating composition may be either water only or a mixed solvent of an organic solvent (e.g., methanol, ethanol, isopropyl alcohol, n-butanol, methyl cellosolve, dimethylformamide, acetone, etc.) and water. The ratio of water in the aqueous coating medium is preferably 50% or more.

The above-described aqueous coating composition may contain various compounds according to the layers of the photosensitive material. Those compounds may be either dissolved or dispersed in a medium. Examples of those compounds include various kinds of couplers, ultraviolet absorbers, anti-color mixing agents, antistatic agents, scavengers, antifogging agents, hardeners, dyes, mildew-proofing agents, etc. It is preferable to use these compounds in a hydrophilic colloid layer that is the uppermost layer for obtaining effective antistatic ability and coating uniformity.

In this case, the coating composition of this layer may contain, in addition to hydrophilic colloids (e.g., gelatin) and the fluorine-containing surfactants of the present invention, other surfactants, matting agents, slipping agents, colloidal silica, gelatin plasticizers, etc.

The amounts of the surfactants of general formulas (1), (1-a) and (1-b) used are not particularly limited and may be varied optionally depending upon the structure of the surfactants, intended use desired for the surfactants or intended application of the photosensitive material containing the surfactants the kinds and amounts of compounds contained in the aqueous composition, the constitution of the medium, etc. For example, in the case where the surfactant of the present invention is used as an coating liquid for forming a hydrophilic colloid (gelatin) layer, which is the uppermost layer, of a photosensitive material, which is a preferred embodiment of the present invention, the amount of the surfactant used is preferably from 0.003 to 0.5% in terms of the concentration (% by weight) in the coating solution, and from 0.03 to 5% based on the gelatin solid.

The photosensitive material of the present invention is only required to have at least one light-sensitive layer and at least one non-light-sensitive layer on a support. A typical example is a silver halide photosensitive material having, on a support, at least one lightsensitive layer comprising a plurality of sub-layers each having substantially the same color sensitivity but different in speeds. This lightsensitive layer includes a unit lightsensitive layer which is sensitive to one of blue light, green light and red light. In a multilayered silver halide color photographic photosensitive material, these unit lightsensitive layers are generally arranged in the order of red-, green- and blue-sensitive layers from a support. However, according to the intended use, this arrangement order may be reversed, or light-sensitive layers sensitive to the same color can sandwich another lightsensitive layer sensitive to a different color. A non-lightsensitive layer can be formed between the silver halide lightsensitive layers and as the uppermost layer and the lowermost layer. These intermediate layers may contain, e.g., couplers DIR compounds and anti-color mixing agents to be described later. As for a plurality of silver halide emulsion layers constituting respective unit lightsensitive layer, a two-layered structure of high- and low-speed emulsion layers can be preferably used in this order so as to the speed becomes lower toward the support as described in DE (German Patent) 1,121,470 or GB 923,045, the entire contents of both of which are incorporated herein by reference. Also, as described in JP-A's-57-112751, 62-200350, 62-206541 and 62-206543, the entire contents of all of which are incorporated herein by reference, layers can be arranged such that a low-speed emulsion layer is formed farther from a support and a high-speed layer is formed closer to the support.

As specific examples of the layer arrangement, the layers can be provided in the order, enumerating from the farthest side from a support, of low-speed blue-sensitive layer (BL)/high-speed blue-sensitive layer (BH)/high-speed green-sensitive layer (GH)/low-speed green-sensitive layer (GL)/high-speed red-sensitive layer (RH)/low-speed red-sensitive layer (RL), the order of BH/BL/GL/GH/RH/RL, and the order of BH/BL/GH/GL/RL/RH.

Further, the layers may also be arranged in the order, enumerating from the farthest side from a support, of blue-sensitive layer/GH/RH/GL/RL, as described in Jpn. Pat. Application KOKOKU Publication No. (hereinafter referred to as JP-B-) 55-34932, the entire contents of which are incorporated herein by reference. In addition, the layers may also be arranged in the order, enumerating from the farthest side from a support, of blue-sensitive layer/GL/RL/GH/RH, as described in JP-A's-56-25738 and 62-63936, the entire contents of both of which are incorporated herein by reference.

As described in JP-B-49-15495, the entire contents of which are incorporated herein by reference, the layer arrangement of providing a silver halide emulsion layer having the highest speed as an upper layer, a silver halide emulsion layer having lower speed than the former layer as an intermediate layer, and a silver halide emulsion layer having a yet lower speed than the former layer as an underlayer, thereby, three layers each having different speeds are configured so that the speeds of the respective layers are sequentially lowered toward the support, can be mentioned. Even in a case where the photographic material is configured by such three layers having different speeds, the arrangement may be in an order of medium-speed emulsion layer/high-speed emulsion layer/low-speed emulsion layer from the farthest side from a support.

In addition, the arrangement may be in the order of high-speed emulsion layer/low-speed emulsion layer/medium-speed emulsion layer, or of low-speed emulsion layer/medium-speed emulsion layer/high-speed emulsion layer can be adopted. Furthermore, the arrangement can be changed as described above even when four or more layers are formed.

In order to improve color reproduction, it is preferred that an interlayer effect-donating layer (CL), which has a different spectral sensitivity distribution from main color sensitive layers such as BL, GL and RL, is arranged neighboring to or near the main color sensitive layers.

The silver halide preferably used in the present invention is silver iodobromide, silver iodochloride or silver iodochlorobromide containing about 30 mol % or less of silver iodide. Especially preferred is silver iodobromide or silver iodochlorobromide containing from about 2 mol % to about 10 mol % of silver iodide.

Silver halide grains contained in a photographic emulsion may have regular crystals such as cubic, octahedral, or tetradecahedral crystals, irregular crystals such as spherical or tabular crystals, crystals having crystal defects such as a twin plane, or composite shapes thereof.

The silver halide grains may be fine grains having a grain size of about 0.2 μm or less or large grains having a projected-area diameter of about 10 μm, and the emulsion may be either a polydisperse or monodisperse emulsion.

A silver halide photographic emulsion which can be used in the present invention can be prepared by methods described in, e.g., “I. Emulsion preparation and types,” Research Disclosure (RD) No. 17643 (December, 1978), pages 22-23, ibid, No. 18716 (November, 1979), page 648, and ibid, No. 307105 (November, 1989), pages. 863 to 865; P. Glafkides, Chimie et Phisique Photographiques, Paul Montel, 1967; G. F. Duffin, Photographic Emulsion Chemistry, Focal Press, 1966; and V. L. Zelikman, et al., Making and Coating Photographic Emulsion, Focal Press, 1964.

Monodisperse emulsions described, for example, in U.S. Pat. Nos. (hereinafter referred to as U.S.P.) 3,574,628 and 3,655,394 and British Patent 1,413,748 are also preferable.

Tabular grains having an aspect ratio of about 3 or more can also be used in the present invention. In particular, an emulsion in which at least 50% of the total projected area is accounted for by silver halide tabular grains having an aspect ratio of 8 or more may be used for the improvement of storability with time. The upper limit of the aspect ratio is not particularly limited, but it is preferably 30 or less. Tabular grains can easily be prepared by methods described in, e.g., Gutoff, Photographic Science and Engineering, Vol. 14, pages 248 to 257 (1970); U.S. Pat. Nos. 4,434,226, 4,414,310, 4,433,048 and 4,439,520, and British Patent 2,112,157.

A crystal structure may be uniform, or may have different halogen compositions in the interior and the exterior thereof, or may be a layered structure. Alternatively, silver halides having different compositions may be bonded through an epitaxial junction or silver halide may be bonded to a compound other than silver halide such as silver rhodamide or zinc oxide. A mixture of grains having various types of crystal forms may also be used.

The emulsion for use in the photosensitive material of the present invention may be any of the surface latent image type in which latent images are mainly formed on the surface, the internal latent image type in which latent images are formed in the internal portion of grains and the type in which latent images exist in both the surface and the internal portion of grains. However, it is requisite that the emulsion be a negative type. The emulsion of the internal latent image type may specifically be, for example, a core/shell internal-latent-image type emulsion described in JP-A-63-264740 whose productive process is described in JP-A-59-133542. The thickness of the shell of this emulsion, although varied depending on development processing, etc., is preferably in the range of 3 to 40 nm, more preferably 5 to 20 nm.

The silver halide emulsion is generally subjected to physical ripening, chemical sensitization and spectral sensitization before use. Additives employed in these steps are described in RD Nos. 17643, 18716 and 307105. Positions where the description is made are listed in the following table.

With respect to the photosensitive material of the present invention, at least two emulsions which are different from each other in at least one of the characteristics of the grain size, grain size distribution, halogen composition, grain configuration and speed of lightsensitive silver halide emulsion, can be mixed together and used in one layer.

It is preferred that silver halide grains having a grain surface fogged as described in U.S. Pat. No. 4,082,553, silver halide grains having a grain internal portion fogged as described in U.S. Pat. No. 4,626,498 and JP-A-59-214852, the entire contents of all of which are incorporated herein by reference, and colloidal silver be used in lightsensitive silver halide emulsion layers and/or substantially non-lightsensitive hydrophilic colloidal layers. The expression “silver halide grains having a grain surface or grain internal portion fogged” refers to silver halide grains which can be developed uniformly (non-imagewise) irrespective of the unexposed or exposed zone of photosensitive material. The process for producing them is described in U.S. Pat. No. 4,626,498 and JP-A-59-214852. The silver halides constituting internal nuclei of core/shell silver halide grains having a grain internal portion fogged may have different halogen composition. Any of silver chloride, silver chlorobromide, silver iodobromide and silver chloroiodobromide can be used as the silver halide having a grain surface or grain internal portion fogged. The average grain size of these fogged silver halide grains is preferably in the range of 0.01 to 0.75 μm, especially preferably 0.05 to 0.6 μm. With respect to grain configuration, although both regular grains and a polydisperse emulsion can be used, monodispersity (at least 95% of the weight or number of silver halide grains have grain sizes falling within ±40% of the average grain size) is preferred.

In the present invention, it is preferred to use nonlightsensitive fine grain silver halide. The expression “nonlightsensitive fine grain silver halide” refers to silver halide fine grains which are not sensitive to light at the time of imagewise exposure for obtaining dye image and which are substantially not developed at the time of development processing thereof. Those not fogged in advance are preferred. The fine grain silver halide has a silver bromide content of 0 to 100 mol %, and, if necessary, may contain silver chloride and/or silver iodide. Preferably, silver iodide is contained in an amount of 0.5 to 10 mol %. The average grain size (average of equivalent circle diameter of projected area) of fine grain silver halide is preferably in the range of 0.01 to 0.5 μm, more preferably 0.02 to 0.2 μm.

The fine grain silver halide can be prepared by the same process as used in the preparation of common lightsensitive silver halide. It is not needed to optically sensitize the surface of silver halide grains. Further, a spectral sensitization thereof is also unnecessary. However, it is preferred to add known stabilizers such as triazoles, azaindenes, benzothiazoliums and mercapto compounds and zinc compounds thereto prior to the addition thereof to a coating liquid. Colloidal silver can be contained in the fine grain silver halide grain-containing layer.

The silver coating amount of the photosensitive material for use in the present invention is preferably 6.0 g/m² or less, most preferably 4.5 g/m² or less.

The photographic additives useful in the invention are described in the Research Disclosures, the entire contents of all of which are incorporated herewith by reference, and associating descriptions are set forth below.

| Types of | | | | |
|---|---|---|---|---|
| Additives | | RD17643 | RD18716 | RD307105 |
| 1. | Chemical | page 23 | page 648 | page 866 |
| | sensitizers | | right column | |
| 2. | Sensitivity | | page 648 | |
| | increasing | | right column | |
| | agents | | | |
| 3. | Spectral | pages | page 648, | pages |
| | sensitizers, | 23-24 | right column | 866-868 |
| | super- | | to page 649, | |
| | sensitizers | | right column | |
| 4. | Brighteners | page 24 | page 647, | page 868 |
| | | | right column | |
| 5. | Light | pages | page 649, | page 873 |
| | absorbents, | 25-26 | right column | |
| | filter dyes, | | to page 650, | |
| | ultraviolet | | left column | |
| | absorbents | | | |
| 6. | Binders | page 26 | page 651, | pages |
| | | | left column | 873-874 |
| 7. | Plasticizers, | page 27 | page 650, | page 876 |
| | lubricants | | right column | |
| 8. | Coating aids, | pages | page 650, | pages |
| | surfactants | 26-27 | right column | 875-876 |
| 9. | Antistatic | page 27 | page 650, | pages |
| | agents | | right column | 876-877 |
| 10. | Matting | | | pages |
| | agents | | | 878-879 |

Various dye forming couplers can be used in the photosensitive material of the present invention, and the following couplers are particularly preferable.

Yellow couplers: couplers represented by formulas (I) and (II) in EP No. 502,424A; couplers represented by formulas (1) and (2) in EP No. 513,496A (particularly Y-28 on page 18); a coupler represented by formula (I) in claim 1 of EP No. 568,037A; a coupler represented by general formula (I) in column 1, lines 45 to 55, in U.S. Pat. No. 5,066,576; a coupler represented by general formula (I) in paragraph 0008 of JP-A-4-274425; couplers described in claim 1 on page 40 in EP No. 498,381A1 (particularly D-35 on page 18); couplers represented by formula (Y) on page 4 in EP No. 447,969A1 (particularly Y-1 (page 17) and Y-54 (page 41)); and couplers represented by formulas (II) to (IV) in column 7, lines 36 to 58, in U.S. Pat. No. 4,476,219 (particularly II-17, II-19 (column 17), and II-24 (column 19)), the entire contents of the above documents disclosing the yellow couplers are incorporated herein by reference Magenta couplers: JP-A-3-39737 (L-57 (page 11, lower right column), L-68 (page 12, lower right column), and L-77 (page 13, lower right column); A-4-63 (page 134), and A-4-73 and -75 (page 139) in EP No. 456,257; M-4 and -6 (page 26), and M-7 (page 27) in EP No. 486,965; M-45 (page 19) in EP No. 571,959A; (M−1) (page 6) in JP-A-5-204106; and M-22 in paragraph 0237 of JP-A-4-362631, the entire contents of the above documents disclosing the magenta couplers are incorporated herein by reference.

Cyan couplers: CX-1, CX-3, CX-4, CX-5, CX-11, CX-12, CX-14, and CX-15 (pages 14 to 16) in JP-A-4-204843; C-7 and C-10 (page 35), C-34 and C-35 (page 37), and (1-1) and (1-17) (pages 42 and 43) in JP-A-4-43345; and couplers represented by general formulas (Ia) and (Ib) in claim 1 of JP-A-6-67385, the entire contents of the above documents disclosing the cyan couplers are incorporated herein by reference.

Polymer couplers: P-1 and P-5 (page 11) in JP-A-2-44345, the entire contents of which is incorporated herein by reference.

Couplers for forming a colored dye with a proper diffusibility are preferably those described in U.S. Pat. No. 4,366,237, GB No. 2,125,570, EP No. 96,873B, and DE No. 3,234,533, the entire contents of the above documents disclosing the couplers are incorporated herein by reference.

As couplers for correcting the unnecessary absorption of a colored dye, preferred use is made of, besides the magenta colored yellow couplers of the present invention, yellow colored cyan couplers represented by formulas (CI), (CII), (CIII), and (CIV) described on page 5 in EP No. 456,257A1 (particularly YC-86 on page 84); yellow colored magenta couplers ExM-7 (page 202), Ex-1 (page 249), and EX-7 (page 251) described in EP No. 456,257A1; magenta colored cyan couplers CC-9 (column 8) and CC-13 (column 10) described in U.S. Pat. No. 4,833,069; (2) (column 8) in U.S. Pat. No. 4,837,136; and colorless masking couplers represented by formula (A) in claim 1 of We No. 92/11575 (particularly compound examples on pages 36 to 45), the entire contents of all the documents disclosing the couplers for correcting the unnecessary absorption of a colored dye are incorporated herein by reference.

Examples of compounds (including a coupler) which react with a developing agent in an oxidized form to thereby release a photographically useful compound residue are as follows. Development inhibitor release compounds: compounds represented by formulas (I), (II), (III), and (IV) on page 11 of EP No. 378,236A1 (particularly T-101 (page 30), T-104 (page 31), T-113 (page 36), T-131 (page 45), T-144 (page 51), and T-158 (page 58)); a compound represented by formula (I) on page 7 of EP No. 436,938A2 (particularly D-49 (page 51)); a compound represented by formula (1) in EP No. 568,037A (particularly (23) (page 11)); and compounds represented by formulas (I), (II), and (III) on pages 5 and 6 of EP No. 440,195A2 (particularly 1-(1) on page 29). Bleaching accelerator release compounds: compounds represented by formulas (I) and (I′) on page 5 of EP No. 310,125A2 (particularly (60) and (61) on page 61); and compounds represented by formula (I) in claim 1 of JP-A-6-59411 (particularly (7) (page 7)). Ligand release compounds: compounds represented by LIG-X described in claim 1 of U.S. Pat. No. 4,555,478 (particularly compounds in column 12, lines 21 to 41). Leuco dye release compounds: compounds 1 to 6 in columns 3 to 8 of U.S. Pat. No. 4,749,641. Fluorescent dye release compounds: compounds represented by COUP-DYE in claim 1 of U.S. Pat. No. 4,774,181 (particularly compounds 1 to 11 in columns 7 to 10). Development accelerator or fogging agent release compounds: compounds represented by formulas (1), (2), and (3) in column 3 of U.S. Pat. No. 4,656,123 (particularly (1-22) in column 25); and ExZK-2 on page 75, lines 36 to 38, in EP No. 450,637A2. Compounds which release a group which does not function as a dye unless it splits off: compounds represented by formula (I) in claim 1 of U.S. Pat. No. 4,857,447 (particularly Y-1 to Y-19 in columns 25 to 36).

Preferable examples of additives other than couplers are as follows.

Dispersion mediums of an oil-soluble organic compound: P-3, P-5, P-16, P-19, P-25, P-30, P-42, P-49, P-54, P-55, P-66, P-81, P-85, P-86, and P-93 (pages 140 to 144) in JP-A-62-215272. Impregnating latexes of an oil-soluble organic compound: latexes described in U.S. Pat. No. 4,199,363. Scavengers of developing agent in an oxidized form: compounds represented by formula (I) in column 2, lines 54 to 62, in U.S. Pat. No. 4,978,606 (particularly 1-(1), 1-(2), 1-(6), and 1-(12) (columns 4 and 5)), and formulas in column 2, lines 5 to 10, in U.S. Pat. No. 4,923,787 (particularly compound 1 (column 3)). Stain inhibitors: formulas (I) to (III) on page 4, lines 30 to 33, particularly 1-47, I-72, III-1, and III-27 (pages 24 to 48) in EP No. 298321A. Anti-fading agent: A-6, A-7, A-20, A-21, A-23, A-24, A-25, A-26, A-30, A-37, A-40, A-42, A-48, A-63, A-90, A-92, A-94, and A-164 (pages 69 to 118) in EP No. 298,321A; II-1 to III-23, particularly III-10, in columns 25 to 38 of U.S. Pat. No. 5,122,444; I-1 to III-4, particularly II-2, on pages 8 to 12 in EP No. 471,347A; and A-1 to A-48, particularly A-39 and A-42, in columns 32 to 40 of U.S. Pat. No. 5,139,931. Materials which reduce the use amount of a color enhancer or a color mixing prevention agent: I-1 to II-15, particularly I-46, on pages 5 to 24 in EP No. 411,324A. Formalin scavengers: SCV-1 to SCV-28, particularly SCV-8, on pages 24 to 29 in EP No. 477,932A. Film hardeners: H-1, H-4, H-6, H-8, and H-14 on page 17 in JP-A-1-214845; compounds (H-1 to H-54) represented by formulas (VII) to (XII) in columns 13 to 23 of U.S. Pat. No. 4,618,573; compounds (H-1 to H-76), particularly H-14, represented by formula (6) on page 8, lower right column, in JP-A-2-214852; and compounds described in claim 1 of U.S. Pat. No. 3,325,287. Development inhibitor precursors: P-24, P-37, and P-39 (pages 6 and 7) in JP-A-62-168139; and compounds described in claim 1, particularly 28 and 29 in column 7, of U.S. Pat. No. 5,019,492. Antiseptic agents and mildewproofing agents; I-1 to III-43, particularly II-1, II-9, II-10, 11-18, and III-25, in columns 3 to 15 of U.S. Pat. No. 4,923,790. Stabilizers and antifoggants: I-1 to (14), particularly I-1, I-60, (2), and (13), in columns 6 to 16 of U.S. Pat. No. 4,923,793; and compounds 1 to 65, particularly compound 36, in columns 25 to 32 of U.S. Pat. No. 4,952,483. Chemical sensitizers: triphenylphosphine, selenide, and compound 50 in JP-A-5-40324. Dyes: a-1 to b-20, particularly a-1, a-12, a-18, a-27, a-35, a-36, and b-5, on pages 15 to 18 and V-1 to V-23, particularly V-1, on pages 27 to 29 in JP-A-3-156450; F-1-1 to F-II-43, particularly F-1-11 and F-II-8, on pages 33 to 55 in EP No. 445,627A; III-1 to III-36, particularly III-1 and III-3, on pages 17 to 28 in EP No. 457,153A; microcrystalline dispersions of Dye-1 to Dye-124 on pages 8 to 26 in WO No. 88/04794; compounds 1 to 22, particularly compound 1, on pages 6 to 11 in EP No. 319,999A; compounds D-1 to D-87 (pages 3 to 28) represented by formulas (1) to (3) in EP No. 519,306A; compounds 1 to 22 (columns 3 to 10) represented by formula (I) in U.S. Pat. No. 4,268,622; and compounds (1) to (31) (columns 2 to 9) represented by formula (I) in U.S. Pat. No. 4,923,788. UV absorbents: compounds (18b) to (18r) and 101 to 427 (pages 6 to 9) represented by formula (1) in JP-A-46-3335; compounds (3) to (66) (pages 10 to 44) represented by formula (I) and compounds HBT-1 to HBT-10 (page 14) represented by formula (III) in EP No. 520,938A; and compounds (1) to (31) (columns 2 to 9) represented by formula (1) in EP No. 521,823A.

The present invention can be applied to various black-and-white photosensitive materials such as black-and-white papers, black-and-white negative films and roentgen films, and color photosensitive materials such as color negative films for general purposes or cinemas, color reversal films for slides and TV, color paper, color positive films and color reversal paper. Moreover, the present invention is suitable to lens equipped film units described in JP-B-2-32615 and Jpn. Utility Model Appln. KOKOKU Publication No. 3-39784.

Supports which can be suitably used in the present invention are described in, e.g., RD. No. 17643, page 28; RD. No. 18716, from the right column of page 647 to the left column of page 648; and RD. No. 307105, page 879.

In the photosensitive material of the present invention, the total of film thicknesses of all hydrophilic colloid layers on the side having emulsion layers is preferably 28 μm or less, more preferably 23 μm or less, still more preferably 18 μm or less, and most preferably 16 μm or less. Film swelling speed T_{1/2} is preferably 30 sec or less, more preferably 20 sec or less. The film swelling speed T_{1/2} is defined as the time that, when the saturation film thickness means 90% of the maximum swollen film thickness realized by the processing in a color developing solution at 30° C. for 3 min 15 sec, spent for the film thickness to reach ½ of the saturation film thickness. The film thickness means one measured under moisture conditioning at 25° C. and at a relative humidity of 55% (two days). The film swelling speed T_{1/2} can be measured by using a swellometer described in A. Green et al., Photogr. Sci. Eng., Vol. 19, No. 2, pp. 124 to 129. The film swelling speed T_{1/2} can be regulated by adding a film hardening agent to gelatin as a binder or by changing aging conditions after coating. The swelling ratio preferably ranges from 150 to 400%. The swelling ratio can be calculated from the maximum swollen film thickness measured under the above conditions in accordance with the formula:

[maximum swollen film thickness−film thickness]/film thickness.

In the photosensitive material of the present invention, hydrophilic colloid layers (called “back layers”) having a total dried film thickness of 2 to 20 μm are preferably formed on the side opposite to the side having emulsion layers. The back layers preferably contain the above light absorbent, filter dye, ultraviolet absorbent, antistatic agent, film hardener, binder, plasticizer, lubricant, coating aid and surfactant. The swelling ratio of the back layers is preferably 150% to 500%.

The photosensitive material of the present invention can be developed by conventional methods described in the above mentioned RD. No. 17643, pages 28 and 29; RD. No. 18716, page 651, left to right columns; and RD No. 307105, pages 880 and 881.

The color negative film processing solution for use in the present invention will be described below.

The compounds listed in page 9, right upper column, line 1 to page 11, left lower column, line 4 of JP-A-4-121739 can be used in the color developing solution for use in the present invention. Preferred color developing agents for use in especially rapid processing are 2-methyl-4-[N-ethyl-N-(2-hydroxyethyl)amino]aniline, 2-methyl-4-[N-ethyl-N-(3-hydroxypropyl)amino]aniline and 2-methyl-4-[N-ethyl-N-(4-hydroxybutyl)amino]aniline.

These color developing agents are preferably used in an amount of 0.01 to 0.08 mol, more preferably 0.015 to 0.06 mol, and much more preferably 0.02 to 0.05 mol per liter (L) of the color developing solution. The replenisher of the color developing solution preferably contains the color developing agent in an amount corresponding to 1.1 to 3 times the above concentration, more preferably 1.3 to 2.5 times the above concentration.

Hydroxylamine can widely be used as preservatives of the color developing solution. When enhanced preserving properties are required, it is preferred to use hydroxylamine derivatives having substituents for example, alkyl, hydroxyalkyl, sulfoalkyl and carboxyalkyl groups, examples of which include N,N-di(sulfoehtyl)hydroxylamine, monomethylhydroxylamine, dimethylhydroxylamine, monoethylhydroxylamine, diethylhydroxylamine and N,N-di(carboxyethyl)hydroxylamine. Of these, N,N-di(sulfoehtyl)hydroxylamine is most preferred. Although these may be used in combination with the hydroxylamine, it is preferred that one or at least two members thereof be used in place of the hydroxylamine.

These preservatives are preferably used in an amount of 0.02 to 0.2 mol, more preferably 0.03 to 0.15 mol, and most preferably 0.04 to 0.1 mol per liter of the color developing solution. The replenisher of the color developing solution preferably contains the preservative in an amount corresponding to 1.1 to 3 times the concentration of the mother liquor (processing tank solution) as in the color developing agent.

Sulfurous salts are used as tarring preventives for the color developing agent in an oxidized form in the color developing solution. Each sulfurous salt is preferably used in the color developing solution in an amount of 0.01 to 0.05 mol, more preferably 0.02 to 0.04 mol per liter, and is preferably used in the replenisher in an amount corresponding to 1.1 to 3 times the above concentration.

The pH value of the color developing solution preferably ranges from 9.8 to 11.0, more preferably from 10.0 to 10.5. That of the replenisher is preferably set at 0.1 to 1.0 higher than the above value. Common buffers such as carbonate, phosphonate, sulfosalicylate and borate are used for stabilizing the above pH value.

Although the amount of the replenisher of the color developing solution preferably ranges from 80 to 1300 mL per m² of the photosensitive material, it is desired that the amount be smaller from the viewpoint of reducing environmental pollution load. Specifically, the amount of the replenisher more preferably ranges from 80 to 600 mL, most preferably from 80 to 400 mL.

Although the bromide ion concentration of the color developing solution generally ranges from 0.01 to 0.06 mol per liter, it is preferred that the above concentration be set at 0.015 to 0.03 mol per liter for inhibiting fog while maintaining sensitivity to thereby improve discrimination and for bettering graininess. When the bromide ion concentration is set so as to fall within the above range, the replenisher preferably contains bromide ion in a concentration as calculated by the following formula. However, when C is negative, it is preferred that no bromide ion be contained in the replenisher.

C=A−W/V

wherein

C: bromide ion concentration of the color developing replenisher (mol/L),

A: target bromide ion concentration of the color developing solution (mol/L),

W: amount of bromide ion leached from the photosensitive material into the color developing solution when a color development of 1 m² of the photosensitive material has been carried out (mol), and

V: amount of color developing replenisher supplied per m² of the photosensitive material (L).

Development accelerators such as pyrazolidones represented by 1-phenyl-3-pyrazolidone and 1-phenyl-2-methyl-2-hydroxymethyl-3-pyrazolidone and thioether compounds represented by 3,6-dithia-1,8-octanediol are preferably used for means for enhancing sensitivity when the amount of the replenisher has been reduced or when a high bromide ion concentration has been set.

Compounds and processing conditions described on page 4, left lower column, line 16 to page 7, left lower column, line 6 of JP-A-4-125558 can be applied to the processing solution having bleaching capability for use in the present invention. Preferable bleaching agents are those having a redox potential of 150 mV or more, and the specific examples and preferable ones are those described in JP-A′-5-72694 and 5-173312, especially preferably 1,3-diaminopropane tetra-acetic acid, and ferric complex salt of the compound of the specific example 1 set forth on page 7 of JP-A-5-173312.

For improving the biodegradability of the bleaching agent, it is preferred that ferric complex salts of compounds listed in JP-A's-4-251845, and 4-268552, EP Nos. 588,289, and 591,934 and JP-A-6-208213 be used as the bleaching agent. The concentration of the above bleaching agent preferably ranges from 0.05 to 0.3 mol per liter of the solution having bleaching capability, and it is especially preferred that a design be made at 0.1 to 0.15 mol per liter for reducing the discharge to the environment. When the solution having bleaching capability is a bleaching solution, a bromide is preferably incorporated therein in an amount of 0.2 to 1 mol, more preferably 0.3 to 0.8 mol per liter.

Each component is incorporated in the replenisher of the solution having bleaching capability fundamentally in a concentration calculated by the following formula. This enables holding the concentration of the mother liquor constant.

C_{R}═C_{T}×(V₁+V₂)/V₁+C_{P}

C_{R}: concentration of each component in the replenisher,

C_{T}: concentration of the component in the mother liquor (processing tank solution),

C_{P}: component concentration consumed during processing,

V₁: amount of replenisher having bleaching capability supplied per m² of photosensitive material (mL), and

V₂: amount carried from previous bath by 1 m² of photosensitive material (mL).

In addition, a pH buffer is preferably incorporated in the bleaching solution, and it is especially preferred to incorporate a dicarboxylic acid of low order such as succinic acid, maleic acid, malonic acid, glutaric acid or adipic acid. It is also preferred to use common bleaching accelerators listed in JP-A-53-95630, RD No. 17129 and U.S. Pat. No. 3,893,858.

The bleaching solution is preferably replenished with 50 to 1000 mL, more preferably 80 to 500 mL, and much more preferably 100 to 300 mL, of a bleaching replenisher per m² of the photosensitive material. Further, the bleaching solution is preferably aerated.

Compounds and processing conditions described on page 7, left lower column, line 10 to page 8, right lower column, line 19 of JP-A-4-125558 can be applied to a processing solution having fixing capability.

For enhancing the fixing velocity and preservability, it is especially preferred to incorporate compounds represented by the general formulae (I) and (II) of JP-A-6-301169 either individually or in combination in the processing solution having fixing capability. Further, the use of p-toluenesulfinic salts and sulfinic acids listed in JP-A-1-224762 is preferred from the viewpoint of enhancing the preservability.

Although the incorporation of an ammonium as a cation in the solution having bleaching capability or solution having fixing capability is preferred from the viewpoint of enhancing the bleach ability, it is preferred that the amount of ammonium be reduced or brought to nil from the viewpoint of minimizing environmental pollution.

Conducting jet agitation described in JP-A-1-309059 is especially preferred in the bleach, bleach-fix and fixation steps.

The amount of replenisher supplied in the bleach-fix or fixation step is in the range of 100 to 1000 mL, preferably 150 to 700 mL, and especially preferably 200 to 600 mL, per m² of the photosensitive material.

Silver is preferably recovered by installing any of various silver recovering devices in an in-line or off-line mode in the bleach-fix or fixation step. In-line installation enables processing with the silver concentration of the solution lowered, so that the amount of replenisher can be reduced. It is also suitable to conduct an off-line silver recovery and recycle residual solution for use as a replenisher.

The bleach-fix and fixation steps can each be constructed by a plurality of processing tanks. Preferably, the tanks are provided with cascade piping and a multistage counterflow system is adopted. A 2-tank cascade structure is generally effective from the viewpoint of a balance with the size of the developing machine. The ratio of processing time in the former-stage tank to that in the latter-stage tank is preferably in the range of 0.5:1 to 1:0.5, more preferably 0.8:1 to 1:0.8.

From the viewpoint of enhancing the preservability, it is preferred that a chelating agent which is free without forming any metal complex be present in the bleach-fix and fixing solutions. Biodegradable chelating agents described in connection with the bleaching solution are preferably used as such a chelating agent.

Descriptions made on page 12, right lower column, line 6 to page 13, right lower column, line 16 of JP-A-4-125558 mentioned above can preferably be applied to water washing and stabilization steps. In particular, with respect to stabilizing solutions, the use of azolylmethylamines described in EP Nos. 504,609 and 519,190 and N-methylolazoles described in JP-A-4-362943 in place of formaldehyde and the dimerization of magenta coupler into a surfactant solution not containing an image stabilizer such as formaldehyde are preferred from the viewpoint of protecting working environment.

To reduce adhesion of dust to a magnetic recording layer formed on a photosensitive material, a stabilizer described in JP-A-6-289559 can be preferably used.

The replenishment rate of washing water and a stabilizer is preferably 80 to 1,000 mL, more preferably, 100 to 500 mL, and most preferably, 150 to 300 mL per m² of a photosensitive material in order to maintain the washing and stabilization functions and at the same time reduce the waste liquors for environmental protection. In processing performed with this replenishment rate, it is preferable to prevent the propagation of bacteria and mildew by using known mildewproofing agents such as thiabendazole, 1,2-benzoisothiazoline-3-one, and 5-chloro-2-methylisothiazoline-3-one, antibiotics such as gentamicin, and water deionized by an ion exchange resin or the like. It is more effective to use deionized water together with a mildewproofing agent or an antibiotic.

The replenishment rate of a solution in a washing water tank or stabilizer tank is preferably reduced by performing reverse permeable membrane processing described in JP-A's-3-46652, 3-53246, 3-55542, 3-121448, and 3-126030. A reverse permeable membrane used in this processing is preferably a low-pressure reverse permeable membrane.

In the processing of the present invention, it is particularly preferable to perform processing solution evaporation correction disclosed in Journal of Technical Disclosure No. 94-4992. In particular, a method of performing correction on the basis of (formula-1) on page 2 by using temperature and humidity information of an environment in which a processor is installed is preferable. Water for use in this evaporation correction is preferably taken from the washing water replenishment tank. If this is the case, deionized water is preferably used as the washing replenishing water.

Processing agents described in aforementioned Journal of Technical Disclosure No. 94-4992, page 3, right column, line 15 to page 4, left column, line 32 are preferably used in the present invention. As a processor for these processing agents, a film processor described on page 3, right column, lines 22 to 28 is preferable.

Practical examples of processing agents, automatic processors, and evaporation correction methods suited to practicing the present invention are described in the same Journal of Technical Disclosure No. 94-4992, page 5, right column, line 11 to page 7, right column, last line.

Processing agents used in the present invention can be supplied in any form: a liquid agent having the concentration of a solution to be used, concentrated liquid agent, granules, powder, tablets, paste, and emulsion. Examples of such processing agents are a liquid agent contained in a low-oxygen permeable vessel disclosed in JP-A-63-17453, vacuum-packed powders and granules disclosed in JP-A's-4-19655 and 4-230748, granules containing a water-soluble polymer disclosed in JP-A-4-221951, tablets disclosed in JP-A's-51-61837 and 6-102628, and a paste disclosed in PCT KOHYO Publication No. 57-500485. Although any of these processing agents can be preferably used, the use of a liquid adjusted to have the concentration of a solution to be used is preferable for the sake of convenience in use.

As a vessel for containing these processing agents, polyethylene, polypropylene, polyvinylchloride, polyethyleneterephthalate, and nylon are used singly or as a composite material. These materials are selected in accordance with the level of necessary oxygen permeability. For a readily oxidizable solution such as a color developer, a low-oxygen permeable material is preferable. More specifically, polyethyleneterephthalate or a composite material of polyethylene and nylon is preferable. A vessel made of any of these materials preferably has a thickness of 500 to 1,500 μm and an oxygen permeability of 20 mL/m²·24 hrs·atm or less.

Color reversal film processing solutions used in the present invention will be described below. Processing for a color reversal film is described in detail in Aztech Ltd., Known Technology No. 6 (1991, April 1), page 1, line 5 to page 10, line 5 and page 15, line 8 to page 24, line 2, and any of the contents can be preferably applied.

In this color reversal film processing, an image stabilizing agent is contained in a control bath or a final bath. Preferable examples of this image stabilizing agent are formalin, sodium formaldehyde-bisulfite, and N-methylolazole. Sodium formaldehyde-bisulfite or N-methylolazole is preferable in terms of work environment, and N-methyloltriazole is particularly preferable as N-methylolazole. The contents pertaining to a color developer, bleaching solution, fixing solution, and washing water described in the color negative film processing can be preferably applied to the color reversal film processing.

Preferable examples of color reversal film processing agents containing the above contents are an E-6 processing agent manufactured by Eastman Kodak Co. and a CR-56 processing agent manufactured by Fuji Photo Film Co., Ltd.

The magnetic recording layer that is preferably used in the present invention will be explained.

The magnetic recording layer is the one obtained by coating a support with a water-base or organic solvent coating liquid having magnetic material grains dispersed in a binder.

The magnetic material grains for use in the present invention can be composed of any of ferromagnetic iron oxides such as γFe₂O₃, Co coated γFe₂O₃, Co coated magnetite, Co containing magnetite, ferromagnetic chromium dioxide, ferromagnetic metals, ferromagnetic alloys, Ba ferrite of hexagonal system, Sr ferrite, Pb ferrite and Ca ferrite. Of these, Co coated ferromagnetic iron oxides such as Co coated γFe₂O₃ are preferred. The configuration thereof may be any of acicular, rice grain, spherical, cubic and plate shapes. The specific surface area is preferably at least 20 m²/g, more preferably at least 30 m²/g in terms of S_{BET}. The saturation magnetization (σs) of the ferromagnetic material preferably ranges from 3.0×10⁴ to 3.0×10⁵ A/m, more preferably from 4.0×10⁴ to 2.5×10⁵ A/m. The ferromagnetic material grains may have their surface treated with silica and/or alumina or an organic material. Further, the magnetic material grains may have their surface treated with a silane coupling agent or a titanium coupling agent as described in JP-A-6-161032. Still further, use can be made of magnetic material grains having their surface coated with an organic or inorganic material as described in JP-A's-4-259911 and 5-81652.

The binder for use in the magnetic material grains can be composed of any of natural polymers (e.g., cellulose derivatives and sugar derivatives), acid-, alkali- or bio-degradable polymers, reactive resins, radiation curable resins, thermosetting resins and thermoplastic resins listed in JP-A-4-219569 and mixtures thereof. The Tg of each of the above resins ranges from −40 to 300° C. and the weight average molecular weight thereof ranges from 2 thousand to 1 million. For example, vinyl copolymers, cellulose derivatives such as cellulose diacetate, cellulose triacetate, cellulose acetate propionate, cellulose acetate butyrate and cellulose tripropionate, acrylic resins and polyvinylacetal resins can be mentioned as suitable binder resins. Gelatin is also a suitable binder resin. Of these, cellulose di(tri)acetate is especially preferred. The binder can be cured by adding an epoxy, aziridine or isocyanate crosslinking agent. Suitable isocyanate crosslinking agents include, for example, isocyanates such as tolylene diisocyanate, 4,4′-diphenylmethane diisocyanate, hexamethylene diisocyanate and xylylene diisocyanate, reaction products of these isocyanates and polyhydric alcohols (e.g., reaction product of 3 mol of tolylene diisocyanate and 1 mol of trimethylolpropane), and polyisocyanates produced by condensation of these isocyanates, as described in, for example, JP-A-6-59357.

The method of dispersing the magnetic material in the above binder preferably comprises using a kneader, a pin type mill and an annular type mill either individually or in combination as described in JP-A-6-35092. Dispersants listed in JP-A-5-088283 and other common dispersants can be used. The thickness of the magnetic recording layer ranges from 0.1 to 10 μm, preferably 0.2 to 5 μm, more preferably 0.3 to 3 μm. The weight ratio of magnetic material grains to binder is preferably in the range of 0.5:100 to 60:100, more preferably 1:100 to 30:100. The coating amount of magnetic material grains ranges from 0.005 to 3 g/m², preferably from 0.01 to 2 g/m², and more preferably from 0.02 to 0.5 g/m². The transmission yellow density of the magnetic recording layer is preferably in the range of 0.01 to 0.50, more preferably 0.03 to 0.20, and most preferably 0.04 to 0.15. The magnetic recording layer can be applied to the back of a photographic support in its entirety or in striped pattern by coating or printing. The magnetic recording layer can be applied by the use of, for example, an air doctor, a blade, an air knife, a squeeze, an immersion, reverse rolls, transfer rolls, a gravure, a kiss, a cast, a spray, a dip, a bar or an extrusion. Coating liquids set forth in JP-A-5-341436 are preferably used.

The magnetic recording layer may also be provided with, for example, lubricity enhancing, curl regulating, antistatic, sticking preventive and head polishing functions, or other functional layers may be disposed to impart these functions. An abrasive of grains whose at least one member is nonspherical inorganic grains having a Mohs hardness of at least 5 is preferred. The nonspherical inorganic grains are preferably composed of fine grains of any of oxides such as aluminum oxide, chromium oxide, silicon dioxide and titanium dioxide; carbides such as silicon carbide and titanium carbide; and diamond. These abrasives may have their surface treated with a silane coupling agent or a titanium coupling agent. The above grains may be added to the magnetic recording layer, or the magnetic recording layer may be overcoated with the grains (e.g., as a protective layer or a lubricant layer). The binder which is used in this instance can be the same as mentioned above and, preferably, the same as the that of the magnetic recording layer. The photosensitive material having the magnetic recording layer is described in U.S. Pat. Nos. 5,336,589, 5,250,404, 5,229,259 and 5,215,874 and EP No. 466,130.

The polyester support preferably used in the present invention will be described below. Particulars thereof together with the below mentioned light-sensitive material, processing, cartridge and working examples are specified in JIII Journal of Technical Disclosure No. 94-6023 (issued by Japan Institute of Invention and Innovation on Mar. 15, 1994). The polyester for use in the present invention is prepared from a diol and an aromatic dicarboxylic acid as essential components. Examples of suitable aromatic dicarboxylic acids include 2,6-, 1,5-, 1,4- and 2,7-naphthalenedicarboxylic acids, terephthalic acid, isophthalic acid and phthalic acid, and examples of suitable diols include diethylene glycol, triethylene glycol, cyclohexanedimethanol, bisphenol A and other bisphenols. The resultant polymers include homopolymers such as polyethylene terephthalate, polyethylene naphthalate and polycyclohexanedimethanol terephthalate. Polyesters containing 2,6-naphthalenedicarboxylic acid in an amount of 50 to 100 mol % are especially preferred. Polyethylene 2,6-naphthalate is most preferred. The average molecular weight thereof ranges from approximately 5,000 to 200,000. The Tg of the polyester for use in the present invention is at least 50° C., preferably at least 90° C.

The polyester support is subjected to heat treatment at a temperature of from 40° C. to less than Tg, preferably from Tg minus 20° C. to less than Tg, in order to suppress curling. This heat treatment may be conducted at a temperature held constant within the above temperature range or may be conducted while cooling. The period of heat treatment ranges from 0.1 to 1500 hr, preferably 0.5 to 200 hr. The support may be heat treated either in the form of a roll or while being carried in the form of a web. The surface form of the support may be improved by rendering the surface irregular (e.g., coating with conductive inorganic fine grains of SnO₂, Sb₂O₅, etc.). Moreover, a scheme is desired such that edges of the support are knurled so as to render only the edges slightly high, thereby preventing photographing of core sections. The above heat treatment may be carried out in any of stages after support film formation, after surface treatment, after back layer application (e.g., application of an antistatic agent or a lubricant) and after undercoating application. The heat treatment is preferably performed after antistatic agent application.

An ultraviolet absorber may be milled into the polyester. Light piping can be prevented by milling, into the polyester, dyes and pigments commercially available as polyester additives, such as Diaresin produced by Mitsubishi Chemical Industries, Ltd. and Kayaset produced by NIPPON KAYAKU CO., LTD.

Surface treatment is preferably performed for adhering the support and the photosensitive material constituting layers to each other. Examples thereof include chemical, mechanical, corona discharge, flaming, ultraviolet irradiation, high-frequency, glow discharge, active plasma, laser, mixed acid, ozonization and other surface activating treatments. Of these surface treatments, ultraviolet irradiation, flaming, corona discharge and glow discharge treatments are preferred.

Now, the substratum will be described below:

The substratum may be composed of a single layer or two or more layers. As the binder for the substratum, there can be mentioned not only copolymers prepared from monomers, as starting materials, selected from among vinyl chloride, vinylidene chloride, butadiene, methacrylic acid, acrylic acid, itaconic acid and maleic anhydride but also polyethyleneimine, an epoxy resin, a grafted gelatin, nitrocellulose, gelatin, polyvinyl alcohol and modified polymere of these polymers. Resorcin or p-chlorophenol is used as a support-swelling compound. A gelatin hardener such as a chromium salt (e.g., chrome alum), an aldehyde (e.g., formaldehyde or glutaraldehyde), an isocyanate, an active halogen compound (e.g., 2,4-dichloro-6-hydroxy-s-triazine), an epichlorohydrin resin or an active vinyl sulfone compound can be used in the substratum. Also, SiO2, TiO₂, inorganic fine grains or polymethyl methacrylate copolymer fine grains (0.01 to 10 μm) may be incorporated therein as a matting agent.

In the present invention, further, an antistatic agent is preferably used. As the antistatic agent, there can be mentioned a polymer containing a carboxylic acid and a carboxylic acid salt or sulfonic acid salt, a cationic polymer and an ionic surfactant compound.

Most preferable antistatic agent consists of fine particles of a crystalline metal oxide of 10⁷ Ω·cm or less, preferably 10⁵ Ω·cm or less, volume resistivity with a particle size of 0.001 to 1.0 μm, constituted of at least one member selected from among ZnO, TiO₂, SnO₂, Al₂O₃, In₂O₃, SiO₂, MgO, BaO, MoO₃ and V₂O₅, or a composite oxide thereof (e.g., Sb, P, B, In, S, Si or C), or fine particles of such a metal oxide or composite oxide thereof in sol form. The content of antistatic agent in the photosensitive material is preferably in the range of 5 to 500 mg/m², more preferably 10 to 350 mg/m². The quantitative ratio of conductive crystalline oxide or composite oxide thereof to binder is preferably in the range of 1/300 to 100/1, more preferably 1/100 to 100/5.

The photosensitive material of the present invention preferably has sliding property. The layer containing a sliding agent is preferably provided on both light-sensitive side and backside. Preferable sliding property, in terms of coefficient of dynamic friction, is 0.25 or less but 0.01 or more. By the measurement, there can be obtained the value at 60 cm/min carriage on a stainless steel ball of 5 mm diameter (25° C., 60%RH). Even if the evaluation is made with the opposite material replaced by a light-sensitive layer surface, the value of substantially the same level can be obtained.

Examples of suitable sliding agents include polyorganosiloxanes, higher fatty acid amides, higher fatty acid metal salts and esters of higher fatty acids and higher alcohols. As the polyorganosiloxanes, there can be employed, for example, polydimethylsiloxane, polydiethylsiloxane, polystyrylmethylsiloxane and polymethylphenylsiloxane. The layer to be loaded with the sliding agent is preferably an outermost one of emulsion layers or a back layer. Polydimethylsiloxane and an ester having a long-chain alkyl group are especially preferred. For preventing silver halide pressure marks and desensitization, silicone oil and chlorinated paraffin are preferably used.

In the photosensitive material of the present invention, a matting agent is preferably contained. The matting agent, although can be contained in the emulsion side or the backside, is most preferably incorporated in an outermost layer of the emulsion side. The matting agent may be soluble, or insoluble, in processing solutions. It is preferred that soluble and insoluble matting agents be used in combination. For example, polymethyl methacrylate, polymethyl methacrylate/methacrylic acid (9/1 or 5/5 in molar ratio) and polystyrene particles are preferred. The particle diameter is preferably in the range of 0.8 to 10 μm, and a narrow particle diameter distribution is preferred. It is preferred that 90% or more of all the particles have diameters which fall within 0.9 to 1.1 times the average particle diameter. For enhancing matting properties, it is also preferred to simultaneously add fine particles of up to 0.8 μm. As such fine particles, there can be mentioned, for example, polymethyl methacrylate (0.2 μm), polymethyl methacrylate/methacrylic acid (9/1 in molar ratio, 0.3 μm), polystyrene particles (0.25 μm) and colloidal silica (0.03 μm).

The film patrone employed in the present invention will be described below. The main material composing the patrone for use in the present invention may be a metal or a synthetic plastic.

Examples of preferable plastic materials include polystyrene, polyethylene, polypropylene and polyphenyl ether. The patrone for use in the present invention may contain various types of antistatic agents and can preferably contain, for example, carbon black, metal oxide grains, nonionic, anionic, cationic or betaine type surfactants and polymers. Such an antistatic patrone is described in JP-A's-1-312537 and 1-312538. The resistance thereof at 25° C. in 25% RH is preferably 10¹² Ω or less. The plastic patrone is generally molded from a plastic having carbon black or a pigment milled thereinto for imparting light shielding properties. The patrone size may be the same as the current size 135, or for miniaturization of cameras, it is advantageous to decrease the diameter of the 25 mm cartridge of the current size 135 to 22 mm or less. The volume of the case of the patrone is preferably 30 cm³ or less, more preferably 25 cm³ or less. The weight of the plastic used in each patrone or patrone case preferably ranges from 5 to 15 g.

In addition, a patrone capable of feeding a film out by rotating a spool may be used. Further, the patrone may be so structured that a film front edge is accommodated in the main frame of the patrone and that the film front edge is fed from a port part of the patrone to the outside by rotating a spool shaft in a film feeding out direction. These are disclosed in U.S. Pat. Nos. 4,834,306 and 5,226,613. The photographic film used in the invention may be a so-called raw film, which is a film before development, or may be a development processed photographic film. Also, the raw film and the development processed film may be contained in a same new patrone or may be contained in separate patrones.

The color photosensitive material of the present invention is also suitably used as a negative film for an advanced photo system (to be referred to as an APS hereinafter). Examples are NEXIA A, NEXIA F, and NEXIA H (ISO 200, 100, and 400, respectively) manufactured by Fuji Photo Film Co., Ltd. (to be referred to as Fuji Film hereinafter). These films are so processed as to have an APS format and set in an exclusive cartridge. These APS cartridge films are loaded into APS cameras such as the Fuji Film EPION Series represented by the EPION 300Z. The color photosensitive film of the present invention is also suited as a film with lens such as Fuji Film FUJICOLOR UTSURUNDESU (Quick Snap) SUPER SLIM.

A photographed film is printed through the following steps in a miniature laboratory system.

(1) Reception (an exposed cartridge film is received from a customer)

(2) Detaching step (the film is transferred from the cartridge to an intermediate cartridge for development)

(3) Film development

(4) Reattaching step (the developed negative film is returned to the original cartridge)

(5) Printing (prints of three types C, H, and P and an index print are continuously automatically printed on color paper [preferably Fuji Film SUPER FA8])

(6) Collation and shipment (the cartridge and the index print are collated by an ID number and shipped together with the prints) As these systems, the Fuji Film MINILABO CHAMPION SUPER FA-298, FA-278, FA-258, FA-238 are preferable. Examples of a film processor are the FP922AL, FP562B, FP562BL, FP362B, and FP3622BL, and a recommended processing chemical is the FUJICOLOR JUST-IT CN-16L. Examples of a printer processor are the PP3008AR, PP3008A, PP1828AR, PP1828A, PP1258AR, PP1258A, PP728AR, and PP728A, and a recommended processing chemical is the FUJICOLOR JUST-IT CP-47L. A detacher used in the detaching step and a reattacher used in the reattaching step are preferably the Fuji Film DT200 or DT100 and AT200 or AT100, respectively.

The APS can also be enjoyed by PHOTO JOY SYSTEM whose main component is the Fuji Film Aladdin 1000 digital image scanner. For example, a developed APS cartridge film is directly loaded into the Aladdin 1000, or image information of a negative film, positive film, or print is input to the Aladdin 1000 by using the FE-550 35-mm film scanner or the PE-550 flat head scanner. Obtained digital image data can be easily processed and edited. This data can be printed out by the NC-550AL digital color printer using a photo-fixing heat-sensitive color printing system or the PICTOROGRAPHY 3000 using a laser exposure thermal development transfer system, or by existing laboratory equipment through a film recorder. The Aladdin 1000 can also output digital information directly to a floppy® disk or Zip disk or to an CD-R via a CD writer.

In a home, a user can enjoy photographs on a TV set simply by loading a developed APS cartridge film into the Fuji Film Photo Player AP-1. Image information can also be continuously input to a personal computer by loading a developed APS cartridge film into the Fuji Film Photo Scanner AS-1. The Fuji Film Photo Vision FV-10 or FV-5 can be used to input a film, print, or three-dimensional object. Furthermore, image information recorded in a floppy® disk, Zip disk, CD-R, or hard disk can be variously processed on a computer by using the Fuji Film Photo Factory application software. The Fuji Film NC-2 or NC-2D digital color printer using a photo-fixing heat-sensitive color printing system is suited to outputting high-quality prints from a personal computer.

To keep developed APS cartridge films, the FUJICOLOR POCKET ALBUM AP-5 POP L, AP-1 POP L, or AP-1 POP KG, or the CARTRIDGE FILE 16 is preferable.

### EXAMPLE

The examples of the present invention will be set forth below, however, the present invention is not limited to these examples.

### Example 1

1) Support

The support employed in this Example was prepared by the following procedure. 1) First layer and substratum:

Both major surfaces of a 90 μm thick polyethylene naphthalate support were treated with glow discharge under such conditions that the treating ambient pressure was 2.66×10 Pa, the H₂O partial pressure of ambient gas 75%, the discharge frequency 30 kHz, the output 2500 W, and the treating strength 0.5 kV·A·min/m². This support was coated, in a coating amount of 5 mL/m², with a coating liquid of the following composition to provide the 1st layer in accordance with the bar coating method described in JP-B-58-4589.

| | | |
|---|---|---|
| Conductive fine grain dispersion | 50 | pts.wt. |
| (SnO₂/Sb₂O₅ grain conc. 10% water | | |
| dispersion, secondary agglomerate of | | |
| 0.005 μm diam. primary grains which | | |
| has an av. grain size of 0.05 μm) | | |
| Gelatin | 0.5 | pt.wt. |
| Water | 49 | pts.wt. |
| Polyglycerol polyglycidyl ether | 0.16 | pt.wt. |
| Polyoxyethylene sorbitan monolaurate | 0.1 | pt.wt. |
| (polymn. degree 20) | | |

The support furnished with the first coating layer was wound round a stainless steel core of 20 cm diameter and heated at 110° C. (Tg of PEN support: 119° C.) for 48 hr to thereby effect heat history annealing. The other side of the support opposite to the first layer was coated, in a coating amount of 10 mL/m², with a coating liquid of the following composition to provide a substratum for emulsion in accordance with the bar coating method.

| | | |
|---|---|---|
| Gelatin | 1.01 | pts.wt. |
| Salicylic acid | 0.30 | pt.wt. |
| Resorcin | 0.40 | pt.wt. |
| Polyoxyethylene nonyiphenyl ether | 0.11 | pt.wt. |
| (polymn. degree 10) | | |
| Water | 3.53 | pts.wt. |
| Methanol | 84.57 | pts.wt. |
| n-Propanol | 10.08 | pts.wt. |

Furthermore, the following second layer and third layer were superimposed in this sequence on the first layer by coating. Finally, multilayer coating of a color negative photosensitive material of the composition indicated below was performed on the opposite side. Thus, a transparent magnetic recording medium with silver halide emulsion layers was obtained.

2) Second Layer (Transparent Magnetic Recording Layer):

(1) Dispersion of Magnetic Substance:

1100 parts by weight of Co-coated γ-Fe₂O₃ magnetic substance (average major axis length: 0.25 μm, SBET: 39 m²/g, Hc: 6.56×10⁴ A/m, as: 77.1 Am²/kg, and σr: 37.4 Am²/kg), 220 parts by weight of water and 165 parts by weight of silane coupling agent (3-(poly(polymerization degree: 10)oxyethyl)oxypropyltrimethoxysilane) were fed into an open kneader, and blended well for 3 hr. The resultant coarsely dispersed viscous liquid was dried at 70° C. round the clock to thereby remove water, and heated at 110° C. for 1 hr. Thus, surface treated magnetic grains were obtained.

Further, in accordance with the following recipe, a composition was prepared by blending by means of the open kneader once more for 4 hr:

Thus obtained surface treated

| | |
|---|---|
| magnetic grains | 855 g |
| Diacetylcellulose | 25.3 g |
| Methyl ethyl ketone | 136.3 g |
| Cyclohexanone | 136.3 g |

Still further, in accordance with the following recipe, a composition was prepared by carrying out fine dispersion by means of a sand mill (1/4G sand mill) at 2000 rpm for 4 hr. Glass beads of 1 mm diameter were used as medium.

| | |
|---|---|
| Thus obtained blend liquid | 45 g |
| Diacetylcellulose | 23.7 g |
| Methyl ethyl ketone | 127.7 g |
| Cyclohexanone | 127.7 g |

Moreover, in accordance with the following recipe, a magnetic substance containing intermediate liquid was prepared.

(2) Preparation of Magnetic Substance Containing Intermediate Liquid:

| | |
|---|---|
| Thus obtained fine dispersion of magnetic | 674 g |
| substance | |
| Diacetylcellulose soin. (solid content 4.34%, | |
| solvent: methyl ethyl | |
| ketone/cyclohexanone = 1/1) | 24,280 g |
| Cyclohexanone | 46 g |

These were mixed together and agitated by means of a disperser to thereby obtain a “magnetic substance containing intermediate liquid”.

An α-alumina abrasive dispersion of the present invention was produced in accordance with the following recipe.

(a) Preparation of Sumicorundum AA-1.5 (Average Primary Grain Diameter: 1.5 μm, Specific Surface Area: 1.3 m²/g) Grain Dispersion

| | |
|---|---|
| Sumicorundum AA-1.5 | 152 g |
| Silane coupling agent KBM903 | |
| (produced by Shin- Etsu Silicone) | 0.48 g |
| Diacetylcellulose soln. (solid content 4.5%, | |
| solvent: methyl ethyl | |
| ketone/cyclohexanone = 1/1) | 227.52 g |

In accordance with the above recipe, fine dispersion was carried out by means of a ceramic-coated sand mill (1/4G sand mill) at 800 rpm for 4 hr. Zirconia beads of 1 mm diameter were used as medium.

(b) Colloidal Silica Grain Dispersion (Fine Grains)

Use was made of “MEK-ST” produced by Nissan Chemical Industries, Ltd.

This is a dispersion of colloidal silica of 0.015 μm average primary grain diameter in methyl ethyl ketone as a dispersion medium, wherein the solid content is 30%.

(3) Preparation of a Coating Liquid for Second Layer:

| | |
|---|---|
| Thus obtained magnetic substance | 19,053 g |
| containing intermediate liquid | |
| Diacetylcellulose soln. | 264 g |
| (solid content 4.5%, solvent: methyl ethyl | |
| ketone/cyclohexanone = 1/1) | |
| Colloidal silica dispersion “MEK-ST” | 128 g |
| (dispersion b, solid content: 30%) | |
| AA-1.5 dispersion (dispersion a) | 12 g |
| Millionate MR-400 (produced by Nippon | 203 g |
| Polyurethane) diluent | |
| (solid content 20%, dilution solvent: | |
| methyl ethyl ketone/cyclohexanone = 1/1) | |
| Methyl ethyl ketone | 170 g |
| Cyclohexanone | 170 g |

A coating liquid obtained by mixing and agitating these was applied in a coating amount of 29.3 mL/m² with the use of a wire bar. Drying was performed at 110° C. The thickness of magnetic layer after drying was 1.0 μm.

3) Third Layer (Higher Fatty Acid Ester Sliding Agent Containing Layer)

(1) Preparation of Raw Dispersion of Sliding Agent

The following liquid A was heated at 100° C. to thereby effect dissolution, added to liquid B and dispersed by means of a high-pressure homogenizer, thereby obtaining a raw dispersion of sliding agent.

| | |
|---|---|
| Liquid A: | |
| Compd. of the formula: | |
| C₆H₁₃CH(OH)(CH₂)_{10COOC}₅₀H₁₀₁ | 399 pts.wt. |
| Compd. of the formula: | |
| n-C₅₀H₁₀₁O(CH₂CH₂O)₁₆H | 171 pts.wt. |
| Cyclohexanone | 830 pts.wt. |
| Liquid B: | |
| Cyclohexanone | 8600 pts.wt. |

(2) Preparation of Spherical Inorganic Grain Dispersion

Spherical inorganic grain dispersion (c1) was prepared in accordance with the following recipe.

| | |
|---|---|
| Isopropyl alcohol | 93.54 pts. wt. |
| Silane coupling agent KBM903 (produced by | 5.53 pts. wt. |
| Shin-Etsu Silicone) Compd. 1-1: | |
| (CH₃O)₃Si—(CH₂)₃—NH₂) | |
| Compd. 8 set forth below | 2.93 pts. wt. |
| 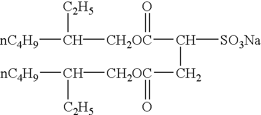 | |
| Seahostar KEP50 (amorphous spherical silica, av. | 88.00 pts. wt. |
| grain size 0.5 μm, produced by Nippon Shokubai Kagaku | |
| Kogyo | |

This composition was agitated for 10 min, and further the following was added.

| | |
|---|---|
| Diacetone alcohol | 252.93 pts.wt. |

The resultant liquid was dispersed by means of ultrasonic homogenizer “Sonifier 450 (manufactured by Branson)” for 3 hr while cooling with ice and stirring, thereby finishing spherical inorganic grain dispersion c1.

(3) Preparation of Spherical Organic Polymer Grain Dispersion

Spherical organic polymer grain dispersion (c2) was prepared in accordance with the following recipe.

| | |
|---|---|
| XC99-A8808 (produced by Toshiba Silicone Co., | 60 pts.wt. |
| Ltd., spherical crosslinked polysiloxane grain, | |
| av. grain size 0.9 μm) | |
| Methyl ethyl ketone | 120 pts.wt. |
| Cyclohexanone | 120 pts.wt. |
| (solid content 20%, | |
| solvent: methyl ethyl | |
| ketone/cyclohexanone = 1/1) | |

This mixture was dispersed by means of ultrasonic homogenizer “Sonifier 450 (manufactured by Branson)” for 2 hr while cooling with ice and stirring, thereby finishing spherical organic polymer grain dispersion c2.

(4) Preparation of Coating Liquid for 3rd Layer

A coating liquid for 3rd layer was prepared by adding the following components to 542 g of the aforementioned raw dispersion of sliding agent:

| | | |
|---|---|---|
| Diacetone alcohol | 5950 | g |
| Cyclohexanone | 176 | g |
| Ethyl acetate | 1700 | g |
| Above Seahostar KEP50 dispersion (c1) | 53.1 | g |
| Above spherical organic polymer grain | 300 | g |
| dispersion (c2) | | |
| FC431 (produced by 3M, solid content 50%, solvent: | 2.65 | g |
| ethyl acetate) | | |
| BYK310 (produced by BYL ChemiJapan, solid | 5.3 | g. |
| content 25%) | | |

The above 3rd-layer coating liquid was applied to the 2nd layer in a coating amount of 10.35 mL/m², dried at 110° C. and further postdried at 97° C. for 3 min.

4) Application of Lightsensitive Layer by Coating:

The thus obtained back layers on its side opposite to the support were coated with a plurality of layers of the following respective compositions, thereby obtaining a color negative film.

(Composition of Lightsensitive Layer)

The numeric value given beside the description of each component is for the coating amount expressed in the unit of g/m². With respect to the silver halide the coating amount is in terms of silver quantity.

| 1st layer (First antihalation layer) | | |
|---|---|---|
| Black colloidal silver | silver | 0.122 |
| 0.07 μm silver iodobromide emulsion | silver | 0.01 |
| Gelatin | | 0.919 |
| ExM-1 | | 0.066 |
| ExC-1 | | 0.002 |
| ExC-3 | | 0.002 |
| Cpd-2 | | 0.001 |
| F-8 | | 0.001 |
| HBS-1 | | 0.050 |
| HBS-2 | | 0.002 |
| 2nd layer (Second antihalation layer) | | |
| Black colloidal silver | silver | 0.055 |
| Gelatin | | 0.425 |
| ExF-1 | | 0.002 |
| F-8 | | 0.001 |
| Solid disperse dye ExF-7 | | 0.120 |
| HBS-1 | | 0.074 |
| 3rd layer (Interlayer) | | |
| ExC-2 | | 0.050 |
| Cpd-1 | | 0.090 |
| Polyethyl acrylate latex | | 0.200 |
| HBS-1 | | 0.100 |
| Gelatin | | 0.700 |
| 4th layer (Low-speed red-sensitive emulsion layer) | | |
| Em-D | silver | 0.577 |
| Em-C | silver | 0.347 |
| ExC-1 | | 0.188 |
| ExC-2 | | 0.011 |
| ExC-3 | | 0.075 |
| ExC-4 | | 0.121 |
| ExC-5 | | 0.010 |
| ExC-6 | | 0.007 |
| ExC-8 | | 0.050 |
| ExC-9 | | 0.020 |
| Cpd-2 | | 0.025 |
| Cpd-4 | | 0.025 |
| UV-2 | | 0.047 |
| UV-3 | | 0.086 |
| UV-4 | | 0.018 |
| HBS-1 | | 0.245 |
| HBS-5 | | 0.038 |
| Gelatin | | 0.994 |
| 5th layer (Medium-speed red-sensitive emulsion layer) | | |
| Em-B | silver | 0.431 |
| Em-C | silver | 0.432 |
| ExC-1 | | 0.154 |
| ExC-2 | | 0.068 |
| ExC-3 | | 0.018 |
| ExC-4 | | 0.103 |
| ExC-5 | | 0.023 |
| ExC-6 | | 0.010 |
| ExC-8 | | 0.016 |
| ExC-9 | | 0.005 |
| Cpd-2 | | 0.036 |
| Cpd-4 | | 0.028 |
| HBS-1 | | 0.129 |
| Gelatin | | 0.882 |
| 6th layer (High-speed red-sensitive emulsion layer) | | |
| Em-A | silver | 1.108 |
| ExC-1 | | 0.180 |
| ExC-3 | | 0.035 |
| ExC-6 | | 0.029 |
| ExC-8 | | 0.110 |
| ExC-9 | | 0.020 |
| Cpd-2 | | 0.064 |
| Cpd-4 | | 0.077 |
| HBS-1 | | 0.329 |
| HBS-2 | | 0.120 |
| Gelatin | | 1.245 |
| 7th layer (Interlayer) | | |
| Cpd-1 | | 0.094 |
| Cpd-6 | | 0.369 |
| Solid disperse dye ExF-4 | | 0.030 |
| HBS-1 | | 0.049 |
| Polyethyl acrylate latex | | 0.088 |
| Gelatin | | 0.886 |
| 8th layer (Layer capable of imparting interlayer effect | | |
| on red-sensitive layer) | | |
| Em-J | silver | 0.153 |
| Em-K | silver | 0.153 |
| Cpd-4 | | 0.030 |
| ExM-2 | | 0.120 |
| ExM-3 | | 0.016 |
| ExM-4 | | 0.026 |
| ExY-1 | | 0.016 |
| ExY-4 | | 0.036 |
| ExC-7 | | 0.026 |
| HBS-1 | | 0.218 |
| HBS-3 | | 0.003 |
| HBS-5 | | 0.030 |
| Gelatin | | 0.610 |
| 9th layer (Low-speed green-sensitive emulsion layer) | | |
| Em-H | silver | 0.329 |
| Em-G | silver | 0.333 |
| Em-I | silver | 0.088 |
| ExM-2 | | 0.378 |
| ExM-3 | | 0.047 |
| ExY-1 | | 0.017 |
| ExC-7 | | 0.007 |
| HBS-1 | | 0.098 |
| HBS-3 | | 0.010 |
| HBS-4 | | 0.077 |
| HBS-5 | | 0.548 |
| Cpd-5 | | 0.010 |
| Gelatin | | 1.470 |
| 10th layer (Medium-speed green-sensitive emulsion | | |
| layer) | | |
| Em-F | silver | 0.457 |
| ExM-2 | | 0.032 |
| ExM-3 | | 0.029 |
| ExM-4 | | 0.029 |
| ExY-3 | | 0.007 |
| ExC-6 | | 0.010 |
| ExC-7 | | 0.012 |
| ExC-8 | | 0.010 |
| HBS-1 | | 0.065 |
| HBS-3 | | 0.002 |
| HBS-4 | | 0.020 |
| HBS-5 | | 0.020 |
| Cpd-5 | | 0.004 |
| Gelatin | | 0.446 |
| 11th layer (High-speed green-sensitive emulsion layer) | | |
| Em-E | silver | 0.794 |
| ExC-6 | | 0.002 |
| ExC-8 | | 0.010 |
| ExM-1 | | 0.013 |
| ExM-2 | | 0.011 |
| ExM-3 | | 0.030 |
| ExM-4 | | 0.017 |
| ExY-3 | | 0.003 |
| Cpd-3 | | 0.004 |
| Cpd-4 | | 0.007 |
| Cpd-5 | | 0.010 |
| HBS-1 | | 0.148 |
| HBS-3 | | 0.003 |
| HBS-4 | | 0.020 |
| HBS-5 | | 0.037 |
| Polyethyl acrylate latex | | 0.099 |
| Gelatin | | 0.939 |
| 12th layer (Yellow filter layer) | | |
| Cpd-1 | | 0.094 |
| Solid disperse dye ExF-2 | | 0.070 |
| Solid disperse dye ExF-5 | | 0.010 |
| Oil soluble dye ExF-6 | | 0.010 |
| HBS-1 | | 0.049 |
| Gelatin | | 0.630 |
| 13th layer (Low-speed blue-sensitive emulsion layer) | | |
| Em-O | silver | 0.212 |
| Em-M | silver | 0.220 |
| Em-N | silver | 0.240 |
| ExC-1 | | 0.027 |
| ExC-7 | | 0.013 |
| ExY-1 | | 0.002 |
| ExY-2 | | 0.890 |
| ExY-4 | | 0.058 |
| Cpd-2 | | 0.100 |
| Cpd-3 | | 0.004 |
| HBS-1 | | 0.222 |
| HBS-5 | | 0.074 |
| Gelatin | | 1.553 |
| 14th layer (High-speed blue-sensitive emulsion layer) | | |
| Em-L | silver | 0.714 |
| ExY-2 | | 0.230 |
| ExY-4 | | 0.080 |
| Cpd-2 | | 0.075 |
| Cpd-3 | | 0.001 |
| HBS-1 | | 0.124 |
| Gelatin | | 0.678 |
| 15th layer (First protective layer) | | |
| 0.07 μm silver iodobromide emulsion | silver | 0.301 |
| UV-1 | | 0.211 |
| UV-2 | | 0.132 |
| UV-3 | | 0.198 |
| UV-4 | | 0.026 |
| F-11 | | 0.009 |
| S-1 | | 0.086 |
| HBS-1 | | 0.175 |
| HBS-4 | | 0.050 |
| Gelatin | | 1.984 |
| 16th layer (Second protective layer) | | |
| H-1 | | 0.400 |
| B-1 (diameter 1.7 μm) | | 0.050 |
| B-2 (diameter 1.7 μm) | | 0.150 |
| B-3 | | 0.050 |
| S-1 | | 0.200 |
| Gelatin | | 0.750 |

In addition to the above components, W-2 to W-6, B-4 to B-6, F-1 to F-18, a lead salt, a platinum salt, an iridium salt and a rhodium salt were appropriately added to the individual layers in order to improve the storage life, processability, resistance to pressure, antiseptic and mildewproofing properties, antistatic properties and coating property thereof.

Preparation of Dispersion of Organic Solid Disperse Dye:

The ExF-2 of the 12th layer was dispersed by the following method. Specifically,

| | |
|---|---|
| Wet cake of ExF-2 (containing 17.6 wt. % water) | 2.800 kg |
| Sodium octylphenyldiethoxymethanesulfonate | 0.376 kg |
| (31 wt. % aq. soln.) | |
| F-15 (7% aq. soln.) | 0.011 kg |
| Water | 4.020 kg |
| Total | 7.210 kg |
| (adjusted to pH = 7.2 with NaOH). | |

Slurry of the above composition was agitated by means of a dissolver to thereby effect a preliminary dispersion, and further dispersed by means of agitator mill LMK-4 under such conditions that the peripheral speed, delivery rate and packing ratio of 0.3 mm-diameter zirconia beads were 10 m/s, 0.6 kg/min and 80%, respectively, until the absorbance ratio of the dispersion became 0.29. Thus, a solid particulate dispersion was obtained, wherein the average particle diameter of dye particulate was 0.29 μm.

Solid dispersions of ExF-4 and ExF-7 were obtained in the same manner. The average particle diameters of these dye particulates were 0.28 μm and 0.49 μm, respectively. ExF-5 was dispersed by the microprecipitation dispersion method described in Example 1 of EP. No. 549,489A. The average particle diameter thereof was 0.06 μm.

TABLE 1

| | | Equivalent | | Equivalent | Grain | |
|---|---|---|---|---|---|---|
| | Average | sphere | | circle | thick- | |
| | Iodide | diameter | Aspect | diameter | ness | |
| Emulsion | (mol %) | (μm) | ratio | (μm) | (μm) | Shape |
| Em-A | 4 | 0.92 | 14 | 2 | 0.14 | Tabular |
| Em-B | 5 | 0.8 | 12 | 1.6 | 0.13 | Tabular |
| Em-C | 4.7 | 0.51 | 7 | 0.85 | 0.12 | Tabular |
| Em-D | 3.9 | 0.37 | 2.7 | 0.4 | 0.15 | Tabular |
| Em-E | 5 | 0.92 | 14 | 2 | 0.14 | Tabular |
| Em-F | 5.5 | 0.8 | 12 | 1.6 | 0.13 | Tabular |
| Em-G | 4.7 | 0.51 | 7 | 0.85 | 0.12 | Tabular |
| Em-H | 3.7 | 0.49 | 3.2 | 0.58 | 0.18 | Tabular |
| Em-I | 2.8 | 0.29 | 1.2 | 0.27 | 0.23 | Tabular |
| Em-J | 5 | 0.8 | 12 | 1.6 | 0.13 | Tabular |
| Em-K | 3.7 | 0.47 | 3 | 0.53 | 0.18 | Tabular |
| Em-L | 5.5 | 1.4 | 9.8 | 2.6 | 0.27 | Tabular |
| Em-M | 8.8 | 0.64 | 5.2 | 0.85 | 0.16 | Tabular |
| Em-N | 3.7 | 0.37 | 4.6 | 0.55 | 0.12 | Tabular |
| Em-O | 1.8 | 0.19 | — | — | — | Cubic |

In Table 1, emulsions A to C are added with spectral sensitizing dyes 1 to 3 in optimum amounts, and are optimally sensitized with gold, sulfur and selenium. Emulsions E to G are added with spectral sensitizing dyes 4 to 6 in optimum amounts and are optimally sensitized with gold, sulfur and selenium. Emulsion J is added with spectral sensitizing dyes 7 and 8 in optimum amounts and is optimally sensitized with gold, sulfur and selenium. Emulsion L is added with spectral sensitizing dyes 9 to 11 in optimum amounts and is optimally sensitized with gold, sulfur and selenium. Emulsion 0 is added with spectral sensitizing dyes 10 to 12 in optimum amounts and is optimally sensitized with gold and sulfur. Emulsions D, H, I, K, M and N are added with spectral sensitizing dyes shown in Table 2 and are optimally sensitized with gold, sulfur and selenium.

TABLE 2

| | | Addition |
|---|---|---|
| | | Amount |
| | | (mol/mol |
| Emulsion | Sensitizing dye | Ag) |
| Em-D | Sensitizing dye 1 | 5.44 × 10⁻⁴ |
| | Sensitizing dye 2 | 2.35 × 10⁻⁴ |
| | Sensitizing dye 3 | 7.26 × 10⁻⁶ |
| Em-H | Sensitizing dye 8 | 6.52 × 10⁻⁴ |
| | Sensitizing dye 13 | 1.35 × 10⁻⁴ |
| | Sensitizing dye 6 | 2.48 × 10⁻⁵ |
| Em-I | Sensitizing dye 8 | 6.09 × 10⁻⁴ |
| | Sensitizing dye 13 | 1.26 × 10⁻⁴ |
| | Sensitizing dye 6 | 2.32 × 10⁻⁵ |
| Em-K | Sensitizing dye 7 | 6.27 × 10⁻⁴ |
| | Sensitizing dye 8 | 2.24 × 10⁻⁴ |
| Em-M | Sensitizing dye 9 | 2.43 × 10⁻⁴ |
| | Sensitizing dye 10 | 2.43 × 10⁻⁴ |
| | Sensitizing dye 11 | 2.43 × 10⁻⁴ |
| Em-N | Sensitizing dye 9 | 3.28 × 10⁻⁴ |
| | Sensitizing dye 10 | 3.28 × 10⁻⁴ |
| | Sensitizing dye 11 | 3.28 × 10⁻⁴ |

The spectral sensitizing dyes described in Table 2 are set forth below.

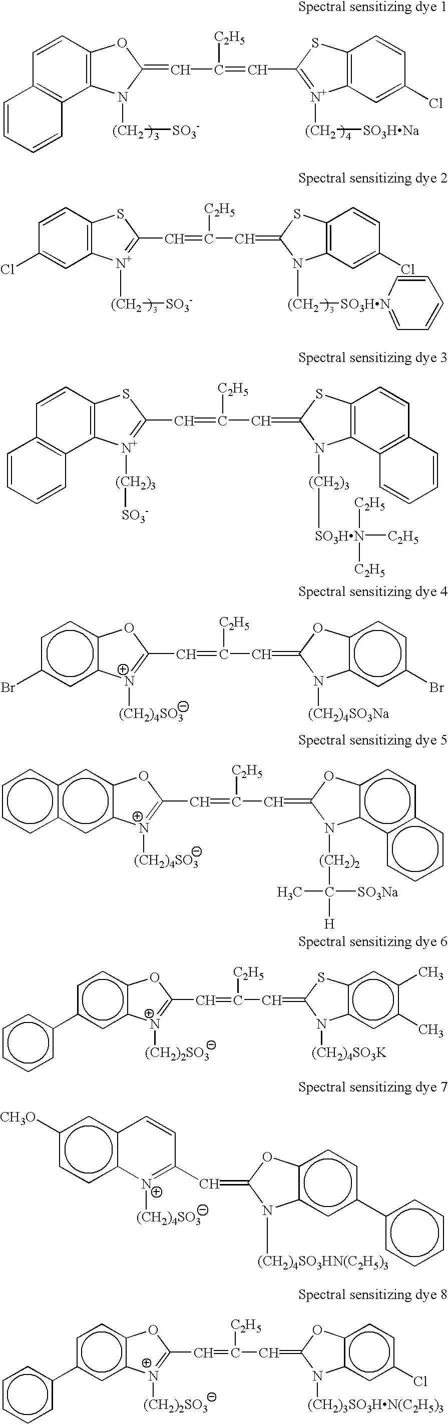

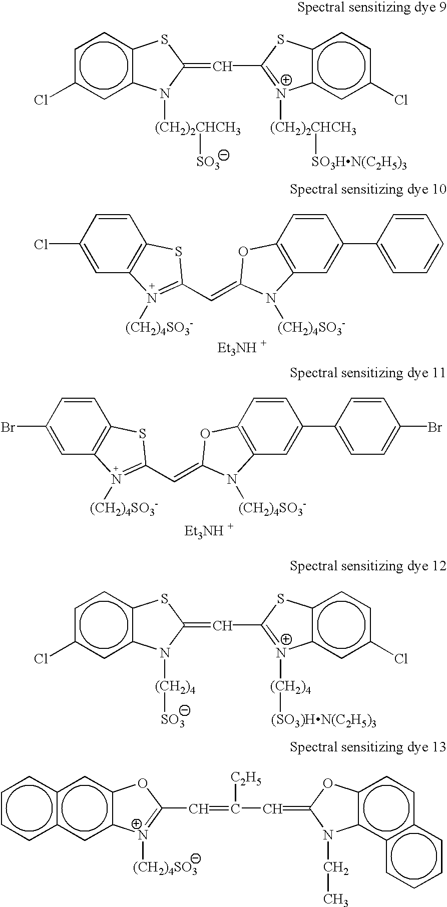

Low molecular weight gelatins were used for the preparation of the tabular grains according to Examples described in JP-A-1-158426.

Emulsions A to K contain Ir and Fe in optimum amounts.

Emulsions L to O have been reduction-sensitized during grain preparation.

Tabular grains are observed, through a high-pressure electron microscope, to have dislocation lines such as those disclosed in JP-A-3-237450.

To emulsions A to C and J, dislocation has been introduced by use of an iodide ion-releasing agent according to Examples described in JP-A-6-11782.

To emulsion E, dislocation has been introduced by use of silver iodide fine grains prepared, just before their addition, in another chamber equipped with a magnetic coupling induction type stirrer disclosed in JP-A-10-43570.

Compound used for individual layers are shown below.

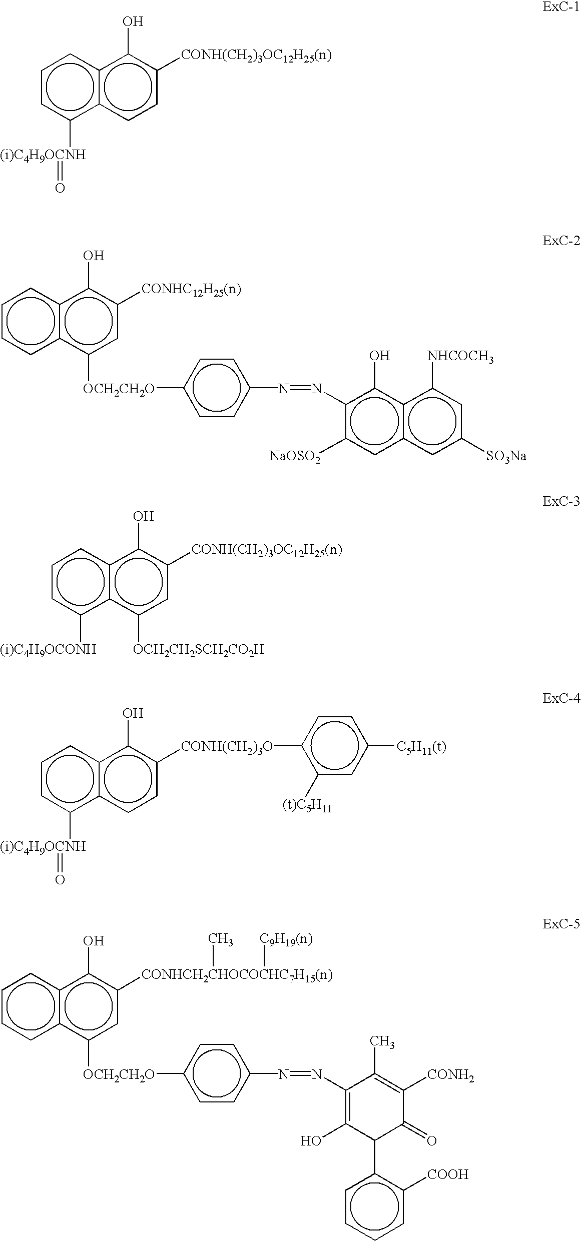

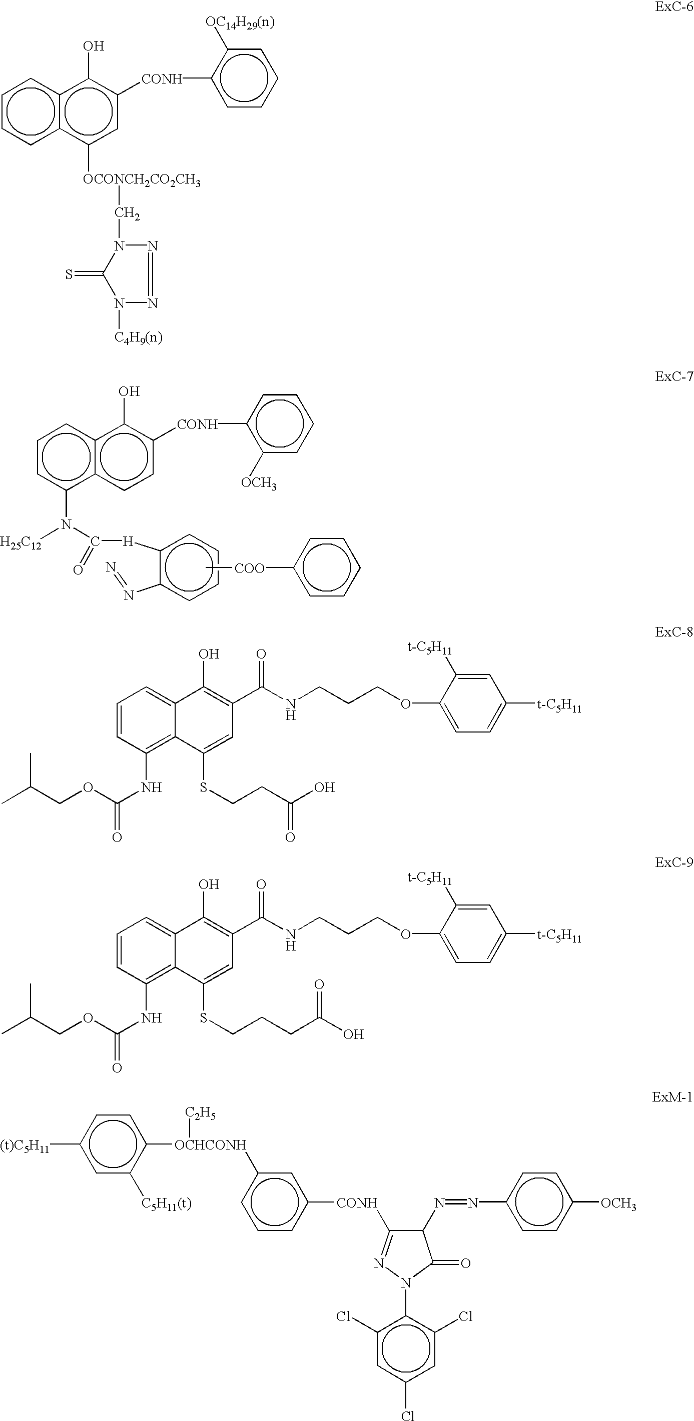

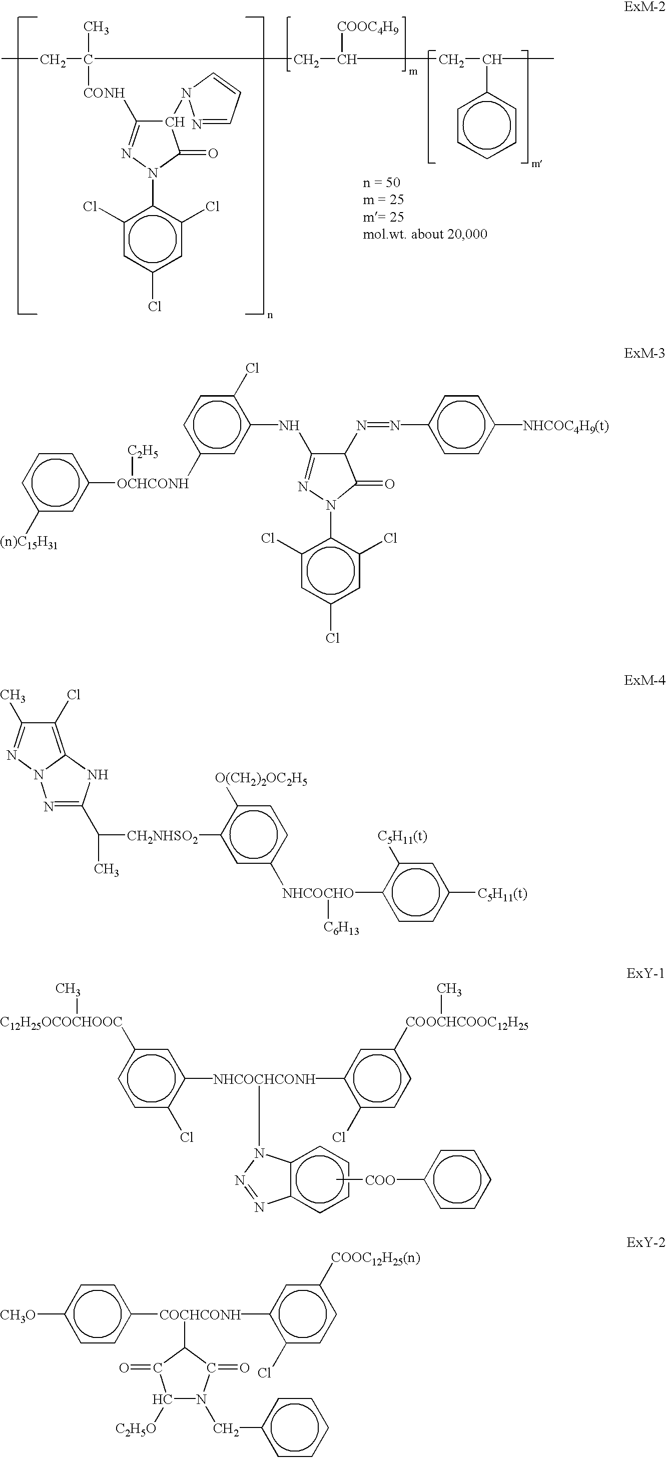

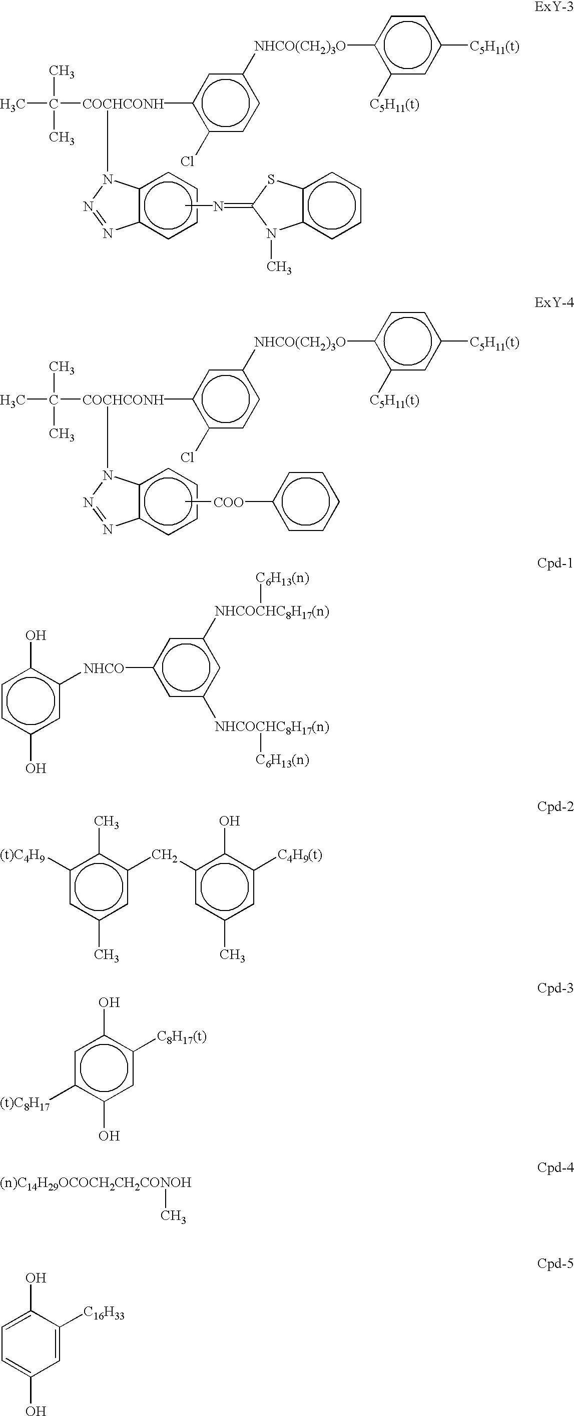

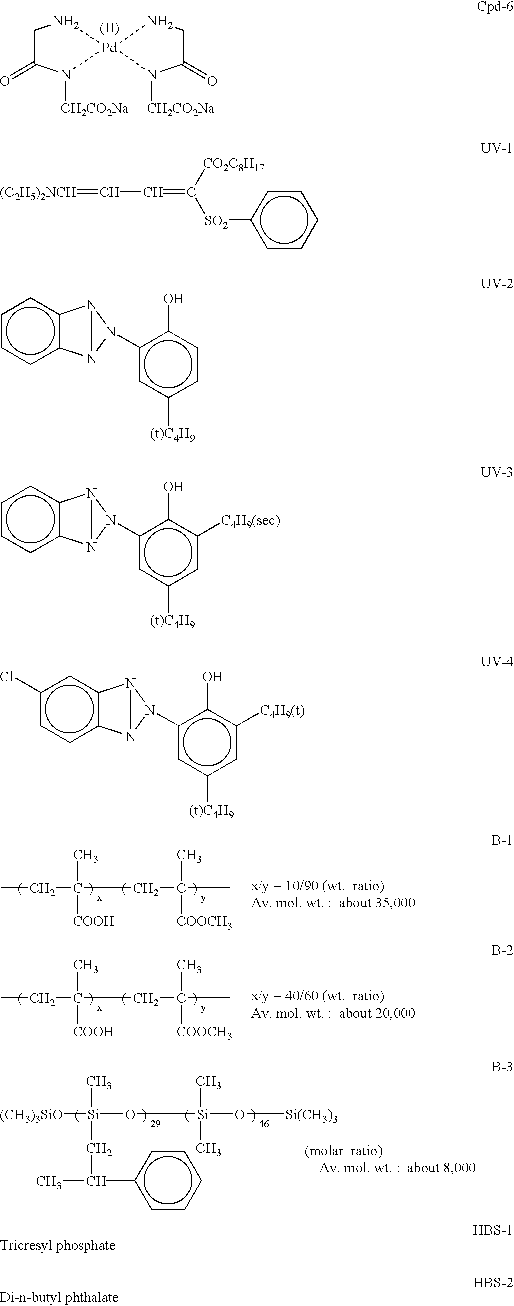

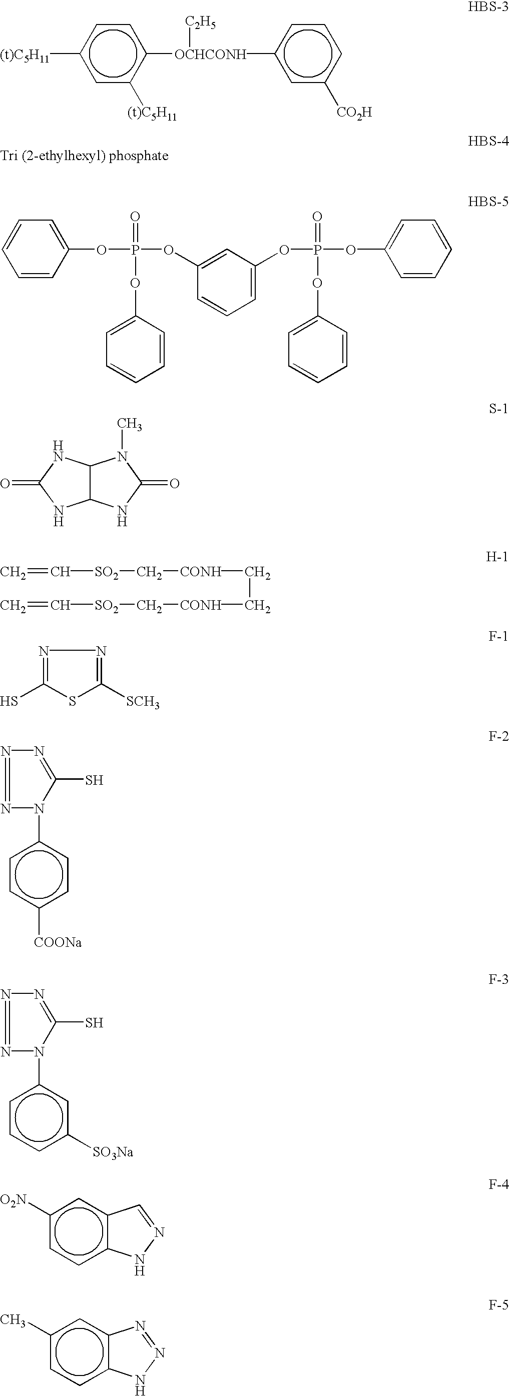

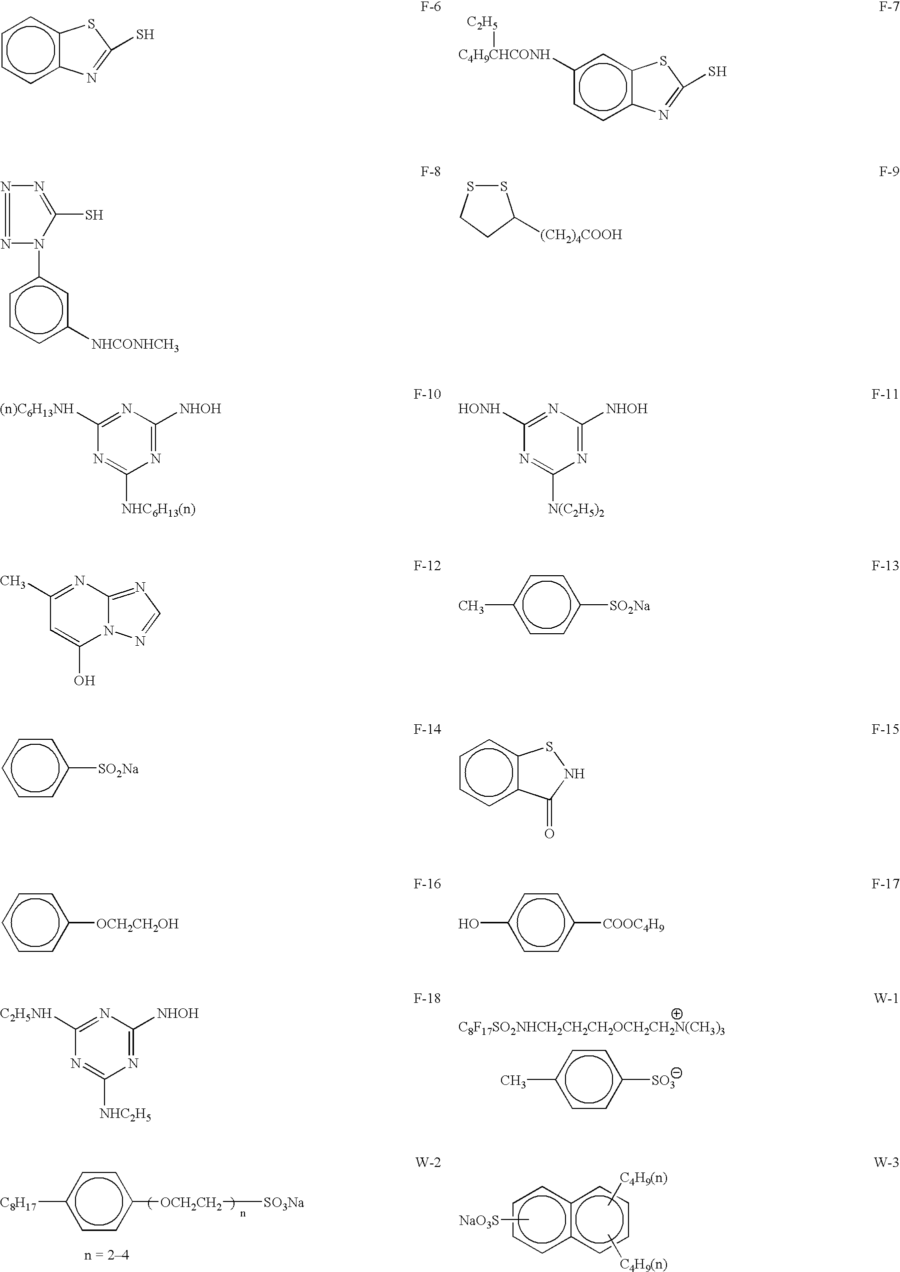

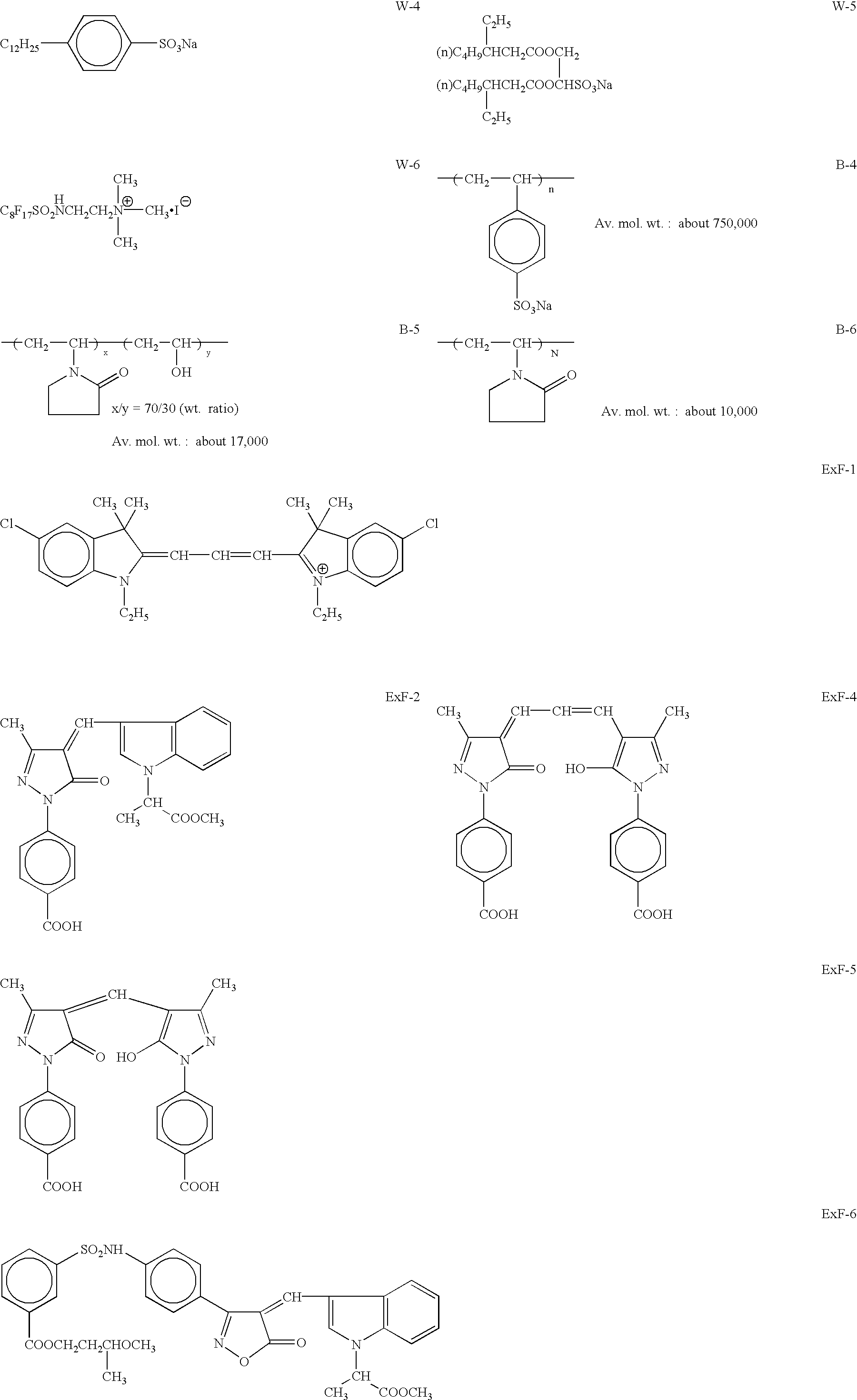

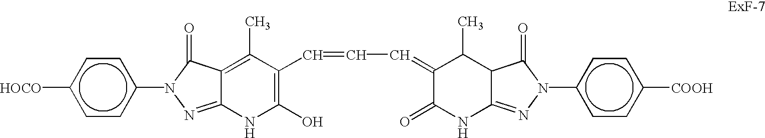

The development was carried out by the use of automatic processor FP-360B manufactured by Fuji Photo Film Co., Ltd. under the following conditions. The apparatus was reworked so as to prevent the flow of overflow solution from the bleaching bath toward subsequent baths and to, instead, discharge all the solution into a waste solution tank. This FP-360B is fitted with an evaporation correcting means described in JIII Journal of Technical Disclosure No. 94-4992 issued by Japan Institute of Invention and Innovation.

The processing steps and compositions of processing solutions are as follows.

(Processing Steps)

| | | | Qty. of | Tank |
|---|---|---|---|---|
| Step | Time | Temp. | replenisher* | volume |
| Color | 3 min | 37.8° C. | 20 mL | 11.5 L |
| Development | 5 sec | | | |
| Bleaching | 50 sec | 38.0° C. | 5 mL | 5 L |
| Fixing (1) | 50 sec | 38.0° C. | — | 5 L |
| Fixing (2) | 50 sec | 38.0° C. | 8 mL | 5 L |
| Washing | 30 sec | 38.0° C. | 17 mL | 3 L |
| Stabilization | 20 sec | 38.0° C. | — | 3 L |
| (1) | | | | |
| Stabilization | 20 sec | 38.0° C. | 15 mL | 3 L |
| (2) | | | | |
| Drying | 1 min | 60° C. | | |
| | 30 sec | | | |

*The replenishment rate is a value per 1.1 m of a 35-mm wide photosensitive material (equivalent to one role of 24 Ex. film).

The stabilizer was fed from stabilization (2) to stabilization (1) by counter current. All the overflow of washing water was introduced into fixing bath (2). The amounts of drag-in of developer into the bleaching step, drag-in of bleaching solution into the fixing step and drag-in of fixer into the washing step were 2.5 mL, 2.0 mL and 2.0 mL, respectively, per 1.1 m of a 35-mm wide photosensitive material. Each crossover time was 6 sec, which was included in the processing time of the previous step.

The open area of the above processor was 100 cm² for the color developer, 120 cm² for the bleaching solution and about 100 cm² for the other processing solutions.

The composition of each of the processing solutions was as follows.

| | Tank | Replenisher |
|---|---|---|
| | solution (g) | (g) |
| (Color developer) | | |
| Diethylenetriamine- | 3.0 | 3.0 |
| pentaacetic acid | | |
| Disodium catechol-3,5- | 0.3 | 0.3 |
| disulfonate | | |
| Sodium sulfite | 3.9 | 5.3 |
| Potassium carbonate | 39.0 | 39.0 |
| Disodium-N,N-bis(2- | 1.5 | 2.0 |
| sulfonatoethyl)hydroxylamine | | |
| Potassium bromide | 1.3 | 0.3 |
| Potassium iodide | 1.3 mg | — |
| 4-Hydroxy-6-methyl-1,3,3a,7- | 0.05 | — |
| tetrazaindene | | |
| Hydroxylamine sulfate | 2.4 | 3.3 |
| 2-Methyl-4-[N-ethyl-N- | 4.5 | 6.5 |
| (β-hydroxyethyl)amino]- | | |
| aniline sulfate | | |
| Water to make | 1.0 L | 1.0 L |
| pH (adjusted by the use of | 10.05 | 10.18 |
| potassium hydroxide and | | |
| sulfuric acid) | | |
| (Bleaching solution) | | |
| Fe(III) ammonium 1,3- | 113 | 170 |
| diamino-propanetetraacetate monohydrate | | |
| Ammonium bromide | 70 | 105 |
| Ammonium nitrate | 14 | 21 |
| Succinic acid | 34 | 51 |
| Maleic acid | 28 | 42 |
| Water to make | 1.0 L | 1.0 L |
| pH (adjusted by the use of | 4.6 | 4.0 |
| aqueous ammonia) | | |
| (Fixing (1) tank solution) | | |
| 5:95 (by volume) mixture of | | |
| the above bleaching tank | | |
| solution and the following | | |
| fixing tank solution | | |
| (pH 6.8) | | |
| (Fixing (2)) | | |
| Aq. soln. of ammonium | 240 mL | 720 mL |
| thiosulfate (750 g/L) | | |
| Imidazole | 7 | 21 |
| Ammonium methanethiosulfonate | 5 | 15 |
| Ammonium methanesulfinate | 10 | 30 |
| Ethylenediaminetetraacetic acid | 13 | 39 |
| Water to make | 1.0 L | 1.0 L |
| pH (adjusted by the use of | 7.4 | 7.45 |
| aqueous ammonia and acetic acid) | | |
| (Washing water) | | |

Tap water was passed through a mixed-bed column filled with H-type strongly acidic cation exchange resin (Amberlite IR-120B produced by Rohm & Haas Co.) and OH-type strongly basic anion exchange resin (Amberlite IR-400 produced by the same maker) so as to set the concentration of calcium and magnesium ions at 3 mg/L or less. Subsequently, 20 mg/L of sodium dichloroisocyanurate and 150 mg/L of sodium sulfate were added. The pH of the solution ranged from 6.5 to 7.5.

(Stabilizer): Common to Tank Solution and Replenisher (g)

| | |
|---|---|
| Sodium p-toluenesulfinate | 0.03 |
| Polyoxyethylene p-monononylphenyl ether | 0.2 |
| (average polymerization degree 10) | |
| Sodium salt of 1,2-benzoisothiazolin-3-one | 0.10 |
| Disodium ethylenediaminetetraacetate | 0.05 |
| 1,2,4-triazole | 1.3 |
| 1,4-bis(1,2,4-triazol-1-ylmethyl)- | 0.75 |
| piperazine | |
| Water to make | 1.0 L |
| pH | 8.5 |

Samples 102 to 110 were prepared in the same manner as sample 101 except that compound W-1 and/or its addition layer were changed to other compounds (comparative compound FC-1 or the compounds of general formula (1) of the invention) and other layers as shown in Table 3. The amounts of the other compounds were so adjusted that the content (weight) of the other compounds in the individual solutions containing the other compounds became the same as the content of compound W-1 in the solution thereof. The samples prepared were stored at 25° C. under a relative humidity of 65% for 7 days. The performances shown below were examined by use of these samples.

Comparative Compound FC-1

C₆F₁₃CH₂CH₂SO₃K

(Fluorescent X-Ray Intensity Ratio in Surface of Photosensitive Material)

The surfaces of the individual samples were analyzed by XPS (X-ray photoelectron spectroscopy) and the fluorescent X-ray intensity ratios of fluorine to carbon (F/C) in the surfaces were calculated.

(Electrification-Controlling Ability Test)

The amount of charge was measured for the individual samples by a method in which a surface of a 35 mm×120 mm sample, the surface being opposite to another surface of the sample on which emulsions were applied, was adhered with a double-sided tape at a temperature of 25° C. and a humidity of 10%, the resulting sample was nipped and conveyed between a pair of earthed rubber rollers facing each other, and then the sample was placed in a Faraday gauge. The results of the measurement of the amount of charge were expressed in electrification series indexes. A electrification series index is a value obtained by subtracting the amount of charge of an individual sample from the amount of charge of sample 101 and multiplying the resulting difference by 10⁹. Samples having a electrification series index less than −0.5 were judged to have a sufficient electrification-controlling ability.

TABLE 3

| | | | Results | | |
|---|---|---|---|---|---|
| | Substitution of W-1 | | | Electrification series | |
| Sample | Compound | | | index with respect to | |
| No. | No. | Addition layer | F/C | Sample No. 101 | Remarks |
| 101 | W-1 | the 16 layer | 0.9 | — | Comparison |
| 102 | W-1 | the 8 layer | 0.6 | 0.2 | Comparison |
| 103 | FC-1 | the 16 layer | 0.7 | −0.3 | Comparison |
| 104 | FS-3 | the 16 layer | 1.4 | −0.7 | Invention |
| 105 | FS-3 | the 8 layer | 0.7 | −0.5 | Invention |
| 106 | FS-1 | the 16 layer | 1.5 | −0.9 | Invention |
| 107 | FS-1 | the 8 layer | 0.5 | −0.5 | Invention |
| 108 | FS-5 | the 16 layer | 1.9 | −1.3 | Invention |
| 109 | FS-16 | the 16 layer | 1.3 | −1.1 | Invention |
| 110 | FS-17 | the 16 layer | 1.8 | −1.4 | Invention |

It became clear from Table 3 that the F/C intensity ratio does not increase and the electrification series controlling ability is insufficient even if Comparative Compound FC-1 has a short chain fluorinated alkyl group having 6 or less carbon atoms. On the other hand, it is clear that the fluorine compounds of the present invention have high F/C intensity ratios and have sufficient electrification series controlling ability where the F/C intensity ratios are high even though their fluoroalkyl groups are short.

### Example 2

The individual samples of Example 1 were evaluated for the following performances.

(Storability with Time)

The above-described samples were exposed with light of 1/100 through a gelatin filter SC-39 manufactured by Fuji Photo Film Co., Ltd. and a continuous wedge. One set of samples were stored at 60° C. under a relative humidity of 60% for 4 days and another set of samples were stored at 25° C. under a relative humidity of 65% for 4 days. Thereafter developed samples were measured for their densities. From the resulting characteristic curve, logarithm of reciprocal of the exposure amount required to give a density of fog +0.1 were calculated as sensitivity, and the difference (ΔS) in B density between a sample stored at 60° C. under a relative humidity of 60% and that of the same sample number which was stored at 25° C. under a relative humidity of 65%. In addition, for the fogging B densities, the difference thereof (Δfog) was also calculated. The smaller (the closer to zero) ΔS or Δfog, the better the storability with time.

TABLE 4

| Sample | Substitution of W-1 | | Results | | |
|---|---|---|---|---|---|
| No. | Compound No. | Addition layer | Δfog | ΔS | Remarks |
| 101 | W-1 | the 16 layer | 0.06 | 0.15 | Comparison |
| 102 | W-2 | the 8 layer | 0.08 | 0.14 | Comparison |
| 103 | FC-1 | the 16 layer | 0.07 | 0.14 | Comparison |
| 104 | FS-3 | the 16 layer | 0.04 | 0.08 | Invention |
| 105 | FS-3 | the 8 layer | 0.03 | 0.07 | Invention |
| 106 | FS-1 | the 16 layer | 0.03 | 0.06 | Invention |
| 107 | FS-1 | the 8 layer | 0.03 | 0.05 | Invention |
| 108 | FS-5 | the 16 layer | 0.04 | 0.09 | Invention |
| 109 | FS-16 | the 16 layer | 0.03 | 0.06 | Invention |
| 110 | FS-17 | the 16 layer | 0.04 | 0.08 | Invention |

Table 4 clearly shows that use of the compounds of the present invention results in small variation in B sensitivity with time and small increase in fogging with time and therefore results in improvement in storability with time.

Further, another sample 101′ was prepared in the same manner as in Sample 101, except that all of the emulsions each having an aspect ratio of 8 or more were replaced with emulsions each having an aspect ratio of 8 or less. To the thus prepared sample 101′, the same replacement conducted to Sample 101 to make samples 102 to 110 mentioned above were made, thereby to prepare samples 102′ to 110′. As a result, only a small effect of improving the storability with time was obtained.

### Example 3

Silver halide color photosensitive material of the following Sample A-01 was prepared.

1. Preparation of Triacetylcellulose Film

Triacetylcellulose was dissolved (13% by weight) by a common solution casting process in dichloromethane/methanol=92/8 (weight ratio), and triphenyl phosphate and biphenyldiphenyl phosphate in a weight ratio of 2:1, which are plasticizers, were added to the resultant solution so that the total amount of the plasticizers was 14% to the triacetylcellulose. Then, a triacetylcellulose film was made by a band process. The thickness of the support after drying was 97 μm.

2. Components of Undercoat Layer

The two surfaces of the triacetylcellulose film were subjected to undercoating treatment. Numbers represent weight contained per 1.0 liter of an undercoat solution.

The two surfaces of the triacetylcellulose film were subjected to corona discharge treatment before undercoating treatment.

| | |
|---|---|
| Gelatin | 10.0 g |
| Salicylic acid | 0.5 g |
| Glycerin | 4.0 g |
| Acetone | 700 mL |
| Methanol | 200 mL |
| Dichloromethane | 80 mL |
| Formaldehyde | 0.1 mg |
| Water to make | 1.0 L |

3. Coating of Back Layers

One surface of the undercoated support was coated with the following back layers.

| 1st layer | | |
|---|---|---|
| Binder: acid-processed gelatin | 1.10 | g |
| (isoelectric point: 9.0) | | |
| Polymeric latex: P-2 | 0.13 | g |
| (average grain size: 0.1 μm) | | |
| Polymeric latex: P-3 | 0.23 | g |
| (average grain size 0.2 μm) | | |
| Ultraviolet absorbent U-1 | 0.030 | g |
| Ultraviolet absorbent U-3 | 0.010 | g |
| Ultraviolet absorbent U-4 | 0.020 | g |
| High-boiling organic solvent Oil-2 | 0.030 | g |
| Surfactant W-3 | 0.010 | g |
| Surfactant W-6 | 3.0 | mg |
| 2nd layer | | |
| Binder: acid-processed gelatin | 3.30 | g |
| (isoelectric point: 9.0) | | |
| Polymeric latex: P-3 | 0.11 | g |
| (average grain size: 0.2 μm) | | |
| Ultraviolet absorbent U-1 | 0.030 | g |
| Ultraviolet absorbent U-3 | 0.010 | g |
| Ultraviolet absorbent U-4 | 0.020 | g |
| High-boiling organic solvent Oil-2 | 0.030 | g |
| Surfactant W-3 | 0.010 | g |
| Surfactant W-6 | 3.0 | mg |
| Dye D-2 | 0.10 | g |
| Dye D-10 | 0.12 | g |
| Potassium sulfate | 0.25 | g |
| Calcium chloride | 0.5 | mg |
| Sodium hydroxide | 0.03 | g |
| 3rd layer | | |
| Binder: acid-processed gelatin | 3.50 | g |
| (isoelectric point: 9.0) | | |
| Surfactant W-3 | 0.020 | g |
| Potassium sulfate | 0.30 | g |
| Sodium hydroxide | 0.03 | g |
| 4th layer | | |
| Binder: lime-processed gelatin | 1.25 | g |
| (isoelectric point: 5.4) | | |
| 1:9 copolymer of methacrylic acid and | 0.040 | g |
| methylmethacrylate (average grain size: 2.0 μm) | | |
| 6:4 copolymer of methacrylic acid and | 0.030 | g |
| methylmethacrylate (average grain size: 2.0 μm) | | |
| Surfactant W-3 | 0.060 | g |
| Surfactant W-2 | 7.0 | mg |
| Hardener H-1 | 0.23 | g |

4. Coating of Photosensitive Emulsion Layers

Sample A-01 was prepared by coating photosensitive emulsion layers presented below on the side opposite, against the support, to the side having the back layers. Numbers represent addition amounts per m² of the coating surface. Note that the effects of added compounds are not restricted to the described purposes.

| 1st layer: Antihalation layer | | | |
|---|---|---|---|
| Black colloidal silver | | 0.25 | g |
| Gelatin | | 2.10 | g |
| Ultraviolet absorbent U-1 | | 0.15 | g |
| Ultraviolet absorbent U-3 | | 0.15 | g |
| Ultraviolet absorbent U-4 | | 0.10 | g |
| High-boiling organic solvent Oil-1 | | 0.10 | g |
| High-boiling organic solvent Oil-2 | | 0.10 | g |
| High-boiling organic solvent Oil-5 | | 0.010 | g |
| Dye D-4 | | 1.0 | mg |
| Dye D-8 | | 2.5 | mg |
| Fine crystal solid dispersion | | 0.05 | g |
| of dye E-1 | | | |
| 2nd layer: First interlayer | | | |
| Gelatin | | 0.50 | g |
| Compound Cpd-R | | 0.050 | g |
| Compound Cpd-S | | 0.025 | g |
| High-boiling organic solvent Oil-4 | | 0.010 | g |
| High-boiling organic solvent Oil-7 | | 2.0 | mg |
| Dye D-7 | | 4.0 | mg |
| 3rd layer: Short wavelength green-sensitive | | | |
| emulsion layer | | | |
| Emulsion R | silver | 0.30 | g |
| Emulsion S | silver | 0.30 | g |
| Gelatin | | 0.45 | g |
| 4th layer: Second interlayer | | | |
| Gelatin | | 0.60 | g |
| Compound Cpd-D | | 0.020 | g |
| Compound Cpd-M | | 0.310 | g |
| Compound Cpd-R | | 0.050 | g |
| Compound Cpd-S | | 0.025 | g |
| High-boiling organic solvent Oil-3 | | 0.010 | g |
| High-boiling organic solvent Oil-10 | | 0.250 | g |
| 5th layer: Low-speed red-sensitive | | | |
| emulsion layer | | | |
| Emulsion A | silver | 0.10 | g |
| Emulsion B | silver | 0.15 | g |
| Emulsion C | silver | 0.15 | g |
| Silver iodobromide emulsion whose | silver | 0.010 | g |
| surface and interior are previously | | | |
| fogged (cubic, average | | | |
| silver iodide content: 1 mol %, | | | |
| equivalent sphere | | | |
| average grain size: 0.06 μm) | | | |
| Gelatin | | 0.70 | g |
| Coupler C-1 | | 0.15 | g |
| Coupler C-2 | | 7.0 | mg |
| Coupler C-10 | | 3.0 | mg |
| Coupler C-11 | | 2.0 | mg |
| Ultraviolet absorbent U-3 | | 0.010 | g |
| Compound Cpd-I | | 0.020 | g |
| Compound Cpd-D | | 3.0 | mg |
| Compound Cpd-J | | 2.0 | mg |
| Compound Cpd-K | | 3.0 | mg |
| High-boiling organic solvent Oil-10 | | 0.030 | g |
| Additive P-1 | | 5.0 | mg |
| 6th layer: Medium-speed red-sensitive | | | |
| emulsion layer | | | |
| Emulsion C | silver | 0.15 | g |
| Emulsion D | silver | 0.15 | g |
| Gelatin | | 0.70 | g |
| Coupler C-1 | | 0.15 | g |
| Coupler C-2 | | 7.0 | mg |
| Coupler C-10 | | 3.0 | mg |
| Compound Cpd-D | | 3.0 | mg |
| Ultraviolet absorbent U-3 | | 0.010 | g |
| High-boiling organic solvent Oil-10 | | 0.030 | g |
| Additive P-1 | | 7.0 | mg |
| 7th layer: High-speed red-sensitive | | | |
| emulsion layer | | | |
| Emulsion E | silver | 0.15 | g |
| Emulsion F | silver | 0.20 | g |
| Gelatin | | 1.30 | g |
| Coupler C-1 | | 0.60 | g |
| Coupler C-2 | | 0.015 | g |
| Coupler C-3 | | 0.030 | g |
| Coupler C-10 | | 5.0 | mg |
| Ultraviolet absorbent U-1 | | 0.010 | g |
| Ultraviolet absorbent U-2 | | 0.010 | g |
| High-boiling organic solvent Oil-6 | | 0.030 | g |
| High-boiling organic solvent Oil-9 | | 0.020 | g |
| High-boiling organic solvent Oil-10 | | 0.050 | g |
| Compound Cpd-D | | 5.0 | mg |
| Compound Cpd-K | | 1.0 | mg |
| Compound Cpd-F | | 0.030 | g |
| Additive P-1 | | 0.010 | g |
| Additive P-4 | | 0.030 | g |
| 8th layer: Third interlayer | | | |
| Gelatin | | 1.40 | g |
| Additive P-2 | | 0.15 | g |
| Dye D-5 | | 0.020 | g |
| Dye D-9 | | 6.0 | mg |
| Compound Cpd-A | | 0.050 | g |
| Compound Cpd-D | | 0.030 | g |
| Compound Cpd-I | | 0.010 | g |
| Compound Cpd-M | | 0.090 | g |
| Compound Cpd-O | | 3.0 | mg |
| Compound Cpd-P | | 5.0 | mg |
| High-boiling organic solvent Oil-6 | | 0.100 | g |
| High-boiling organic solvent Oil-3 | | 0.010 | g |
| Ultraviolet absorbent U-1 | | 0.010 | g |
| Ultraviolet absorbent U-3 | | 0.010 | g |
| 9th layer: Low-speed green-sensitive | | | |
| emulsion layer | | | |
| Emulsion G | silver | 0.25 | g |
| Emulsion H | silver | 0.30 | g |
| Emulsion I | silver | 0.25 | g |
| Silver iodobromide emulsion whose | silver | 0.010 | g |
| surface and interior are previously | | | |
| fogged (cubic, average silver iodide | | | |
| content: 1 mol %, equivalent sphere | | | |
| average grain size: 0.06 μm) | | | |
| Gelatin | | 1.30 | g |
| Coupler C-4 | | 0.20 | g |
| Coupler C-5 | | 0.050 | g |
| Coupler C-6 | | 0.020 | g |
| Compound Cpd-A | | 5.0 | mg |
| Compound Cpd-B | | 0.030 | g |
| Compound Cpd-D | | 5.0 | mg |
| Compound Cpd-F | | 0.010 | g |
| Compound Cpd-G | | 2.5 | mg |
| Compound Cpd-K | | 1.0 | mg |
| Ultraviolet absorbent U-6 | | 5.0 | mg |
| High-boiling organic solvent Oil-2 | | 0.25 | g |
| Additive P-1 | | 5.0 | mg |
| 10th layer: Medium-speed green-sensitive | | | |
| emulsion layer | | | |
| Emulsion I | silver | 0.30 | g |
| Emulsion J | silver | 0.30 | g |
| Gelatin | | 0.70 | g |
| Coupler C-4 | | 0.25 | g |
| Coupler C-5 | | 0.050 | g |
| Coupler C-6 | | 0.020 | g |
| Compound Cpd-A | | 5.0 | mg |
| Compound Cpd-B | | 0.030 | g |
| Compound Cpd-F | | 0.010 | g |
| Compound Cpd-G | | 2.0 | mg |
| High-boiling organic solvent Oil-2 | | 0.20 | g |
| High-boiling organic solvent Oil-9 | | 0.050 | g |
| 11th layer: High-speed green-sensitive | | | |
| emulsion layer | | | |
| Emulsion K | silver | 0.40 | g |
| Gelatin | | 0.80 | g |
| Coupler C-4 | | 0.30 | g |
| Coupler C-5 | | 0.080 | g |
| Coupler C-7 | | 0.050 | g |
| Compound Cpd-A | | 5.0 | mg |
| Compound Cpd-B | | 0.030 | g |
| Compound Cpd-F | | 0.010 | g |
| High-boiling organic solvent Oil-2 | | 0.20 | g |
| High-boiling organic solvent Oil-9 | | 0.050 | g |
| 12th layer: Yellow filter layer | | | |
| Gelatin | | 1.0 | g |
| Compound Cpd-C | | 0.010 | g |
| Compound Cpd-M | | 0.10 | g |
| High-boiling organic solvent Oil-1 | | 0.020 | g |
| High-boiling organic solvent Oil-6 | | 0.10 | g |
| Fine crystal solid dispersion | | 0.25 | g |
| of dye E-2 | | | |
| 13th layer: Short wavelength blue-sensitive | | | |
| emulsion layer | | | |
| Emulsion T | silver | 0.27 | g |
| Gelatin | | 0.40 | g |
| Compound Cpd-Q | | 0.20 | g |
| 14th layer: Low-speed blue-sensitive | | | |
| emulsion layer | | | |
| Emulsion L | silver | 0.15 | g |
| Emulsion M | silver | 0.20 | g |
| Emulsion N | silver | 0.10 | g |
| Silver bromide emulsion whose interior is | silver | 3.0 | mg |
| previously fogged (cubic, equivalent sphere | | | |
| average grain size: 0.11 μm) | | | |
| Gelatin | | 0.80 | g |
| Coupler C-8 | | 0.020 | g |
| Coupler C-9 | | 0.30 | g |
| Coupler C-10 | | 5.0 | mg |
| Compound Cpd-B | | 0.10 | g |
| Compound Cpd-I | | 8.0 | mg |
| Compound Cpd-K | | 1.0 | mg |
| Compound Cpd-M | | 0.010 | g |
| Ultraviolet absorbent U-6 | | 0.010 | g |
| High-boiling organic solvent Oil-2 | | 0.010 | g |
| 15th layer: Medium-speed blue-sensitive | | | |
| emulsion layer | | | |
| Emulsion N | silver | 0.20 | g |
| Emulsion O | silver | 0.20 | g |
| Gelatin | | 0.80 | g |
| Coupler C-8 | | 0.020 | g |
| Coupler C-9 | | 0.25 | g |
| Coupler C-10 | | 0.010 | g |
| Compound Cpd-B | | 0.10 | g |
| Compound Cpd-N | | 2.0 | mg |
| High-boiling organic solvent Oil-2 | | 0.010 | g |
| 16th layer: High-speed blue-sensitive | | | |
| emulsion layer | | | |
| Emulsion P | silver | 0.20 | g |
| Emulsion Q | silver | 0.25 | g |
| Gelatin | | 2.00 | g |
| Coupler C-1 | | 2.0 | mg |
| Coupler C-3 | | 5.0 | mg |
| Coupler C-8 | | 0.10 | g |
| Coupler C-9 | | 1.00 | g |
| Coupler C-10 | | 0.020 | g |
| High-boiling organic solvent Oil-2 | | 0.10 | g |
| High-boiling organic solvent Oil-3 | | 0.020 | g |
| Ultraviolet absorbent U-6 | | 0.10 | g |
| Compound Cpd-B | | 0.20 | g |
| Compound Cpd-N | | 5.0 | mg |
| 17th layer: First protective layer | | | |
| Gelatin | | 1.00 | g |
| Ultraviolet absorbent U-1 | | 0.15 | g |
| Ultraviolet absorbent U-2 | | 0.050 | g |
| Ultraviolet absorbent U-5 | | 0.20 | g |
| Compound Cpd-O | | 5.0 | mg |
| Compound Cpd-A | | 0.030 | g |
| Compound Cpd-H | | 0.20 | g |
| Dye D-1 | | 8.0 | mg |
| Dye D-2 | | 0.010 | g |
| Dye D-3 | | 0.010 | g |
| High-boiling organic solvent Oil-3 | | 0.10 | g |
| 18th layer: Second protective layer | | | |
| Colloidal silver | silver | 2.5 | mg |
| Fine grain silver iodobromide | silver | 0.10 | g |
| emulsion (average silver iodide | | | |
| content: 1 mol %, | | | |
| equivalent sphere | | | |
| average grain diameter 0.06 μm) | | | |
| Gelatin | | 0.80 | g |
| Compound Cpd-T | | 0.24 | g |
| Ultraviolet absorbent U-1 | | 0.030 | g |
| Ultraviolet absorbent U-6 | | 0.030 | g |
| High-boiling organic solvent Oil-3 | | 0.010 | g |
| 19th layer: Third protective layer | | | |
| Gelatin | | 1.00 | g |
| Polymethylmethacrylate | | 0.10 | g |
| (average grain size 1.5 μm) | | | |
| 6:4 copolymer of methylmethacrylate and | | 0.15 | g |
| methacrylic acid(average grain size 1.5 μm) | | | |
| Silicone oil SO-1 | | 0.20 | g |
| Surfactant W-1 | | 25.0 | mg |
| Surfactant W-3 | | 0.040 | g |

In addition to the above compositions, additives F-1 to F-9 were added to all emulsion layers. Also, a gelatin hardener H-1 and surfactants W-3, W-4, W-5, and W-6 for coating and emulsification were added to each layer.

Furthermore, phenol, 1,2-benzisothiazoline-3-one, 2-phenoxyethanol, phenethylalcohol, and p-benzoic butylester were added as antiseptic and mildewproofing agents.

TABLE 5
Silver halide emulsion used in Sample A-01

| | | Av. | | | Halide | Grain | | | | | |
|---|---|---|---|---|---|---|---|---|---|---|---|
| | | Eqvl. | | | comp. of | surface | | | | | |
| | | Spr | | Av. AgI | silver | AgI | Other | | | | |
| | | Dmtr. | COV | content | halide | content | characteristics | | | | |
| Em | Characteristics | (μm) | (%) | (%) | grain | (%) | (1) | (2) | (3) | (4) | (5) |
| A | Monodisperse | 0.24 | 9 | 3.5 | Triple | 1.5 | | ◯ | | | |
| | tetradecahedral | | | | structure | | | | | | |
| | grains | | | | | | | | | | |
| B | Monodisperse (111) | 0.25 | 10 | 3.5 | Quadruple | 1.5 | ◯ | | ◯ | ◯ | ◯ |
| | tabular grains | | | | structure | | | | | | |
| | Av. Aspct ratio 4.0 | | | | | | | | | | |
| C | Monodisperse (111) | 0.3 | 19 | 3.0 | Triple | 0.1 | ◯ | ◯ | | ◯ | ◯ |
| | tabular grains | | | | structure | | | | | | |
| | Av. Aspct ratio 5.0 | | | | | | | | | | |
| D | Monodisperse (111) | 0.35 | 21 | 4.8 | Triple | 2.0 | ◯ | ◯ | | ◯ | ◯ |
| | tabular grains | | | | structure | | | | | | |
| | Av. Aspct ratio 6.0 | | | | | | | | | | |
| E | Monodisperse (111) | 0.40 | 10 | 2.0 | Quadruple | 1.5 | | ◯ | | | |
| | tabular grains | | | | structure | | | | | | |
| | Av. Aspct ratio 6.0 | | | | | | | | | | |
| F | Monodisperse (111) | 0.55 | 12 | 1.6 | Triple | 0.6 | ◯ | ◯ | | | ◯ |
| | tabular grains | | | | structure | | | | | | |
| | Av. Aspct ratio 8.0 | | | | | | | | | | |
| G | Monodisperse cubic | 0.15 | 9 | 3.5 | Quadruple | 2.0 | | | ◯ | | |
| | grains | | | | structure | | | | | | |
| H | Monodisperse cubic | 0.24 | 12 | 4.9 | Quadruple | 0.1 | ◯ | ◯ | | ◯ | |
| | grains | | | | structure | | | | | | |
| I | Monodisperse (111) | 0.30 | 12 | 3.5 | Quintuple | 4.5 | ◯ | ◯ | | ◯ | ◯ |
| | tabular grain | | | | structure | | | | | | |
| | Av. Aspct ratio 6.0 | | | | | | | | | | |
| J | Monodisperse (111) | 0.45 | 21 | 3.0 | Quadruple | 0.2 | ◯ | ◯ | | ◯ | ◯ |
| | tabular grain | | | | structure | | | | | | |
| | Av. Aspct ratio 8.0 | | | | | | | | | | |
| K | Monodisperse (111) | 0.60 | 13 | 2.7 | Triple | 1.3 | ◯ | ◯ | | | ◯ |
| | tabular grain | | | | structure | | | | | | |
| | Av. Aspct ratio 12.0 | | | | | | | | | | |
| L | Monodisperse | 0.31 | 9 | 3.5 | Triple | 7.0 | | | ◯ | | ◯ |
| | tetradecahedral | | | | structure | | | | | | |
| | grains | | | | | | | | | | |
| M | Monodisperse | 0.31 | 9 | 3.5 | Triple | 5.0 | ◯ | ◯ | | ◯ | ◯ |
| | tetradecahedral | | | | structure | | | | | | |
| | grains | | | | | | | | | | |
| N | Monodisperse (111) | 0.33 | 13 | 2.1 | Quadruple | 4.0 | ◯ | ◯ | ◯ | | |
| | tabular grain | | | | structure | | | | | | |
| | Av. Aspct ratio 5.0 | | | | | | | | | | |
| O | Monodisperse (111) | 0.43 | 9 | 2.5 | Quadruple | 1.0 | ◯ | ◯ | | ◯ | ◯ |
| | tabular grain | | | | structure | | | | | | |
| | Av. Aspct ratio 6.0 | | | | | | | | | | |
| P | Monodisperse (111) | 0.75 | 21 | 2.8 | Triple | 0.5 | ◯ | ◯ | | ◯ | ◯ |
| | tabular grain | | | | structure | | | | | | |
| | Av. Aspct ratio 6.0 | | | | | | | | | | |
| Q | Monodisperse (111) | 0.90 | 8 | 1.0 | Quadruple | 0.5 | ◯ | ◯ | | | ◯ |
| | tabular grain | | | | structure | | | | | | |
| | Av. Aspct ratio 10.0 | | | | | | | | | | |
| R | Monodisperse (111) | 0.90 | 10 | 9.0 | Quadruple | 3.0 | ◯ | ◯ | | | ◯ |
| | tabular grain | | | | structure | | | | | | |
| | Av. Aspct ratio 6.6 | | | | | | | | | | |
| S | Monodisperse (111) | 0.50 | 8 | 11.0 | Quadruple | 4.0 | ◯ | ◯ | | | ◯ |
| | tabular grain | | | | structure | | | | | | |
| | Av. Aspct ratio 5.0 | | | | | | | | | | |
| T | Monodisperse (111) | 0.50 | 12 | 7.0 | Quadruple | 4.5 | ◯ | | | | ◯ |
| | tabular grain | | | | structure | | | | | | |
| | Av. Aspct ratio 8.0 | | | | | | | | | | |

Em = Emulsion; Av. Aspct ratio = Average aspect ratio; COV = Coefficient of variation; Av. Eqvl. Spr Dmtr. = Average equivalent sphere diameter; Halide comp. of silver halide grain = Halide composition of silver halide grain (Other characteristics)
The mark “◯” means each of the conditions set forth below is satisfied.
(1) A reduction sensitizer was added during grain formation;
(2) A selenium sensitizer was used as an after-ripening agent
(3) A rhodium salt was added during grain formation.
(4) A shell was provided subsequent to after-ripening by using silver nitrate in an amount of 10%, in terms of silver molar ratio, of the emulsion grains at that time, together with the equimolar amount of potassium bromide
(5) The presence of dislocation lines in an average number of ten or more per grain was observed by a transmission electron microscope.
Note that all the lightsensitive emulsion were after-ripped by the use of sodium thiosulfate, sodium thiocyanate, and sodium aurichloride.
Note, also, an iridium salt was added during grain formation.
Note, also, that chemically-modified gelatin whose amino groups were partially converted to phthalic acid amide, was added to emulsions B, C, E, H, J, N, and Q.

TABLE 6
Sensitizing method of Emulsions A-T

| | Sensitizing | Addition amount | |
|---|---|---|---|
| | dye | per mol of | Time of sensitizing dye |
| Emulsion | added | silver halide (g) | addition |
| A | S-1 | 0.01 | Subsequent to after ripening |
| | S-2 | 0.35 | Prior to after ripening |
| | S-3 | 0.02 | Prior to after ripening |
| | S-8 | 0.03 | Prior to after ripening |
| | S-13 | 0.015 | Prior to after ripening |
| | S-14 | 0.01 | Prior to after ripening |
| B | S-2 | 0.35 | Prior to after ripening |
| | S-3 | 0.02 | Prior to after ripening |
| | S-8 | 0.03 | Prior to after ripening |
| | S-13 | 0.015 | Prior to after ripening |
| | S-14 | 0.01 | Prior to after ripening |
| C | S-2 | 0.45 | Prior to after ripening |
| | S-8 | 0.04 | Prior to after ripening |
| | S-13 | 0.02 | Prior to after ripening |
| D | S-2 | 0.5 | Subsequent to after ripening |
| | S-3 | 0.05 | Subsequent to after ripening |
| | S-8 | 0.05 | Prior to after ripening |
| | S-13 | 0.015 | Prior to after ripening |
| E | S-1 | 0.01 | Prior to after ripening |
| | S-2 | 0.45 | Prior to after ripening |
| | S-8 | 0.05 | Prior to after ripening |
| | S-13 | 0.01 | Subsequent to after ripening |
| F | S-2 | 0.4 | Prior to after ripening |
| | S-3 | 0.04 | Prior to after ripening |
| | S-8 | 0.04 | Prior to after ripening |
| G | S-4 | 0.3 | Subsequent to after ripening |
| | S-5 | 0.05 | Subsequent to after ripening |
| | S-12 | 0.1 | Subsequent to after ripening |
| H | S-4 | 0.2 | Prior to after ripening |
| | S-5 | 0.05 | Subsequent to after ripening |
| | S-9 | 0.15 | Prior to after ripening |
| | S-14 | 0.02 | Subsequent to after ripening |
| I | S-4 | 0.3 | Prior to after ripening |
| | S-9 | 0.2 | Prior to after ripening |
| | S-12 | 0.1 | Prior to after ripening |
| J | S-4 | 0.35 | Prior to after ripening |
| | S-5 | 0.05 | Subsequent to after ripening |
| | S-12 | 0.1 | Prior to after ripening |
| K | S-4 | 0.3 | Prior to after ripening |
| | S-9 | 0.05 | Prior to after ripening |
| | S-12 | 0.1 | Prior to after ripening |
| | S-14 | 0.02 | Prior to after ripening |
| L, M | S-6 | 0.1 | Subsequent to after ripening |
| | S-10 | 0.2 | Subsequent to after ripening |
| | S-11 | 0.05 | Subsequent to after ripening |
| N | S-6 | 0.05 | Subsequent to after ripening |
| | S-7 | 0.05 | Subsequent to after ripening |
| | S-10 | 0.25 | Subsequent to after ripening |
| | S-11 | 0.05 | Subsequent to after ripening |
| O | S-10 | 0.4 | Subsequent to after ripening |
| | S-11 | 0.15 | Subsequent to after ripening |
| P | S-6 | 0.05 | Subsequent to after ripening |
| | S-7 | 0.05 | Subsequent to after ripening |
| | S-10 | 0.3 | Prior to after ripening |
| | S-11 | 0.1 | Prior to after ripening |
| Q | S-6 | 0.05 | Prior to after ripening |
| | S-7 | 0.05 | Prior to after ripening |
| | S-10 | 0.2 | Prior to after ripening |
| | S-11 | 0.25 | Prior to after ripening |
| R | S-15 | 0.25 | Prior to after ripening |
| | S-4 | 0.25 | Prior to after ripening |
| S | S-15 | 0.30 | Prior to after ripening |
| | S-4 | 0.30 | Prior to after ripening |
| T | S-10 | 0.25 | Prior to after ripening |

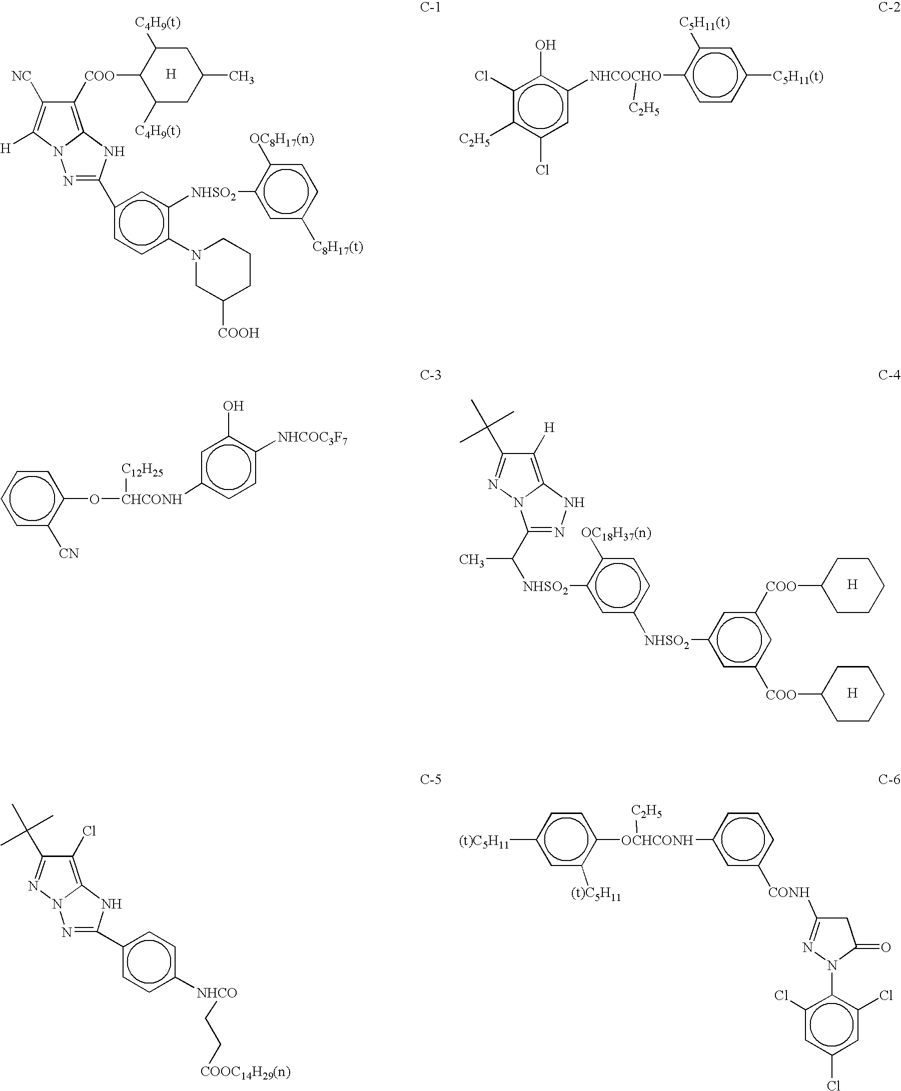

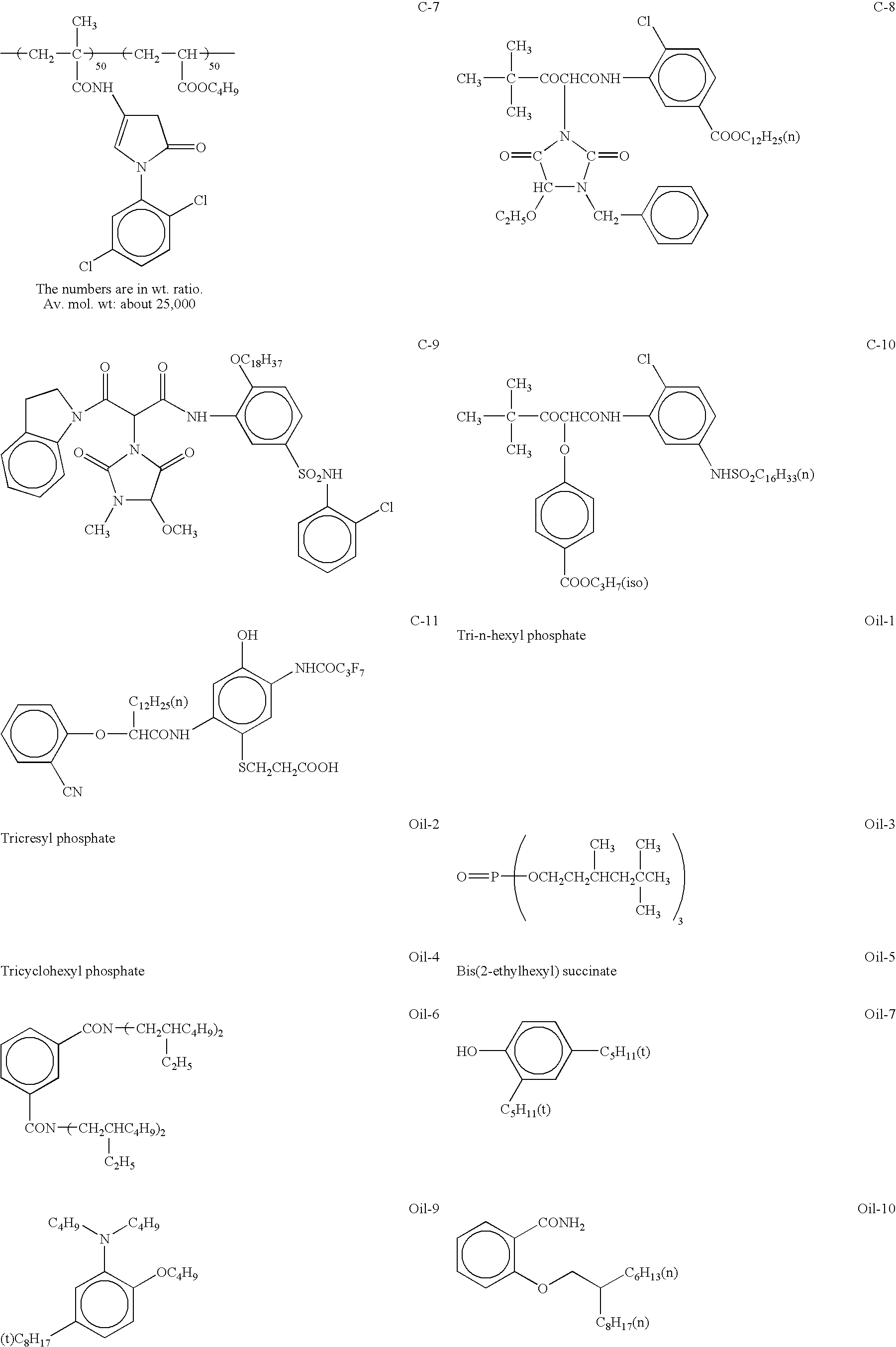

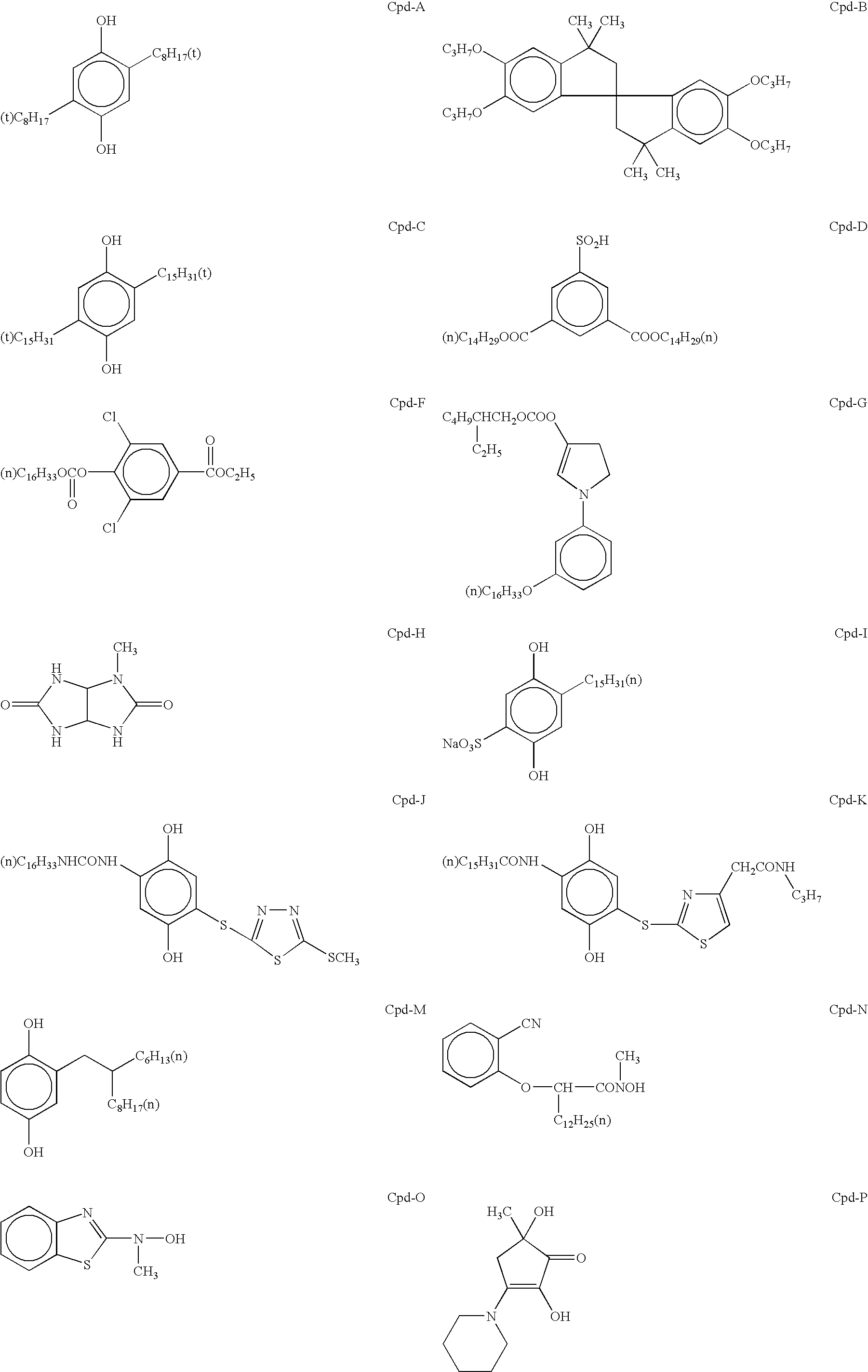

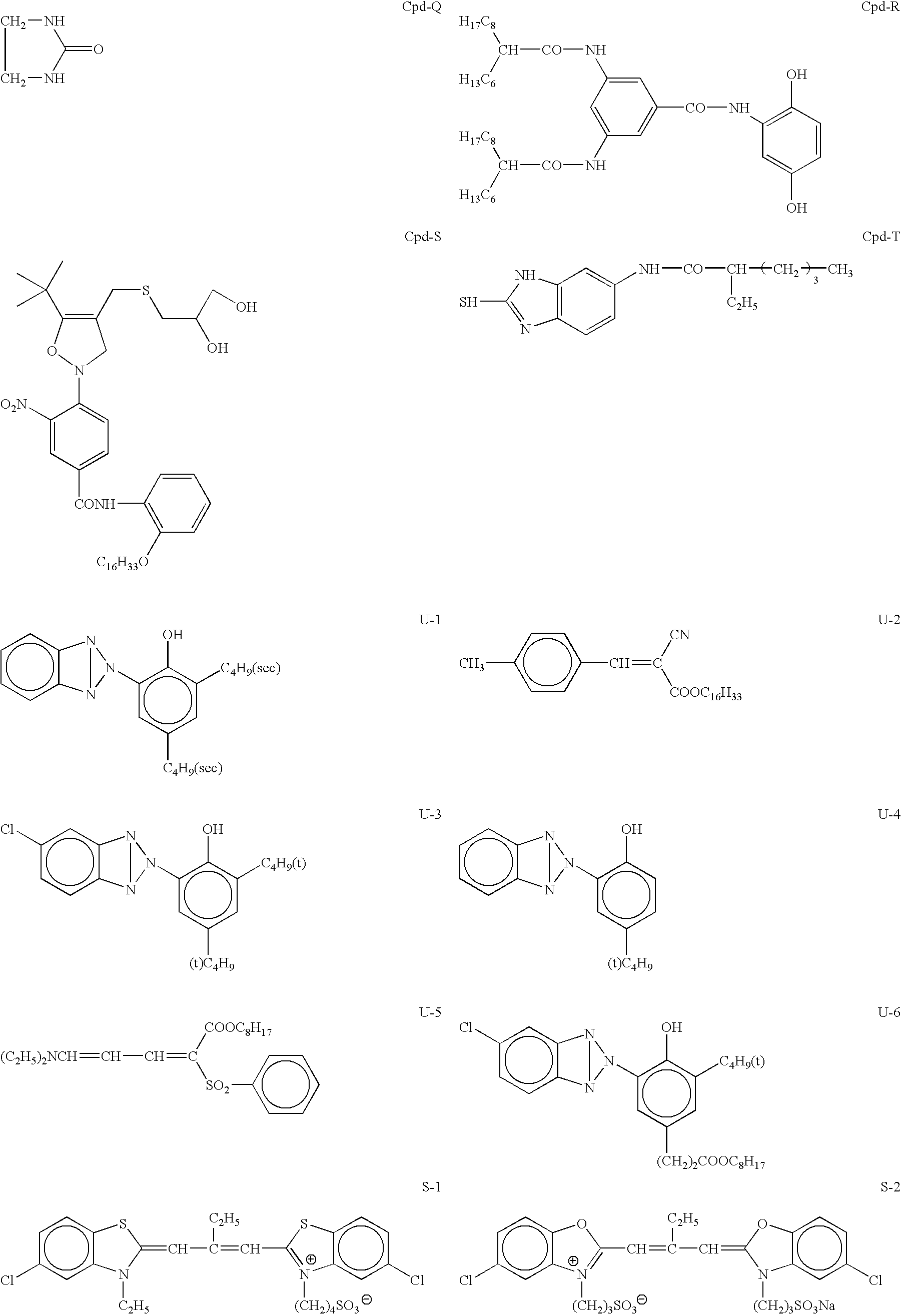

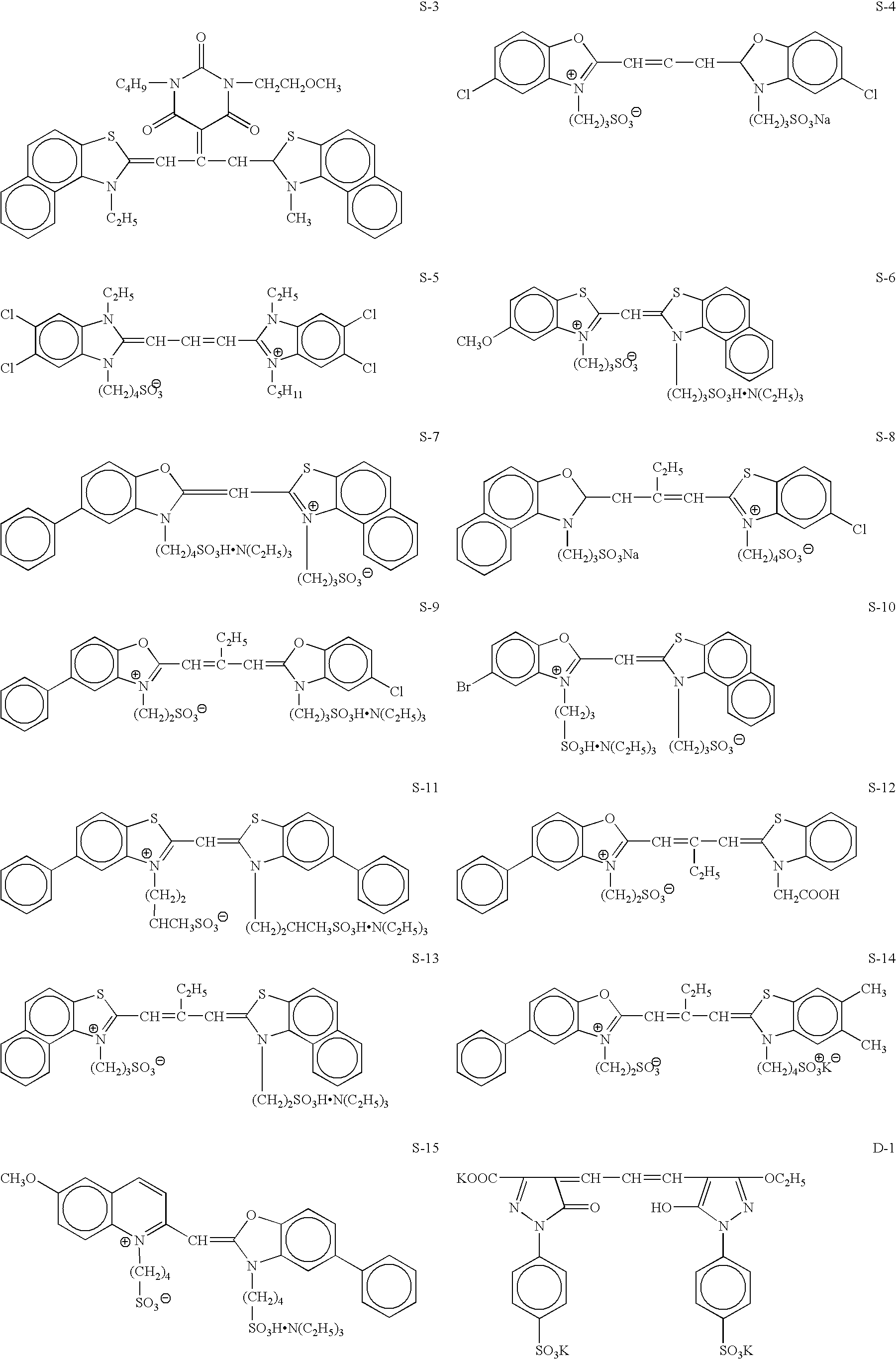

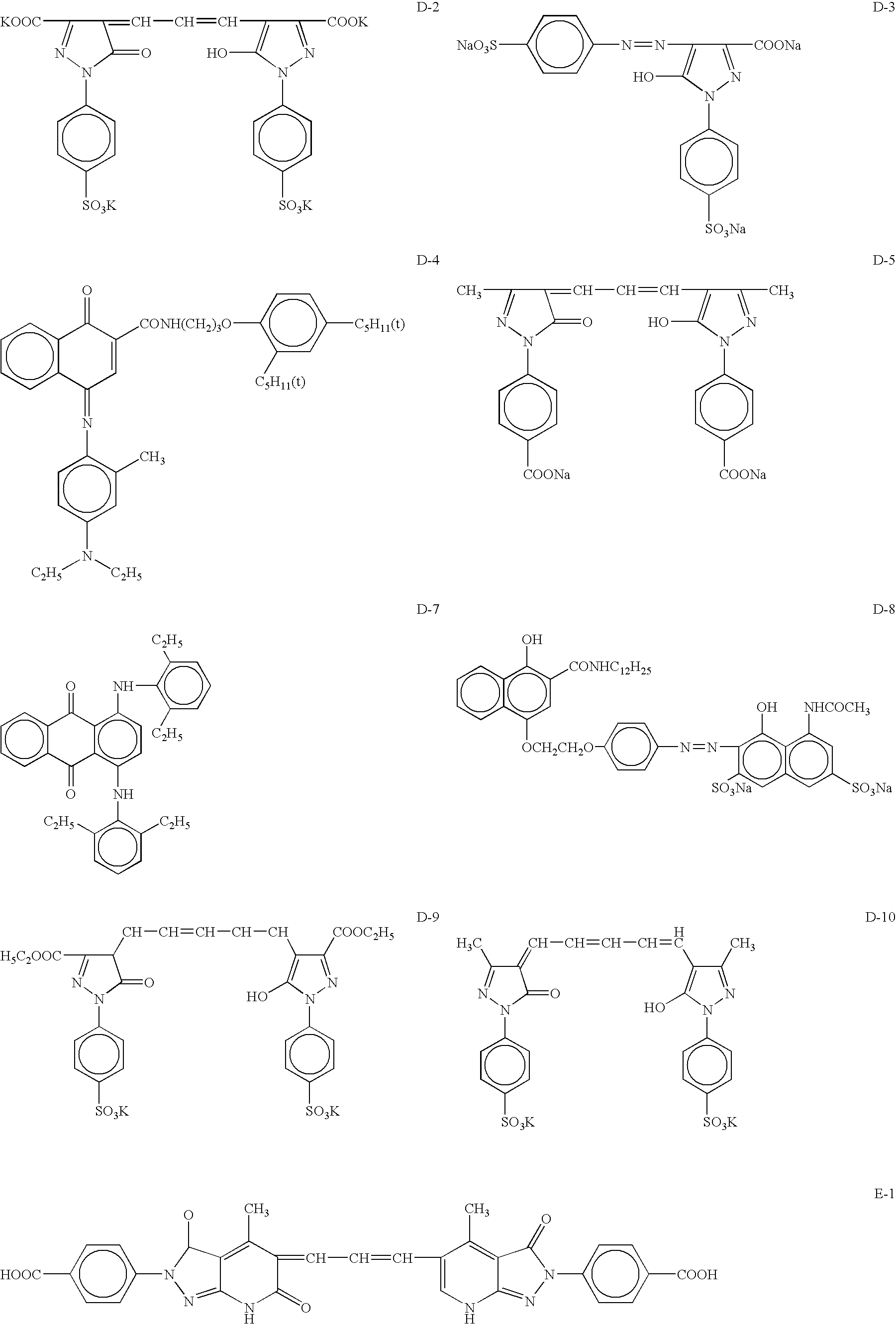

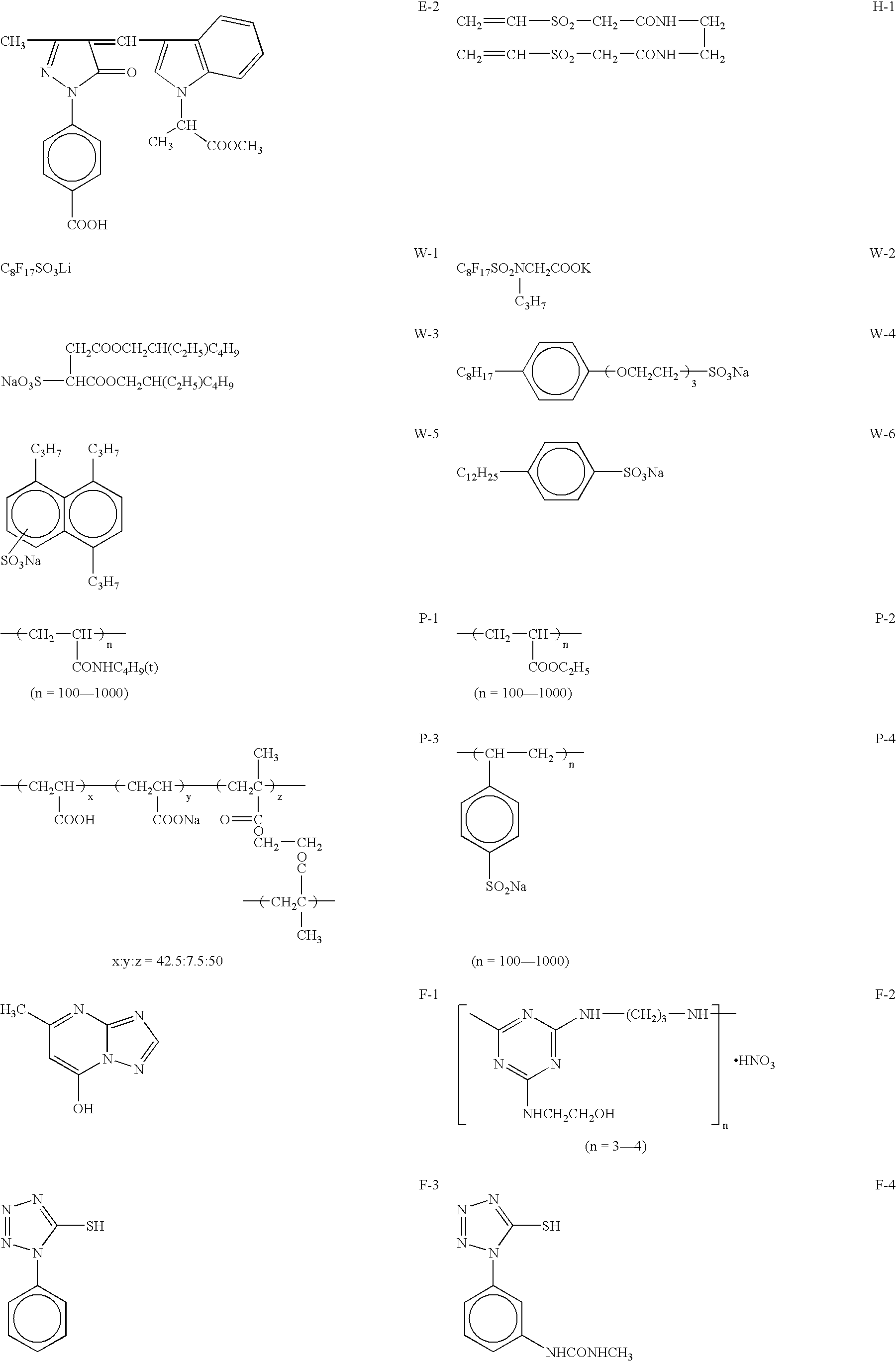

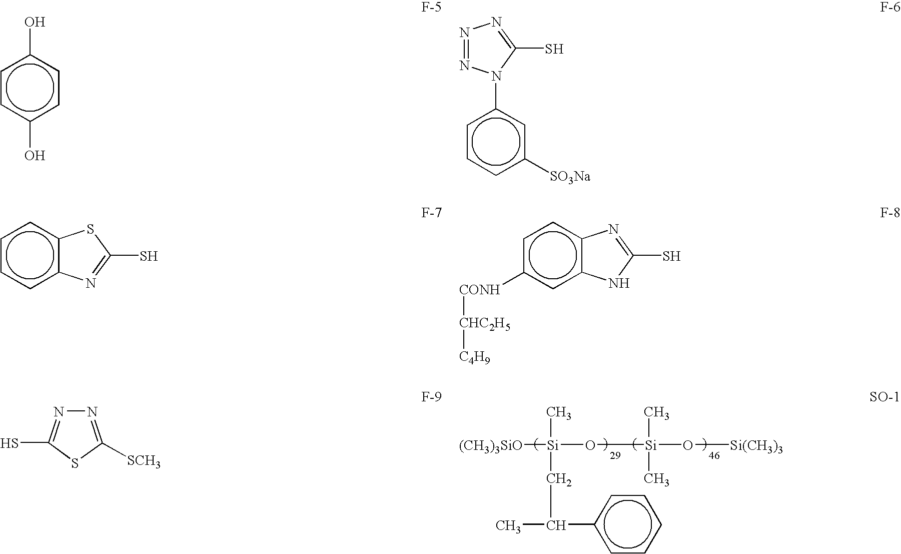

(Preparation of Fine Crystalline Solid Dispersion of Dye E-1)

100 g of Pluronic F88 (an ethylene oxide-propylene oxide block copolymer) manufactured by BASF CORP. and water were added to a wet cake of the dye E-1 (the net weight of E-1 was 270 g), and the resultant material was stirred to make 4,000 g. Next, the Ultra Visco Mill (UVM-2) manufactured by Imex K.K. was filled with 1,700 mL of zirconia beads with an average grain size of 0.5 mm, and the slurry was milled through this UVM-2 at a peripheral speed of approximately 10 m/sec and a discharge rate of 0.5 L/min for 2 hr. The beads were filtered out, and water was added to dilute the material to a dye concentration of 3%. After that, the material was heated to 90° C. for 10 hr for stabilization. The average grain size of the obtained fine dye grains was 0.30 μm, and the grain size distribution (grain size standard deviation×100/average grain size) was 20%.

(Preparation of Fine Crystalline Solid Dispersion of Dye E-2)

Water and 270 g of W-4 were added to 1,400 g of a wet cake of E-2 containing 30 weight % of water, and the resultant material was stirred to form a slurry having an E-2 concentration of 40 weight %. Next, the Ultra Visco Mill (UVM-2) manufactured by Imex K.K. was filled with 1,700 mL of zirconia beads with an average grain size of 0.5 mm, and the slurry was milled through this UVM-2 at a peripheral speed of approximately 10 m/sec and a discharge rate of 0.5 L/min for 8 hr, thereby obtaining a solid fine-grain dispersion of E-2. This dispersion was diluted to 20 weight % by ion exchange water to obtain a fine crystalline solid dispersion.

The average grain size was 0.15 μm.

The film thickness of the above photographic layers, that is, the thickness of from a hydrophilic layer that is adjacent to the support on which a under coating is provided, to a protective layer, was 26.5 μm, and the film thickness thereof when it expanded with H₂O at 25° C. was 47.8 μm.

6. Exposure and Development

A silver halide photographic light-sensitive material prepared above was cut into a Brownie size of a width of 60 mm, processed and installed to a Brownie camera. Then, landscape under daylight, nightscape and still life were photographed.

After the photographing, the samples went through the following development processing to obtain transmission images of minimum transmission density of 0.15 and maximum transmission density of 3.6.

| | | | Tank | Replenishment |
|---|---|---|---|---|
| Processing Step | Time | Temperature | volume | rate |
| 1st development | 6 min | 38° C. | 37 L | 2,200 mL/m² |
| 1st washing | 2 min | 38° C. | 16 L | 4,000 mL/m² |
| Reversal | 2 min | 38° C. | 17 L | 1,100 mL/m² |
| Color development | 6 min | 38° C. | 30 L | 2,200 mL/m² |
| Pre-bleaching | 2 min | 38° C. | 19 L | 1,100 mL/m² |
| Bleaching | 6 min | 38° C. | 30 L | 220 mL/m² |
| Fixing | 4 min | 38° C. | 29 L | 1,100 mL/m² |
| 2nd washing | 4 min | 38° C. | 35 L | 4,000 mL/m² |
| Final rinsing | 1 min | 25° C. | 19 L | 1,100 mL/m² |

Although the initial composition of each processing solution is that as set forth below, in addition to these, each solution contains eluted substances from the photographic material that is processed.

| <1st developer> | <Tank solution> | <Replenisher> |
|---|---|---|
| Nitrilo-N,N,N-trimethylene | 1.5 g | 1.5 g |
| phosphonic acid. | | |
| pentasodium salt | | |
| Diethylenetriamine | 2.0 g | 2.0 g |
| pentaacetic acid. | | |
| pentasodium salt | | |
| Sodium sulfite | 30 g | 30 g |
| Hydroquinone.potassium | 20 g | 20 g |
| monosulfonate | | |
| Potassium carbonate | 15 g | 20 g |
| Potassium bicarbonate | 12 g | 15 g |
| 1-phenyl-4-methyl-4- | 2.5 g | 3.0 g |
| hydroxymethyl-3- | | |
| pyrazolidone | | |
| Potassium bromide | 2.5 g | 1.4 g |
| Potassium thiocyanate | 1.2 g | 1.2 g |
| Potassium iodide | 2.0 mg | — |
| Diethyleneglycol | 13 g | 15 g |
| Water to make | 1,000 mL | 1,000 mL |
| pH | 9.60 | 9.60 |

The pH was adjusted by sulfuric acid or potassium hydroxide.

| <Reversal solution> | <Tank solution> | <Replenisher> |
|---|---|---|
| Nitrilo-N,N,N-trimethylene | 3.0 g | the same as |
| phosphonic acid. | | tank solution |
| pentasodium salt | | |
| Stannous chloride.dihydrate | 1.0 g | |
| p-aminophenol | 0.1 g | |
| Sodium hydroxide | 8 g | |
| Glacial acetic acid | 15 mL | |
| Water to make | 1,000 mL | |
| pH | 6.00 | |

The pH was adjusted by acetic acid or sodium hydroxide.

| <Color developer> | <Tank solution> | <Replenisher> |
|---|---|---|
| Nitrilo-N,N,N-trimethylene | 2.0 g | 2.0 g |
| phosphonic acid. | | |
| pentasodium salt | | |
| Sodium sulfite | 7.0 g | 7.0 g |
| Trisodium phosphate. | 36 g | 36 g |
| dodecahydrate | | |
| Potassium bromide | 1.0 g | — |
| Potassium iodide | 90 mg | — |
| Sodium hydroxide | 12.0 g | 12.0 g |
| Citrazinic acid | 0.5 g | 0.5 g |
| N-ethyl-N-(β-methanesulfon | 10 g | 10 g |
| amidoethyl)-3-methyl-4 | | |
| aminoaniline.3/2sulfuric | | |
| acid.monohydrate | | |
| 3,6-dithiaoctane-1,8-diol | 1.0 g | 1.0 g |
| Water to make | 1,000 mL | 1,000 mL |
| pH | 11.80 | 12.00 |

The pH was adjusted by sulfuric acid or potassium hydroxide.

| <Pre-bleaching solution> | <Tank solution> | <Replenisher> |
|---|---|---|
| Ethylenediaminetetraacetic | 8.0 g | 8.0 g |
| acid.disodium salt. | | |
| dihydrate | | |
| Sodium sulfite | 6.0 g | 8.0 g |
| 1-thioglycerol | 0.4 g | 0.4 g |
| Formaldehyde sodium | 30 g | 35 g |
| bisulfite adduct | | |
| Water to make | 1,000 mL | 1,000 mL |
| pH | 6.3 | 6.10 |

The pH was adjusted by acetic acid or sodium hydroxide.

| <Bleaching solution> | <Tank solution> | <Replenisher> |
|---|---|---|
| Ethylenediaminetetraacetic | 2.0 g | 4.0 g |
| acid.disodium salt. | | |
| dihydrate | | |
| Ethylenediaminetetraacetic | 120 g | 240 g |
| acid.Fe(III).ammonium. | | |
| dihydrate | | |
| Potassium bromide | 100 g | 200 g |
| Ammonium nitrate | 10 g | 20 g |
| Water to make | 1,000 mL | 1,000 mL |
| pH | 5.70 | 5.50 |

The pH was adjusted by nitric acid or sodium hydroxide.

| <Fixing solution> | <Tank solution> | <Replenisher> |
|---|---|---|
| Ammonium thiosulfate | 80 g | the same as |
| | | tank solution |
| Sodium sulfite | 5.0 g | |
| Sodium bisulfite | 5.0 g | |
| Water to make | 1,000 mL | |
| pH | 6.60 | |

The pH was adjusted by acetic acid or ammonia water.

| <Stabilizer> | | | | |
|---|---|---|---|---|
| <Replenisher> | <Tank solution> | | | |
| 1,2-benzoisothiazoline-3-one | 0.02 | g | 0.03 | g |
| Polyoxyethylene-p-monononyl | 0.3 | g | 0.3 | g |
| phenylether | | | | |
| (average polymerization degree = 10) | | | | |
| Polymaleic acid | 0.1 | g | 0.15 | g |
| (average molecular weight = 2,000) | | | | |
| Water to make | 1,000 | mL | 1,000 | mL |

| | | |
|---|---|---|
| pH | 7.0 | 7.0 |

Note that in the development processing step, the solution of each bath was continuously circulated and stirred, and at the bottom of each tank was provided with a bubbling pipe having small apertures of 0.3 mm diameter in an interval of 1 cm, and nitrogen gas was bubbled through the apertures to stir the solution.

Samples A-02 to A-10 were prepared in the same manner as sample A-01 except for performing replacements as shown in Table 7 to sample A-01, and were subjected to the same evaluation as that performed in Examples 1 and 2. The same results as those obtained in Examples 1 and 2 were obtained.

TABLE 7

| | | | Results | | | | |
|---|---|---|---|---|---|---|---|
| | | | | Electrification | | | |
| | Substitution of W-1 | | | series index | | | |
| Sample | Compound | | | with respeci to | | | |
| No. | No. | Addition layer | F/C | Sample No. A-01 | Δfog | ΔS | Remarks |
| A-01 | W-1 | the 19 layer | 0.9 | — | 0.13 | 0.18 | Comparison |
| A-02 | W-1 | the 8 layer | 0.6 | 0.2 | 0.12 | 0.17 | Comparison |
| A-03 | FC-1 | the 19 layer | 0.6 | −0.1 | 0.13 | 0.18 | Comparison |
| A-04 | FS-3 | the 19 layer | 1.3 | −1.1 | 0.06 | 0.09 | Invention |
| A-05 | FS-3 | the 8 layer | 0.6 | −0.6 | 0.05 | 0.08 | Invention |
| A-06 | FS-1 | the 19 layer | 1.5 | −1.4 | 0.07 | 0.09 | Invention |
| A-07 | FS-1 | the 8 layer | 0.5 | −0.8 | 0.06 | 0.07 | invenDion |
| A-08 | FS-5 | the 19 layer | 1.7 | −1.5 | 0.08 | 0.11 | Invention |
| A-09 | FS-16 | the 19 layer | 1.3 | −1.2 | 0.05 | 0.09 | Invention |
| A-10 | FS-17 | the 19 layer | 1.8 | −1.6 | 0.07 | 0.11 | Invention |

In addition to these experiments, other samples A-01′ to A-10′ were prepared in the same manner as Samples A-01 to A-10, respectively, except that all of the emulsions each having an aspect ratio of 8 or more were replaced with emulsions having an aspect ratio of 8 or less. As a result, only a small effect of improving the storability with time was obtained.

### Example 4

From a film disclosed in Example 1 of JP-A-2000-305219, W-2 was removed, and replacement of W-1 and/or its addition layer were conducted in the same manner as in Example 3. The thus prepared samples were development processed in the same manner as in Example 3. As a result, the same advantages as in Example 3 were obtained.

### Example 5

The samples prepared in Example 1 and Example 3 were processed into rolls of 35 mm wide, packed into cartridge, and a camera pass test was conducted in a camera in which a film was advanced at a high speed. The thus prepared samples were developed by the above-mentioned method and then were evaluated for fogging. No fogging was recognized in the samples that were recognized to have an effect of controlling electrification in Examples 1 and 3.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A silver halide photosensitive material comprising at least one light-sensitive layer and at least one non-light-sensitive layer on a support, wherein the photosensitive material contains at least one compound represented by general formula (1) and a ratio of fluorescent X-ray intensity of fluorine to fluorescent X-ray intensity of carbon, F/C, in the surface of the photosensitive material is 0.5 or more: 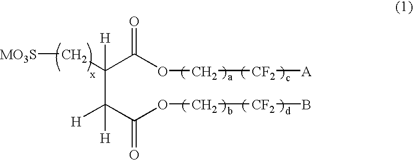
wherein A and B independently represent a fluorine atom or a hydrogen atom; a and b independently represent an integer of 1 to 6; c and d independently represent an integer of 4 to 8; x represents 0 or 1; and M represents a cation.

2. The silver halide photosensitive material according to claim 1, wherein the compound of general formula (1) is represented by general formula (I-a) shown below: 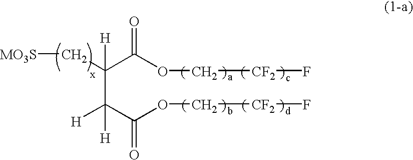
wherein a and b independently represent an integer of 1 to 6; c and d independently represent an integer of 4 to 8; x represents 0 or 1; and M represents a cation.

3. The silver halide photosensitive material according to claim 1, wherein the compound of general formula (1) is represented by general formula (I-b) shown below: 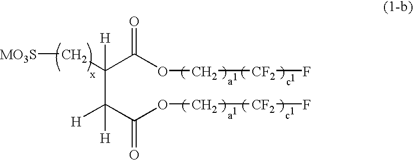
wherein al represents 2 or 3; c¹ represents an integer of 4 to 6; x represents 0 or 1; and M represents a cation.

4. The silver halide photosensitive material according to claim 1, wherein the at least one light-sensitive emulsion layer contains at least one silver halide emulsion comprising grains having an aspect ratio of at least 8 in an amount of at least 50% of the total projected area of all the grains contained in the silver halide emulsion.

5. The silver halide photosensitive material according to claim 1, wherein the photosensitive material is in a rolled form.

6. The silver halide photosensitive material according to claim 2, wherein the at least one light-sensitive emulsion layer contains at least one silver halide emulsion comprising grains having an aspect ratio of at least 8 in an amount of at least 50% of the total projected area of all the grains contained in the silver halide emulsion.

7. The silver halide photosensitive material according to claim 6, wherein the photosensitive material is in a rolled form.

8. The silver halide photosensitive material according to claim 2, wherein the photosensitive material is in a rolled form.

9. The silver halide photosensitive material according to claim 3, wherein the at least one light-sensitive emulsion layer contains at least one silver halide emulsion comprising grains having an aspect ratio of at least 8 in an amount of at least 50% of the total projected area of all the grains contained in the silver halide emulsion.

10. The silver halide photosensitive material according to claim 9, wherein the photosensitive material is in a rolled form.

11. The silver halide photosensitive material according to claim 3, wherein the photosensitive material is in a rolled form.

12. The silver halide photosensitive material according to claim 4, wherein the photosensitive material is in a rolled form.
